(19) United States
(12) Patent Application Publication
(10) Pub. No.: US 2025/0011477 A1
(43) Pub. Date: Jan. 9, 2025

(54) ULTRASMALL AMORPHOUS METAL OXIDE NANOPARTICLES CATALYZE POLYOLEFIN HYDROGENOLYSIS

(71) Applicant: Iowa State University Research Foundation, Inc., Ames, IA (US)

(72) Inventors: Wenyu HUANG, Ames, IA (US); Aaron David SADOW, Ames, IA (US); Shaojiang CHEN, Ames, IA (US); Akalanka TENNAKOON, Ames, IA (US)

(21) Appl. No.: 18/662,461

(22) Filed: May 13, 2024

Related U.S. Application Data
(60) Provisional application No. 63/512,181, filed on Jul. 6, 2023.

(51) Int. Cl. C08F 4/18; B82Y 40/00; C08J 11/16

(52) U.S. Cl. CPC C08F 4/18; C08J 11/16; B82Y 40/00; C08J 2323/06

(57) ABSTRACT

The present application is directed to a catalyst comprising a layer of metal oxide nanoparticles; and a mesoporous silica-containing shell surrounding the layer of metal oxide nanoparticles, wherein the mesoporous silica-containing shell has an outer surface and an inner surface inside the outer surface, the outer surface having openings leading to pores extending through said mesoporous silica-containing shell to the inner surface, wherein the metal oxide is selected from a group consisting of zirconium oxide, hafnium oxide, titanium oxide, niobium oxide, cerium oxide, molybdenum oxide, scandium oxide, yttrium oxide, and lanthanum oxide. The present application is also directed to a method of making such catalyst and a method for catalytically hydrogenolyzing a polymer with the catalyst into solvent, naphtha, diesel, kerosine, base oil, or wax-like products.

### PRIORITY

This application claims the priority benefit of U.S. Provisional Patent Application Ser. No. 63/512,181, filed Jul. 6, 2023, which is hereby incorporated by reference in its entirety.

This invention was made with government support under DE-AC02-07CH11358 awarded by awarded by the Department of Energy. The government has certain rights in the invention.

### FIELD

The present application relates to an ultrasmall amorphous metal oxide nanoparticles that catalyze polyolefin hydrogenolysis.

### BACKGROUND

Metal oxides are ubiquitous in catalysis as supports for active species or as catalysts themselves. Active oxides, such as those of molybdenum, tungsten, or rhenium, can react with unsaturated hydrocarbons in situ to generate surface alkylidene (M=CR₂) sites for olefin metathesis (Lwin, S. & Wachs, I. E., “Olefin Metathesis by Supported Metal Oxide Catalysts,” ACS Catal. 4:2505-2520 (2014)). In contrast, the robust metal-oxygen bonds of non-reducible oxides are used to create 3D architectures, such as in zeolites and mesoporous materials. In catalytic reactions, such materials either make use of acidic or basic surface sites or act as supports for reduced metal nanoparticles, single-atom catalysts, or surface organometallic chemistry (SOMC) species, rather than forming metal-carbon bonds themselves. In principle, in situ conversion of non-reducible metal oxides into metal-hydride and metal-alkyl species, especially in materials with co-localized surface acid sites, could lead to unique multifunctional reaction mechanisms. Such organometalloxide catalysts could be particularly interesting for the selective cleavage of carbon-carbon bonds in hydrocarbons, which has traditionally relied on precious metal catalyzed hydrogenolysis (Sinfelt et al., “Catalysis over Supported Metals. III. Comparison of Metals of Known Surface Area for Ethane Hydrogenolysis,” J. Phys. Chem. 69:95-101 (1965); Gillespie et al., “The Structure Sensitivity of n-Heptane Dehydrocyclization and Hydrogenolysis Catalyzed by Platinum Single Crystals at Atmospheric Pressure,” J. Catal. 70:147-159 (1981); Flaherty, D. W. & Iglesia, E., “Transition-State Enthalpy and Entropy Effects on Reactivity and Selectivity in Hydrogenolysis of n-Alkanes,” J. Am. Chem. Soc. 135:18586-18599 (2013)) or acid-catalyzed hydrocracking (Weitkamp, J., “Catalytic Hydrocracking—Mechanisms and Versatility of the Process,” ChemCatChem 4:292-306 (2012)). Moreover, developing more effective processes for conversions of hydrocarbon plastics, which are currently used and discarded on a hundred of megatons scale (Geyer et al., “Production, Use, and Fate of All Plastics Ever Made,” Sci. Adv. 3:e1700782 (2017)), would also benefit from earth abundant oxide-based catalysts.

The growing global plastic waste crisis (De Smet, M., “The New Plastics Economy: Rethinking the Future of Plastics,” Report No. 080116, (Ellen Macarthur Foundation, 2016)) has motivated recent studies of supported precious metal nanoparticles as catalysts for hydrogenolysis of polyolefins (Celik et al., “Upcycling Single-Use Polyethylene Into High-Quality Liquid Products,” ACS Cent. Sci. 5:1795-1803 (2019); Liu et al., “Plastic Waste to Fuels by Hydrocracking at Mild Conditions,” Sci. Adv. 7:eabf8283 (2021); Rorrer et al., “Conversion of Polyolefin Waste to Liquid Alkanes with Ru-Based Catalysts under Mild Conditions,” JACS Au 1:8-12 (2021); Nakaji et al., “Low-Temperature Catalytic Upgrading of Waste Polyolefinic Plastics into Liquid Fuels and Waxes,” Appl. Catal. B 285:119805 (2021); Jaydev et al., “Direct Conversion of Polypropylene into Liquid Hydrocarbons on Carbon-Supported Platinum Catalysts,” ChemSusChem 14:5179-5185 (2021)). Carbon-carbon bond cleavage via organozirconium-mediated β-alkyl elimination (O'Reilly et al., “β-Alkyl Elimination: Fundamental Principles and Some Applications,” Chem. Rev. 116:8105-8145 (2016)) has received less attention (Kanbur et al., “Catalytic Carbon-Carbon Bond Cleavage and Carbon-Element Bond Formation Give New Life for Polyolefins as Biodegradable Surfactants,” Chem 7:1347-1362 (2021)), despite the earth abundance of Zr and attractive mild conditions (<150° C., atmospheric pressure) used for the hydrogenolysis of polyolefins in pioneering work by Basset and co-workers (Dufaud, V. & Basset, J.-M., “Catalytic Hydrogenolysis at Low Temperature and Pressure of Polyethylene and Polypropylene to Diesels or Lower Alkanes by a Zirconium Hydride Supported on Silica-Alumina: A Step Toward Polyolefin Degradation by the Microscopic Reverse of Ziegler-Natta Polymerization,” Angew. Chem. Int. Ed. 37:806-810 (1998)). The combination of a few of the advantageous features of these distinct classes of catalysts may provide an appropriate strategy for designing organozirconia-mediated hydrogenolysis of hydrocarbons.

The conventional strategy to achieve high catalytic activity, involving evenly dispersed sites over high surface area materials, has not yet enabled the activation of metal oxides for hydrogenolysis. An alternative catalyst design instead positions active sites at specific isolated locations within a 3D nanosized architecture. In support of this idea, a mesoporous silica shell/platinum catalyst/silica core (mSiO₂/Pt/SiO₂) 3D architecture that isolates small Pt nanoparticles at the bottom of mesoporous wells provides high activity and long catalyst lifetimes in polyolefin hydrogenolysis (Tennakoon et al., “Catalytic Upcycling of High-Density Polyethylene Via a Processive Mechanism,” Nat. Catal. 3:893-901 (2020); Wu et al., “Size-Controlled Nanoparticles Embedded in a Mesoporous Architecture Leading to Efficient and Selective Hydrogenolysis of Polyolefins,” J. Am. Chem. Soc. 144:5323-5334 (2022)). In contrast, external-facing platinum particles in Pt/SiO₂ materials readily deactivate by leaching and sintering. The synthetic methods that localize metal nanoparticles in a 3D architecture, however, are not readily adapted to SOMC zirconium complexes due to their unwanted reactivity with air and moisture, which forces the final synthetic step to be organometallic site installation. In that covalent grafting reaction, the placement of sites is governed by the locations of surface hydroxy groups, which are notoriously difficult to control on metal oxide surfaces (Kobayashi et al., “Spatial Distribution of Organic Functional Groups Supported on Mesoporous Silica Nanoparticles: A Study by Conventional and DNP-Enhanced 29Si Solid-state NMR,” Phys. Chem. Chem. Phys. 19:1781-1789 (2017)).

The present application is directed to overcoming these and other deficiencies in the art.

### SUMMARY

One aspect of the present disclosure relates to a catalyst comprising a layer of metal oxide nanoparticles and a mesoporous silica-containing shell surrounding the layer of metal oxide nanoparticles. The mesoporous silica-containing shell has an outer surface and an inner surface inside the outer surface, the outer surface having openings leading to pores extending through the mesoporous silica-containing shell to the inner surface. The metal oxide is selected from a group consisting of zirconium oxide, hafnium oxide, titanium oxide, niobium oxide, cerium oxide, molybdenum oxide, scandium oxide, yttrium oxide, and lanthanum oxide.

Another aspect of the present disclosure relates to a process for catalytically hydrogenolyzing a polymer. This process includes providing a polymer and subjecting the polymer to a hydrogenolysis reaction in the presence of a catalyst to cleave the polymer into hydrocarbon segments. The catalyst comprises metal oxide, where the metal oxide is selected from a group consisting of zirconium oxide, titanium oxide, hafnium oxide, lanthanum oxide, cerium oxide, niobium oxide, molybdenum oxide, tungsten oxide, tantalum oxide, scandium oxide, and yttrium oxide.

Another aspect of the present disclosure relates to a method of preparing a catalyst. This method includes: providing a graphene oxide; providing a metal containing compound; adding the metal containing compound to the graphene oxide to form a plurality of metal oxide hydrate nanoparticles supported on the graphene oxide. The method further involves contacting the plurality of metal oxide hydrate nanoparticles supported on the graphene oxide with a silicon containing compound and a pore structure-directing agent to produce a mesoporous silica-containing shell surrounding the plurality of metal oxide hydrate nanoparticles supported on the graphene oxide, where the mesoporous silica-containing shell has an outer surface and an inner surface inside the outer surface, the outer surface having openings leading to pores extending through the mesoporous silica-containing shell to the inner surface. This method further involves calcinating the mesoporous silica-containing shell containing the plurality of metal oxide hydrate nanoparticles supported on graphene oxide to produce a mesoporous silica-containing shell surrounding the plurality of metal oxide nanoparticles, where the mesoporous silica-containing shell has an outer surface and an inner surface inside the outer surface, the outer surface having openings leading to pores extending through the mesoporous silica-containing shell to the inner surface; where the metal oxide is selected from a group consisting of zirconium oxide, hafnium oxide, titanium oxide, niobium oxide, cerium oxide, molybdenum oxide, scandium oxide, yttrium oxide, and lanthanum oxide.

Metal nanoparticle and surface organometallic chemistry (SOMC) catalysts both benefit from coordinatively unsaturated sites, achieved in the former through high proportions of edge and corner atoms in small nanoparticles and in the latter by immobilization onto inert supports. Although zirconia-catalyzed polyolefin hydrogenolysis had not previously been demonstrated, zirconia was shown to catalyze the hydrogenation of alkenes (Kondo et al., “Infrared Studies of Ethene Hydrogenation Over ZrO₂. Part 3.—Reaction Mechanism,” J. Chem. Soc., Faraday Trans. 88:2095-2099 (1992), which is hereby incorporated by reference in its entirety), and hexane is cracked over zirconia to give similar products and selectivity as the HZSM-5 acid catalyst (Hoang, D. L. & Lieske, H., “Effect of Hydrogen Treatments on ZrO₂ and Pt/ZrO₂ Catalysts,” Catal. Lett. 27:33-42 (1994), which is hereby incorporated by reference in its entirety). Moreover, tests of zirconia as a support for noble metals in hydrogenolysis also suggested its possible activity (Utami et al., “Hydrothermal Preparation of a Platinum-Loaded Sulphated Nanozirconia Catalyst for the Effective Conversion of Waste Low Density Polyethylene into Gasoline-Range Hydrocarbons,” RSC Adv. 9:41392-41401 (2019), which is hereby incorporated by reference in its entirety). Smaller nanoparticles (Puigdollers et al., “Turning a Nonreducible into a Reducible Oxide via Nanostructuring: Opposite Behavior of Bulk ZrO₂ and ZrO₂ Nanoparticles Toward H₂ Adsorption,” J. Phys. Chem. C 120:15329-15337 (2016), which is hereby incorporated by reference in its entirety), the presence of oxygen vacancies (Hoang, D. L. & Lieske, H., “Effect of Hydrogen Treatments on ZrO₂ and Pt/ZrO₂ Catalysts,” Catal. Lett. 27:33-42 (1994), which is hereby incorporated by reference in its entirety), and undercoordinated sites (Zhang et al., “Control of Coordinatively Unsaturated Zr Sites in ZrO₂ for Efficient C—H Bond Activation,” Nat. Commun. 9:3794 (2018), which is hereby incorporated by reference in its entirety) also have been proposed to enhance the reactivity of zirconia by creating either reducible surface sites or Lewis acid sites (Arce-Ramos et al., “Nature of Acid Sites in Silica-Supported Zirconium Oxide: A Combined Experimental and Periodic DFT Study,” J. Phys. Chem. C 119:15150-15159 (2015), which is hereby incorporated by reference in its entirety). Thus, metal oxides with coordinatively unsaturated surface sites in small nanoparticles that are isolated and stabilized by an inert 3D architecture could be promising for carbon-carbon bond hydrogenolysis.

Carbon-carbon bond cleavage reactions, adapted to deconstruct aliphatic hydrocarbon polymers and recover the intrinsic energy and carbon value in plastic waste, have typically been catalyzed by metal nanoparticles or air-sensitive organometallics. Metal oxides that serve as supports for these catalysts are typically considered to be inert. The present application shows that earth-abundant, non-reducible zirconia catalyzes the hydrogenolysis of polyolefins with activity rivaling that of precious metal nanoparticles. Related metal oxides, such as titania and hafnia, as well as rare earth oxides and mid-transition-metal oxides, also show hydrogenolysis activity. To harness this unusual reactivity, the catalytic architecture localizes ultrasmall amorphous zirconia nanoparticles between two fused platelets of mesoporous silica. Macromolecules translocate from bulk through radial mesopores to the highly active zirconia particles, where the chains undergo selective hydrogenolytic cleavage into a narrow, C₁₈-centered distribution.

Ultrasmall amorphous zirconia nanoparticles, covalently embedded in silica and localized in a void between two mesoporous platelets (L-ZrO₂@mSiO₂), are highly active in the hydrogenolysis of polyethylene. The architecture enhances the catalytic activity of zirconia to become comparable to that of Pt/C and improves its selectivity toward liquid products. From a practical perspective, the catalyst can be handled under ambient conditions and provides a competitive, earth-abundant, and low-cost alternative to precious metal hydrogenolysis catalysts for polyolefin deconstruction.

### BRIEF DESCRIPTION OF THE DRAWINGS

FIGS. 1A-F show powder X-ray diffraction (PXRD) pattern (FIG. 1A), high-angle annular dark-field scanning transmission electron microscopy (HAADF STEM) images (FIGS. 1B-C), and energy dispersive X-ray spectroscopy (EDX) elemental maps (Figures ID-F) of imp-ZrO₂/mSiO₂ sample. PXRD pattern shows a featureless broad hump, indicating imp-ZrO₂/mSiO₂ is an amorphous material. The STEM image and the EDX elemental maps display an even distribution of ZrO₂ onto the layered mSiO₂ support.

FIGS. 2A-C show characterization data for ZrO₂-6/mSiO₂. FIG. 2A shows PXRD pattern of ZrO₂-6 obtained from a hydrothermal synthesis, together with the simulated patterns of crystalline ZrO₂ with tetragonal and monoclinic phases. The pattern shows that ZrO₂-6 is monoclinic with an average size of 6.4 nm, estimated by the Scherrer equation: L=0.94λ/(cos θ·B), where L is mean particle size, B is the peak width at half the maximum intensity (FWHM), after subtracting the instrumental line broadening (an empirical value 0.1° in 2θ is used). The full widths at half maximum (FWHM) of the (1̅11) peak (1.388°) and the (111) peak (1.400°) were used for the mean size estimation. FIG. 2B is a low-magnification STEM image showing that ZrO₂ nanoparticles are nano-agglomerates with the primary size less than 6 nm and FIG. 2C is a high-magnification STEM image showing lattice fringes at nanoparticles, indicative of the crystalline characteristics of nanoparticles.

FIGS. 3A-B show N₂ sorption isotherms (FIG. 3A) and Barrett-Joyner-Halenda (BJH) pore size distributions (FIG. 3B) of the mSiO₂, L-ZrO₂@mSiO₂, imp-ZrO₂@mSiO₂, ZrO₂-6/mSiO₂, and L-Pt@mSiO₂.

FIG. 4 is a schematic showing the construction of L-ZrO₂@mSiO₂. Step 1 is precipitation-deposition of ZrO₂(OH)₄₋₂ₓ nanoparticles onto graphene oxide (GO). Step 2a is coating mSiO₂ onto ZrO₂(OH)₄₋₂ₓ/GO. Step 2b is calcination at 550° C.

FIGS. 5A-F show electron microscopy for ZrO₂ catalyst characterization. FIGS. 5A-B show low-magnification (FIG. 5A) (inset: SAED pattern) and high-magnification (FIG. 5B) HAADF STEM images of L-ZrO₂@mSiO₂. FIGS. 5C-D show low-magnification (FIG. 5C) and high-resolution (FIG. 5D) HAADF STEM image of the cross-section of a L-ZrO₂@mSiO₂ particle prepared by microtome. FIGS. 5E-F show high-magnification HAADF STEM image (FIG. 5E) and the corresponding EDX elemental (Si and Zr; Si; O; Zr) maps (FIG. 5F) of the cross-section of a L-ZrO₂@mSiO₂ particle.

FIGS. 6A-C show low-magnification (FIG. 6A) and high-magnification (FIG. 6B) TEM images of the ZrOₓ(OH)₄₋₂ₓ/GO and size distribution of ZrOₓ(OH)+₂ₓ nanoparticles on GO with average size of 3.0±0.4 nm (FIG. 6C).

FIG. 7 shows the X-ray photoelectron spectroscopy (XPS) survey spectrum (1100-0 eV) of L-ZrO₂@mSiO₂ and the peak assignments. As shown in the spectrum, within the XPS detection limit (0.1 at. %), only O, C, Si, and Zr were detected with the loading of 72.82 at. %, 2.46 at. %, 24.24 at. %, and 0.48 at. %, respectively.

FIGS. 8A-B show scanning transmission electron microscopy-energy dispersive X-ray (STEM-EDX) spectrum (−0.5-20.0 KeV) (FIG. 8A) and enlarged spectrum (−0.5-5.0 KeV) of L-ZrO₂@mSiO₂ (FIG. 8B). Apart from the C, O, Si, Zr, and Cu species, other metal impurities were not detected. The detected C and Cu signals could be only contributed to the Cu grid with coated carbon thin film that is used for transmission electron microscopy (TEM).

FIGS. 9A-D are TEM images of GO@mSiO₂ nanoplatelets before (FIGS. 9A-B) and after (FIGS. 9C-D) removal of GO and hexadecyltrimethylammonium bromide (CTAB) by calcination at 550° C. for 6 hours. FIGS. 9E-F show low-magnification (FIG. 9E) and high-magnification (FIG. 9F) STEM images of cross-sectioned mSiO₂ nanoplatelets embedded in epoxy resin. Low-magnification TEM image (FIG. 9A) shows a good dispersity of GO@mSiO₂ nanoplatelets. High-magnification TEM image (FIG. 9B) shows the silica shell is mesoporous. FIG. 9C displays that mSiO₂ retained the mesoporous structure after calcination. A narrow (˜3.5 nm) bright/dark band is observed in FIGS. 9D-F, suggesting a narrow open cavity between two mSiO₂ layers.

FIGS. 10A-B show a HAADF image and the corresponding EDX elemental maps (left-right: Si and Zr mix, Si, Zr) of ZrO₂-6/mSiO₂ (FIG. 10A) and a cross-sectioned ZrO₂-6/mSiO₂ particle (FIG. 10B). The top-down and cross-section view STEM images show that brighter contrast only exists on the external surface of mSiO₂ platelets. The corresponding elemental maps display that Zr is solely distributed on the external surfaces. Taken together, ZrO₂ nanoparticles are confirmed distributed on the external surfaces on mSiO₂ particles or as separate aggregates not on mSiO₂.

FIGS. 11A-B show low-magnification (FIG. 11A) and high-magnification (FIG. 11B) HAADF STEM images of commercial Pt/C catalyst from Alfa Aesar. FIG. 11C is a bar graph showing size distribution of Pt nanoparticles of Pt/C catalyst with the average size of 1.3±0.4 nm.

FIGS. 12A-B show HAADF STEM images of L-Pt@mSiO₂ catalyst from top-down view (FIG. 12A) and side view (FIG. 12B). FIG. 12C is a bar graph showing size distribution of Pt nanoparticles of L-Pt@mSiO₂ catalyst with the average size of 3.5±0.8 nm.

FIGS. 13A-B show low-magnification (FIG. 13A) and high-magnification (FIG. 13B) TEM images of the PtOₓ(OH)₄₋₂ₓ/GO composite. FIG. 13C is a bar graph showing size distribution of PtOₓ(OH)₄₋₂ₓ nanoparticles on GO.

FIGS. 14A-B show TEM image of L-ZrO₂@mSiO₂ with the electron beam focused on ZrO₂ nanoparticles (FIG. 14A) and size distribution of ZrO₂ nanoparticles on L-ZrO₂@mSiO₂ with the average size of 3.0±0.5 nm (FIG. 14B).

FIG. 15 shows PXRD pattern of L-ZrO₂@mSiO₂ sample, together with the simulated patterns of crystalline ZrO₂ with tetragonal and monoclinic phases. The broad hump in the pattern of L-ZrO₂@mSiO₂ indicates the amorphous characteristics of the sample.

FIG. 16A shows PXRD pattern of the sample of ZrO₂ nanoparticles obtained from the calcination of ZrOₓ(OH)₄₋₂ₓ/GO composite at 550° C. for 6 hours, together with the simulated patterns of crystalline ZrO₂ with tetragonal and monoclinic phases. The pattern shows the ZrO₂ nanoparticles contain both tetragonal and monoclinic nanocrystallites with a size of 5.5 nm and 9.3 nm, respectively, estimated by the Scherrer equation: L=0.94λ/(cos θ·B), where L is mean particle size, B is the peak broadening defined by FWHM, after subtracting the instrumental line broadening (an empirical value 0.1° in 20 is used). The FWHM of the (101) peak (1.605°) for the tetragonal phase and the (101̅) peak (0.984°) for the monoclinic phase are used for the mean size estimation. FIGS. 16B-C is a low-magnification HAADF STEM image displaying that ZrO₂ nanoparticles are nano-agglomerates with the primary size less than 10 nm (FIG. 16B) and high-magnification STEM image (FIG. 16C) showing that lattice fringes at nanoparticles, indicating the crystalline characteristics of nanoparticles.

FIG. 17 shows gel permeation chromatography (GPC) analysis of molecular mass and distribution of the commercial PE starting material; Mₙ=20 kDa, M_{w}=90 kDa (Alfa Aesar 42607).

FIG. 18 shows TGA-DSC analysis of PE starting material (Mₙ=20 kDa, M_{w}=90 kDa) showing its thermal stability from 50 to 500° C.

FIGS. 19A-H show hydrogenolysis results from L-ZrO₂@mSiO₂ and control catalysts. FIG. 19A shows time-dependent conversion of polyethylene (PE) (Mₙ=20 kDa, M_{w}=90 kDa, Ð=4.8), liquid yield, and volatile yield in mass percentage catalyzed by L-ZrO₂@mSiO₂ under H₂ at 300° C. Data are presented as H₂ quantification (mean±1σ) determined from 3 or more gas chromatography (GC) measurements. FIG. 19B shows carbon number distribution of liquid products from hydrogenolysis of PE catalyzed by L-ZrO₂@mSiO₂ after 2, 4, 6, 8, 12, and 20 hours.

FIG. 19C shows comparison of C—C bond cleavage activity (left axis, mean±1σ determined from three H₂ quantification measurements and mass of metal loading) and conversion of PE (right axis, mean±1σ determined from two experiments of isolated material) at 300° C. for 6 hours. FIG. 19D shows comparison of C—C bond cleavage reactivity for short and long, linear and branched polymers in L-ZrO₂@mSiO₂-catalyzed hydrogenolysis. FIGS. 19E-H show carbon number distribution of liquid products catalyzed by L-ZrO₂@mSiO₂ (FIG. 19E), ZrO₂-30 (FIG. 19F), imp-ZrO₂/mSiO₂ (FIG. 19G), and ZrO₂-6/mSiO₂ (FIG. 19H), obtained from reactions that consumed similar mols of H₂.

FIG. 20 is a graph showing experimental Mₙ of the lumped phases fitted to eq 3.

FIG. 21 shows gas chromatography-flame ionized detector (GC-FID) trace of the sampled headspace from the hydrogenolysis of PE catalyzed by L-ZrO₂@SiO₂, yielding 2.2 wt % volatile species with respect to the mass of the starting PE (Table 3). Reaction conditions: 0.0086 ZrO₂ wt/PE wt %, 2 hours, 300° C., under H₂ (0.992 MPa).

FIG. 22 is a bar graph showing carbon number distribution determined from GC-FID analysis (FIG. 21) of the sampled headspace from the hydrogenolysis of PE catalyzed by L-ZrO₂@SiO₂. Conditions: 0.0086 ZrO₂ wt/PE wt %, 2 hours, 300° C., under H₂ (0.992 MPa).

FIG. 23 shows gas chromatography-mass spectrometry (GC-MS) trace of the oil products from the hydrogenolysis of PE catalyzed by L-ZrO₂@SiO₂. Conditions: 0.0086 ZrO₂ wt/PE wt %, 2 hours, 300° C., under H₂ (0.992 MPa). Workup: extraction of the solid reaction mixture with methylene chloride at 80° C. Oil yield corresponds to 15.5% of the mass of the starting PE (Table 3).

FIG. 24 is a bar graph showing carbon number distribution determined from GC-MS analysis of the oil products (FIG. 23) generated in the hydrogenolysis of PE catalyzed by L-ZrO₂@SiO₂. Conditions: 0.0086 ZrO₂ wt/PE wt %, 2 hours, 300° C., under H₂ (0.992 MPa).

FIG. 25 shows GPC trace of the solid remaining after the hydrogenolysis of PE catalyzed by L-ZrO₂@SiO₂ and extraction of oil products with methylene chloride, corresponding to 82.3 wt % solid residue with respect to the mass of the starting PE (Table 3). Reaction conditions: 0.0086 ZrO₂ wt/PE wt %, 2 hours, 300° C., under H₂ (0.992 MPa). Mₙ=3,050 Da, M_{w}=6,900 Da, Ð=2.3 (Table 6).

FIG. 26 shows GC-FID trace of the sampled headspace from the hydrogenolysis of PE catalyzed by L-ZrO₂@SiO₂, yielding 3.0 wt % volatile species with respect to the mass of the starting PE (Table 3). Reaction conditions: 0.0086 ZrO₂ wt/PE wt %, 4 hours, 300° C., under H₂ (0.992 MPa).

FIG. 27 is a bar graph showing carbon number distribution determined from GC-FID analysis of the sampled headspace from the hydrogenolysis of PE catalyzed by L-ZrO₂@SiO₂ (FIG. 25). Conditions: 0.0086 ZrO₂ wt/PE wt %, 4 hours, 300° C., under H₂ (0.992 MPa).

FIG. 28 shows GC-MS trace of the oil products from the hydrogenolysis of PE catalyzed by L-ZrO₂@SiO₂. Conditions: 0.0086 ZrO₂ wt/PE wt %, 4 hours, 300° C., under H₂ (0.992 MPa). Workup: extraction of the solid reaction mixture with methylene chloride at 80° C. Oil yield corresponds to 27.8% of the mass of the starting PE (Table 3).

FIG. 29 is a bar graph showing carbon number distribution determined from GC-MS analysis (FIG. 28) of the oil products from the hydrogenolysis of PE catalyzed by L-ZrO₂@SiO₂. Conditions: 0.0086 ZrO₂ wt/PE wt %, 4 hours, 300° C., H₂ (0.992 MPa).

FIG. 30 shows GPC trace of the solid left over after the hydrogenolysis of PE catalyzed by L-ZrO₂@SiO₂ after 4 hours and extraction of oil products with methylene chloride, corresponding to 69.2 wt % solid residue with respect to the mass of the starting PE (Table 3). Reaction conditions: 0.0086 ZrO₂ wt/PE wt %, 4 hours, 300° C., under H₂ (0.992 MPa). Mₙ=1,990 Da, M_{w}=3,800 Da, Ð=1.9 (Table 7).

FIG. 31 shows GC-FID trace of the sampled headspace from the hydrogenolysis of PE catalyzed by L-ZrO₂@SiO₂ for 6 hours, yielding 2.7 wt % volatile species with respect to the mass of the starting PE (Table 3). Reaction conditions: 0.0086 ZrO₂ wt/PE wt %, 6 hours, 300° C., under H₂ (0.992 MPa).

FIG. 32 is a bar graph showing carbon number distribution determined from GC-FID analysis of the sampled headspace from the hydrogenolysis of PE catalyzed by L-ZrO₂@SiO₂ (FIG. 30). Conditions: 0.0086 ZrO₂ wt/PE wt %, 6 hours, 300° C., under H₂ (0.992 MPa).

FIG. 33 shows GC-MS trace of the oil products from the hydrogenolysis of PE catalyzed by L-ZrO₂@SiO₂ (Table 3). Conditions: 0.0086 ZrO₂ wt/PE wt %, 6 hours, 300° C., under H₂ (0.992 MPa). Workup: extraction of the solid reaction mixture with methylene chloride at 80° C. Oil yield corresponds to 42.3% of the mass of the starting PE.

FIG. 34 is a bar graph showing carbon number distribution determined from GC-MS analysis (FIG. 33) of the oil products from the hydrogenolysis of PE catalyzed by L-ZrO₂@SiO₂. Conditions: 0.0086 ZrO₂ w/PE wt %, 6 hours, 300° C., under H₂ (0.992 MPa).

FIG. 35 shows GPC trace of the solid remaining after hydrogenolysis of PE catalyzed by L-ZrO₂@SiO₂ and extraction of oil products with methylene chloride, corresponding to 55.4 wt % solid residue with respect to the mass of the starting PE. Reaction conditions: 0.0086 ZrO₂ wt/PE wt %, 6 hours, 300° C., under H₂ (0.992 MPa). Mₙ=1,880 Da, M_{w}=3,300 Da, Ð=1.8 (Table 7).

FIG. 36 shows GC-FID trace of the sampled headspace from the hydrogenolysis of PE catalyzed by L-ZrO₂@SiO₂ (Table 3), yielding 6.5 wt % volatile species with respect to the mass of the starting PE. Conditions: 0.0086 ZrO₂ wt/PE wt %, 8 hours, 300° C., under H₂ (0.992 MPa).

FIG. 37 is a bar graph showing carbon number distribution determined from GC-FID analysis (FIG. 36) of the sampled headspace from the hydrogenolysis of PE catalyzed by L-ZrO₂@SiO₂. Conditions: 0.0086 ZrO₂ wt/PE wt %, 8 hours, 300° C., under H₂ (0.992 MPa).

FIG. 38 shows GC-MS trace of the oil products from the hydrogenolysis of PE catalyzed by L-ZrO₂@SiO₂ (Table 3). Conditions: 0.0086 ZrO₂ wt/PE wt %, 8 hours, 300° C., under H₂ (0.992 MPa). Workup: extraction of the solid reaction mixture with methylene chloride at 80° C. Oil yield corresponds to 55.0% of the mas of the starting PE.

FIG. 39 is a bar graph showing carbon number distribution determined by GC-MS FIG. 38) of the oil products from the hydrogenolysis of PE catalyzed by L-ZrO₂@SiO₂ after 8 hours. Conditions: 0.0086 ZrO₂ wt/PE wt %, 8 hours, 300° C., under H₂ (0.992 MPa).

FIG. 40 shows GPC trace of the solid remaining after the hydrogenolysis of PE catalyzed by L-ZrO₂@SiO₂ and extraction of oil products with methylene chloride, corresponding to 38.5 wt % solid residue with respect to the mass of the starting PE. Reaction conditions: 0.0086 ZrO₂ wt/PE wt %, 8 hours, 300° C., under H₂ (0.992 MPa). Mₙ=1,600 Da, M_{w}=2,700 Da, Ð=1.7 (Table 7).

FIG. 41 shows GC-FID trace of the sampled headspace from the hydrogenolysis of PE catalyzed by L-ZrO₂@SiO₂, yielding 7.7 wt % volatile species with respect to the mass of the starting PE (Table 3). Reaction conditions: 0.0086 ZrO₂ wt/PE wt %, 12 hours, 300° C., under H₂ (0.992 MPa).

FIG. 42 is a bar graph showing carbon number distribution determined by GC-FID analysis (FIG. 41) of the sampled headspace from the hydrogenolysis of PE catalyzed by L-ZrO₂@SiO₂. Conditions: 0.0086 ZrO₂ wt/PE wt %, 12 hours, 300° C., under H₂ (0.992 MPa).

FIG. 43 shows GC-MS trace of the oil products from the hydrogenolysis of PE catalyzed by L-ZrO₂@SiO₂. Conditions: 0.0086 ZrO₂ wt/PE wt %, 12 hours, 300° C., under H₂ (0.992 MPa). Workup: extraction of the solid reaction mixture with methylene chloride at 80° C. Oil yield corresponds to 64.9% of the mass of the starting PE (Table 3).

FIG. 44 is a bar graph showing carbon number distribution determined by GC-MS analysis (FIG. 43) of the oil products from the hydrogenolysis of PE catalyzed by L-ZrO₂@SiO₂. Conditions: 0.0086 ZrO₂ wt/PE wt %, 12 hours, 300° C., under H₂ (0.992 MPa).

FIG. 45 shows GPC trace of the solid remaining after the hydrogenolysis of PE catalyzed by L-ZrO₂@SiO₂ and extraction of soluble oils using methylene chloride, corresponding to 27.4 wt % solid residue with respect to the mass of the starting PE. Reaction conditions: 0.0086 ZrO₂ wt/PE wt %, 12 hours, 300° C., under H₂ (0.992 MPa). Mₙ=930 Da, M_{w}=1,800 Da, Ð=1.9

### (Table 7).

FIG. 46 shows GC-MS trace of the oil products from the hydrogenolysis of PE catalyzed by L-ZrO₂@SiO₂ over 15 hours (Table 3). Conditions: 0.0086 ZrO₂ wt/PE wt %, 15 hours, 300° C., H₂ (0.992 MPa). Workup: extraction of the solid reaction mixture with methylene chloride at 80° C. Oil yield corresponds to 79.8% of the mass of the starting PE.

FIG. 47 is a bar graph showing carbon number distribution determined by GC-MS analysis (FIG. 46) of the oil products from the hydrogenolysis of PE catalyzed by L-ZrO₂@SiO₂. Conditions: 0.0086 ZrO₂ wt/PE wt %, 15 hours, 300° C., under H₂ (0.992 MPa).

FIG. 48 shows GC-FID trace of the sampled headspace from the hydrogenolysis of PE catalyzed by L-ZrO₂@SiO₂, yielding 9.8 wt % volatile species with respect to the mass of the starting PE (Table 3). Reaction conditions: 0.0086 ZrO₂ wt/PE wt %, 15 hours, 300° C., under H₂ (0.992 MPa).

FIG. 49 is a bar graph showing carbon number distribution determined by GC-FID analysis (FIG. 48) of the sampled headspace from the hydrogenolysis of PE catalyzed by L-ZrO₂@SiO₂. Conditions: 0.0086 ZrO₂ wt/PE wt %, 15 hours, 300° C., under H₂ (0.992 MPa).

FIG. 50 shows GPC trace of the solid remaining after the hydrogenolysis of PE catalyzed by L-ZrO₂@SiO₂ and extraction of the soluble oil with methylene chloride, yielding 82.3 wt % solid residue with respect to the mass of the starting PE. Reaction conditions: 0.0086 ZrO₂ wt/PE wt %, 15 hours, 300° C., under H₂ (0.992 MPa). Mₙ=1,100 Da, M_{w}=1,990 Da, Ð=1.8 (Table 7).

FIG. 51 shows GC-FID trace of the sampled headspace from the hydrogenolysis of PE catalyzed by L-ZrO₂@SiO₂, yielding 14.2 wt % volatile species with respect to the mass of the starting PE (Table 3). Reaction conditions: 0.0086 ZrO₂ wt/PE wt %, 20 hours, 300° C., under H₂ (0.992 MPa).

FIG. 52 is a bar graph showing carbon number distribution determined by GC-FID analysis (FIG. 51) of the sampled headspace from the hydrogenolysis of PE catalyzed by L-ZrO₂@SiO₂. Conditions: 0.0086 ZrO₂ wt/PE wt %, 20 hours, 300° C., under H₂ (0.992 MPa).

FIG. 53 shows GC-MS trace of the oil products from the hydrogenolysis of PE catalyzed by L-ZrO₂@SiO₂ (Table 3). Conditions: 0.0086 ZrO₂ wt/PE wt %, 20 hours, 300° C., under H₂ (0.992 MPa). Workup: extraction of the solid reaction mixture with methylene chloride at 80° C. Oil yield corresponds to 85.8% of the mass of the starting PE.

FIG. 54 is a bar graph showing carbon number distribution determined by GC-MS analysis (FIG. 53) of the oil products from the hydrogenolysis of PE catalyzed by L-ZrO₂@SiO₂. Conditions: 0.0086 ZrO₂ wt/PE wt %, 20 hours, 300° C., under H₂ (0.992 MPa).

FIG. 55 shows GC-FID trace of the sampled headspace from the hydrogenolysis of PE catalyzed by imp-ZrO₂/mSiO₂, yielding 2.6% volatile species with respect to the mass of the starting PE (Table 6). Conditions: 0.0086 ZrO₂ wt/PE wt %, 6 hours, 300° C., under H₂ (0.992 MPa).

FIG. 56 is a bar graph showing carbon number distribution determined by GC-FID analysis (FIG. 55) of the sampled headspace from the hydrogenolysis of PE catalyzed by imp-ZrO₂/mSiO₂ (Table 6). Conditions: 0.0086 ZrO₂ wt/PE wt %, 6 hours, 300° C., under H₂ (0.992 MPa).

FIG. 57 shows GC-MS trace of the oil products from the hydrogenolysis of PE catalyzed by imp-ZrO₂/SiO₂ (Table 6). Conditions: 0.0086 ZrO₂ wt/PE wt %, 6 hours, 300° C., under H₂ (0.992 MPa). Workup: extraction of the solid reaction mixture with methylene chloride at 80° C. Oil yield corresponds to 20.1% of the mass of the starting PE.

FIG. 58 is a bar graph showing carbon number distribution determined by GC-MS analysis (FIG. 57) of the oil products from the hydrogenolysis of PE catalyzed by imp-ZrO₂/mSiO₂. Conditions: 0.0086 ZrO₂ wt/PE wt %, 6 hours, 300° C., under H₂ (0.992 MPa).

FIG. 59 shows GPC trace of the solid remaining after hydrogenolysis of PE catalyzed by imp-ZrO₂/mSiO₂ and extraction of oils using methylene chloride, yielding 77.4 wt % solid residue with respect to the mass of the starting PE. Reaction conditions: 0.0086 ZrO₂ wt/PE wt %, 6 hours, 300° C., under H₂ (0.992 MPa). Mₙ=3,000 Da, M_{w}=8,700 Da, Ð=2.9 (Table 7).

FIG. 60 shows GC-FID trace of the sampled headspace from the hydrogenolysis of PE catalyzed by ZrO₂-6/mSiO₂, yielding 0.7% volatile species with respect to the mass of the starting PE (Table 6). Conditions: 0.0119 ZrO₂ wt/PE wt %, 6 hours, 300° C., under H₂ (0.992 MPa).

FIG. 61 is a bar graph showing carbon number distribution determined by GC-FID analysis (FIG. 60) of the sampled headspace from the hydrogenolysis of PE catalyzed by ZrO₂-6/mSiO₂. Conditions: 0.0119 ZrO₂ wt/PE wt %, 6 hours, 300° C., under H₂ (0.992 MPa).

FIG. 62 shows GC-MS trace of the oil products from the hydrogenolysis of PE catalyzed by ZrO₂-6/mSiO₂. Conditions: 0.0119 ZrO₂ wt/PE wt %, 6 hours, 300° C., under H₂ (0.992 MPa). Workup: extraction of the solid reaction mixture with methylene chloride at 80° C. Oil yield corresponds to 12.6% of the mass of the starting PE (Table 6).

FIG. 63 is a bar graph showing carbon number distribution determined by GC-MS analysis (FIG. 62) of the oil products from the hydrogenolysis of PE catalyzed by ZrO₂-6/mSiO₂. Conditions: 0.0119 ZrO₂ wt/PE wt %, 6 hours, 300° C., under H₂ (0.992 MPa).

FIG. 64 shows GPC trace of the solid left over from the hydrogenolysis of PE catalyzed by ZrO₂-6/mSiO₂, yielding 86.7 wt % solid residue with respect to the mass of the starting PE. Reaction conditions: 0.0119 ZrO₂ wt/PE wt %, 6 hours, 300° C., under H₂ (0.992 MPa). Mₙ=4,500 Da, M_{w}=29,600 Da, Ð=6.6 (Table 7).

FIG. 65 shows GC-FID trace of the sampled headspace from the hydrogenolysis of PE catalyzed by ZrO₂-6/mSiO₂, yielding 13.7% volatile species with respect to the mass of the starting PE (Table 6). Conditions: 0.0119 ZrO₂ wt/PE wt %, 15 hours, 300° C., under H₂ (0.992 MPa).

FIG. 66 is a bar graph showing carbon number distribution determined by GC-FID analysis (FIG. 65) of the sampled headspace from the hydrogenolysis of PE catalyzed by ZrO₂-6/mSiO₂. Conditions: 0.0119 ZrO₂ wt/PE wt %, 15 hours, 300° C., under H₂ (0.992 MPa).

FIG. 67 shows GC-MS trace of the oil products from the hydrogenolysis of PE catalyzed by ZrO₂-6/mSiO₂ (Table 6). Conditions: 0.0119 ZrO₂ wt/PE wt %, 15 hours, 300° C., under H₂ (0.992 MPa). Workup: extraction of the solid reaction mixture with methylene chloride at 80° C. Oil yield corresponds to 25.1% of the mass of the starting PE.

FIG. 68 is a bar graph showing carbon number distribution determined from GC-MS analysis (FIG. 67) of the oil products from the hydrogenolysis of PE catalyzed by ZrO₂-6/mSiO₂. Conditions: 0.0119 ZrO₂ wt/PE wt %, 15 hours, 300° C., under H₂ (0.992 MPa).

FIG. 69 shows GPC trace of the solid remaining after the hydrogenolysis of PE catalyzed by ZrO₂-6/mSiO₂ and extraction of soluble oils with methylene chloride, yielding 61.0 wt % solid residue with respect to the mass of the starting PE. Reaction conditions: 0.0119 ZrO₂ wt/PE wt %, 15 hours, 300° C., under H₂ (0.992 MPa). Mₙ=1,700 Da, M_{w}=5,800 Da, Ð=3.4 (Table 7).

FIG. 70 shows GC-FID trace of the sampled headspace for the hydrogenolysis of PE catalyzed by ZrO₂-30, yielding 0.7% volatile species with respect to the mass of the starting PE (Table 6). Conditions: 0.183 ZrO₂ wt/PE wt %, 6 hours, at 300° C., under H₂ (0.992 MPa).

FIG. 71 is a bar graph showing carbon number distribution determined by GC-FID analysis (FIG. 70) of the sampled headspace from the hydrogenolysis of PE catalyzed by ZrO₂-30. Conditions: 0.183 ZrO₂ wt/PE wt %, 6 hours, 300° C., under H₂ (0.992 MPa).

FIG. 72 shows GC-MS trace of the oil products from the hydrogenolysis of PE catalyzed by ZrO₂-30. Conditions: 0.183 ZrO₂ wt/PE wt %, 6 hours, 300° C., under H₂ (0.992 MPa). Workup: extraction of the solid reaction mixture with methylene chloride at 80° C. Oil yield corresponds to 12.6% of the mass of the starting PE.

FIG. 73 is a bar graph showing carbon number distribution determined by GC-MS analysis (FIG. 72) of the oil products from the hydrogenolysis of PE catalyzed by ZrO₂-30. Conditions: 0.183 ZrO₂ wt/PE wt %, 6 hours, 300° C., under H₂ (0.992 MPa).

FIG. 74 shows GPC trace of the solid remaining after the hydrogenolysis of PE catalyzed by ZrO₂-30 and extraction of the soluble oils using methylene chloride, yielding 86.7 wt % solid residue with respect to the mass of the starting PE. Reaction conditions: 0.183 ZrO₂ wt/PE wt 9%, 6 hours, 300° C., under H₂ (0.992 MPa). Mₙ=3,000 Da, M_{w}=6,000 Da, Ð=2.0 (Table 7).

FIG. 75 shows GC-FID trace of the sampled headspace from the hydrogenolysis of PE catalyzed by ZrO₂-30, yielding 3.3% volatile species with respect to the mass of the starting PE (Table 6). Conditions: 0.183 ZrO₂ wt/PE wt %, 12 hours, 300° C., under H₂ (0.992 MPa).

FIG. 76 is a bar graph showing carbon number distribution determined from GC-FID analysis (FIG. 75) of the sampled headspace from the hydrogenolysis of PE catalyzed by ZrO₂-30. Conditions: 0.183 ZrO₂ wt/PE wt %, 12 hours, 300° C., under H₂ (0.992 MPa).

FIG. 77 shows GC-MS trace of the oil products from the hydrogenolysis of PE catalyzed by ZrO₂-30 (Table 6). Conditions: 0.183 ZrO₂ wt/PE wt %, 12 hours, 300° C., under H₂ (0.992 MPa). Workup: extraction of the solid reaction mixture with methylene chloride at 80° C. Oil yield corresponds to 27.7% of the mass of the starting PE.

FIG. 78 is a bar graph showing carbon number distribution determined by GC-MS analysis (FIG. 77) of the oil products from the hydrogenolysis of PE catalyzed by ZrO₂-30. Conditions: 0.183 ZrO₂ wt/PE wt %, 12 hours, 300° C., under H₂ (0.992 MPa).

FIG. 79 shows GC-FID trace of the sampled headspace from the hydrogenolysis of PE catalyzed by L-Pt@mSiO₂, yielding 2.6% volatile species with respect to the mass of the starting PE (Table 6). Conditions: 0.0092 Pt wt/PE wt %, 6 hours, 300° C., under H₂ (0.992 MPa).

FIG. 80 is a bar graph showing carbon number distribution determined by GC-FID analysis (FIG. 79) of the sampled headspace from the hydrogenolysis of PE catalyzed by L-Pt@mSiO₂. Conditions: 0.0092 Pt wt/PE wt %, 6 hours, 300° C. under H₂ (0.992 MPa).

FIG. 81 shows GC-MS trace of the oil products from the hydrogenolysis of PE catalyzed by L-Pt@mSiO₂. Conditions: 0.0092 Pt/PE wt %, 6 hours, 300° C., under H₂ (0.992 MPa). Workup: extraction of the solid reaction mixture with methylene chloride at 80° C. Oil yield corresponds to 51.5% of the mass of the starting PE (Table 6).

FIG. 82 is a bar graph showing carbon number distribution determined by GC-MS analysis (FIG. 81) of the oil products from the hydrogenolysis of PE catalyzed by L-Pt@mSiO₂. Conditions: 0.0092 Pt wt/PE wt %, 6 hours, 300° C., under H₂ (0.992 MPa).

FIG. 83 shows GPC trace of the solid remaining after hydrogenolysis of PE catalyzed by L-Pt@mSiO₂ and extraction of soluble oils using methylene chloride, yielding 45.9 wt % solid residue with respect to the mass of the starting PE. Reaction conditions: 0.0092 Pt wt/PE wt %, 6 hours, 300° C., under H₂ (0.992 MPa). Mₙ=2,400 Da, M_{w}=3,800 Da, Ð=1.6 (Table 7).

FIG. 84 shows GC-FID trace of the sampled headspace from the hydrogenolysis of PE catalyzed by Pt/C, yielding 2.2% volatile species with respect to the mass of the starting PE (Table 6). Conditions: 0.0092 Pt wt/PE wt %, 6 hours, 300° C., under H₂ (0.992 MPa).

FIG. 85 is a bar graph showing carbon number distribution determined by GC-FID analysis (FIG. 84) of the sampled headspace from the hydrogenolysis of PE catalyzed by Pt/C. Conditions: 0.0092 Pt wt/PE wt %, 6 hours, 300° C., under H₂ (0.992 MPa).

FIG. 86 shows GC-MS trace of the oil products from the hydrogenolysis of PE catalyzed by Pt/C. Conditions: 0.0092 Pt/PE wt %, 6 hours, 300° C., under H₂ (0.992 MPa). Workup: extraction of the solid reaction mixture with methylene chloride at 80° C. Oil yield corresponds to 22.2% of the mass of the starting PE (Table 6).

FIG. 87 is a bar graph showing carbon number distribution determined by GC-MS analysis (FIG. 86) of the oil products from the hydrogenolysis of PE catalyzed by Pt/C. Conditions: 0.0092 Pt wt/PE wt %, 6 hours, 300° C., under H₂ (0.992 MPa).

FIG. 88 shows GPC trace of the solid remaining after hydrogenolysis of PE catalyzed by Pt/C and extraction of soluble oils with methylene chloride, yielding 75.6 wt % solid residue with respect to the mass of the starting PE. Reaction conditions: 0.0092 Pt wt/PE wt %, 6 hours, 300° C., under H₂ (0.992 MPa). Mₙ=1,400 Da, M_{w}=1,900 Da, Ð=1.4 (Table 7).

FIG. 89 shows GPC analysis of molecular mass and distributions of a post-consumer grocery bag; Mₙ=10.6 kDa, M_{w}=150.0 kDa.

FIG. 90 shows GPC analysis of molecular mass and distributions of a commercial PE starting material; Mₙ=2.8 kDa, M_{w}=5.4 kDa (Aldrich 332119).

FIG. 91 shows GC-FID trace of the sampled headspace from the hydrogenolysis of hexatriacontane (C₃₆H₇₄) catalyzed by L-ZrO₂@SiO₂, yielding 1.7 wt % volatile species with respect to the mass of the hexatriacontane (Table 8). Reaction conditions: 0.0086 ZrO₂ wt/C₃₆H₇₄ wt %, 6 hours, 300° C., under H₂ (0.992 MPa).

FIG. 92 is a bar graph showing carbon number distribution determined by GC-FID analysis (FIG. 91) of the sampled headspace from the hydrogenolysis of hexatriacontane catalyzed by L-ZrO₂@SiO₂. Conditions: 0.0086 ZrO₂ wt/C₃₆H₇₄ wt %, 6 hours, 300° C., under H₂ (0.992 MPa).

FIG. 93 shows GC-MS trace of the oil products from the hydrogenolysis of hexatriacontane catalyzed by L-ZrO₂@SiO₂. Conditions: 0.0086 ZrO₂ wt/C₃₆H₇₄ wt %, 6 hours, 300° C., under H₂ (0.992 MPa). Workup: Solid/liquid mixture was scraped from the reaction vessel. 34% of the starting hexatriacontane was converted.

FIG. 94 is a bar graph showing carbon number distribution determined from GC-MS analysis (FIG. 93) of the oil products from the hydrogenolysis of hexatriacontane catalyzed by L-ZrO₂@SiO₂. Conditions: 0.0086 ZrO₂ wt/C₃₆H₇₄ wt %, 6 hours, 300° C., under H₂ (0.992 MPa).

FIG. 95 shows GC-FID trace of the sampled headspace from the hydrogenolysis of LDPE (Mₙ=2.8 kDa, M_{w}=5.3 kDa) catalyzed by L-ZrO₂@SiO₂, yielding 4.5 wt % volatile species with respect to the mass of the starting PE (Table 8). Reaction conditions: 0.0086 ZrO₂ wt/PE wt %, 6 hours, 300° C., under H₂ (0.992 MPa).

FIG. 96 is a bar graph showing carbon number distribution determined by GC-FID analysis (FIG. 95) of the sampled headspace from the hydrogenolysis of LDPE (Mₙ=2.8 kDa, M_{w}=5.3 kDa) catalyzed by L-ZrO₂@SiO₂. Conditions: 0.0086 ZrO₂ wt/PE wt %, 6 hours, 300° C., under H₂ (0.992 MPa).

FIG. 97 shows GC-MS trace of the oil products from the hydrogenolysis of LDPE (Mₙ=2.8 kDa, M_{w}=5.3 kDa) catalyzed by L-ZrO₂@SiO₂. Conditions: 0.0086 ZrO₂ wt/PE wt %, 6 hours, 300° C., under H₂ (0.992 MPa). Workup: extraction of the solid reaction mixture with methylene chloride at 80° C. Oil yield corresponds to 47.4% of the mass of the starting PE.

FIG. 98 is a bar graph showing carbon number distribution of the oil products from the hydrogenolysis of LDPE (Mₙ=2.8 kDa, M_{w}=5.3 kDa) catalyzed by L-ZrO₂@SiO₂. Conditions: 0.0086 ZrO₂ wt/PE wt %, 6 hours, 300° C., under H₂ (0.992 MPa).

FIG. 99 shows GC-FID trace of the sampled headspace from the hydrogenolysis of a post-consumer grocery bag catalyzed by L-ZrO₂@SiO₂, yielding 1.7 wt % volatile species with respect to the mass of the starting PE (Table 8). Reaction conditions: 0.0086 ZrO₂ wt/PE wt %, 6 hours, 300° C., under H₂ (0.992 MPa).

FIG. 100 is a bar graph showing carbon number distribution determined by GC-FID analysis (FIG. 99) of the sampled headspace from the hydrogenolysis of a post-consumer grocery bag catalyzed by L-ZrO₂@SiO₂. Conditions: 0.0086 ZrO₂ wt/PE wt %, 6 hours, 300° C., under H₂ (0.992 MPa).

FIG. 101 shows GC-MS trace of the oil products from the hydrogenolysis of post-consumer grocery bag catalyzed by L-ZrO₂@SiO₂. Conditions: 0.0086 ZrO₂ w/PE wt %, 6 hours, 300° C., under H₂ (0.992 MPa). Workup: extraction of the solid reaction mixture with methylene chloride at 80° C. Oil yield corresponds to 41.1% of the mass of the starting PE (Table 8).

FIG. 102 is a bar graph showing carbon number distribution determined by GC-MS analysis (FIG. 101) of the oil products from the hydrogenolysis of post-consumer grocery bag catalyzed by L-ZrO₂@SiO₂. Conditions: 0.0086 ZrO₂ wt/PE wt %, 6 hours, 300° C., under H₂ (0.992 MPa).

FIG. 103 shows GC-FID trace of the sampled headspace from the hydrogenolysis of ultrahigh molecular weight polyethylene (UHMWPE) catalyzed by L-ZrO₂@SiO₂, yielding 2.9 wt % volatile species with respect to the mass of the starting PE (Table 8). Reaction conditions: 0.0086 ZrO₂ wt/PE wt %, 6 hours, 300° C., under H₂ (0.992 MPa).

FIG. 104 is a bar graph showing carbon number distribution determined by GC-FID analysis (FIG. 103) of the sampled headspace from the hydrogenolysis of UHMWPE catalyzed by L-ZrO₂@SiO₂. Conditions: 0.0086 ZrO₂ wt/PE wt %, 6 hours, 300° C., under H₂ (0.992 MPa).

FIG. 105 shows GC-MS trace of the oil products from the hydrogenolysis of UHMWPE catalyzed by L-ZrO₂@SiO₂. Conditions: 0.0086 ZrO₂ wt/PE wt %, 6 hours, 300° C., under H₂ (0.992 MPa). Workup: extraction of the solid reaction mixture with methylene chloride at 80° C. Oil yield corresponds to 46.6% of the mass of the starting PE (Table 8).

FIG. 106 is a bar graph showing carbon number distribution determined by GC-MS analysis (FIG. 105) of the oil products from the hydrogenolysis of UHMWPE catalyzed by L-ZrO₂@SiO₂. Conditions: 0.0086 ZrO₂ wt/PE wt %, 6 hours, 300° C., under H₂ (0.992 MPa).

### DETAILED DESCRIPTION

One aspect of the present disclosure relates to a catalyst comprising a layer of metal oxide nanoparticles and a mesoporous silica-containing shell surrounding the layer of metal oxide nanoparticles. The mesoporous silica-containing shell has an outer surface and an inner surface inside the outer surface, the outer surface having openings leading to pores extending through the mesoporous silica-containing shell to the inner surface. The metal oxide is selected from a group consisting of zirconium oxide, hafnium oxide, titanium oxide, niobium oxide, cerium oxide, molybdenum oxide, scandium oxide, yttrium oxide, and lanthanum oxide.

In some embodiments, the metal oxide nanoparticles form a uniform layer. In other embodiments, the metal oxide nanoparticles are not uniformly distributed.

According to the present disclosure, the layer of metal oxide as separated or fused nanoparticles can have a thickness of about 0.1 nm to about 10000 nm, about 1 nm to about 5000 nm, about 1 nm to about 1000 nm, about 5 nm to about 1000 nm, about 10 nm to about 1000 nm, about 15 nm to about 1000 nm, about 20 nm to about 1000 nm, about 10 nm to about 900 nm, about 10 nm to about 800 nm, about 10 nm to about 700 nm, about 10 nm to about 600 nm, about 10 nm to about 500 nm, about 10 nm to about 400 nm, about 10 nm to about 300 nm, about 10 nm to about 200 nm, about 10 nm to about 100 nm, about 0.1 nm to about 500 nm, about 0.1 nm to about 250 nm, about 0.1 nm to about 100 nm, about 0.1 nm to about 50 nm, about 1 nm to about 500 nm, about 1 nm to about 50 nm, about 2 nm to about 40 nm, about 3 nm to about 30 nm, about 4 nm to about 20 nm, about 5 nm to about 10 nm, about 0.1 nm to about 10 nm, about 0.2 nm to about 9 nm, about 0.3 nm to about 8 nm, about 0.4 nm to about 7 nm, about 0.4 nm to about 6 nm, about 0.5 nm to about 5 nm, about 0.6 nm to about 5 nm, about 0.7 nm to about 4 nm, or about 0.8 nm to about 3 nm. The layer of metal oxide nanoparticles can have a thickness of about 0.1 nm, about 0.25 nm, about 0.5 nm, about 0.75 nm, about 1 nm, about 1.25 nm, about 1.5 nm, about 1.75 nm, about 2 nm, about 2.25 nm, about 2.5 nm, about 2.75 nm, about 3 nm, about 3.25 nm, about 3.5 nm, about 3.75 nm, about 4 nm, about 4.5 nm, about 5 nm, about 5.5 nm, about 6 nm, about 6.5 nm, about 7 nm, about 7.5 nm, about 8 nm, about 8.5 nm, about 9 nm, about 9.5 nm, or about 10 nm. In some embodiments, the layer of metal oxide nanoparticles can have a thickness of about 0.5 nm, about 1 nm, about 1.5 nm, about 2 nm, about 2.5 nm, about 3 nm, about 3.5 nm, about 4 nm, about 4.5 nm, or about 5 nm.

In some embodiments, the metal oxide nanoparticles are selected from a group consisting of zirconium oxide, hafnium oxide, titanium oxide, niobium oxide, cerium oxide, and molybdenum oxide. In one embodiment, the metal oxide nanoparticles are zirconia oxide nanoparticles.

In some embodiments, the zirconia oxide nanoparticles are amorphous zirconia oxide nanoparticles. Alternatively, the zirconia oxide nanoparticles are crystalline zirconia oxide nanoparticles.

In some embodiments, the metal oxide nanoparticles are embedded in the inner surface of the shell via contacts between the surface of the metal oxide nanoparticles and inner surface of the shell.

According to the present disclosure, the metal oxide nanoparticles have a mean particle diameter of about 0.1 nm to about 1000 nm, about 1 nm to about 1000 nm, about 5 nm to about 1000 nm, about 10 nm to about 1000 nm, about 15 nm to about 1000 nm, about 20 nm to about 1000 nm, about 10 nm to about 900 nm, about 10 nm to about 800 nm, about 10 nm to about 700 nm, about 10 nm to about 600 nm, about 10 nm to about 500 nm, about 10 nm to about 400 nm, about 10 nm to about 300 nm, about 10 nm to about 200 nm, about 10 nm to about 100 nm, about 0.1 nm to about 500 nm, about 0.1 nm to about 250 nm, about 0.1 nm to about 100 nm, about 0.1 nm to about 50 nm, about 1 nm to about 500 nm, about 1 nm to about 50 nm, about 2 nm to about 40 nm, about 3 nm to about 30 nm, about 4 nm to about 20 nm, about 5 nm to about 10 nm, about 0.1 nm to about 10 nm, about 0.2 nm to about 9 nm, about 0.3 nm to about 8 nm, about 0.4 nm to about 7 nm, about 0.4 nm to about 6 nm, about 0.5 nm to about 5 nm, about 0.6 nm to about 5 nm, about 0.7 nm to about 4 nm, or about 0.8 nm to about 3 nm. The metal oxide nanoparticles can have a mean particle diameter of about 0.1 nm, about 0.25 nm, about 0.5 nm, about 0.75 nm, about 1 nm, about 1.25 nm, about 1.5 nm, about 1.75 nm, about 2 nm, about 2.25 nm, about 2.5 nm, about 2.75 nm, about 3 nm, about 3.25 nm, about 3.5 nm, about 3.75 nm, about 4 nm, about 4.5 nm, about 5 nm, about 5.5 nm, about 6 nm, about 6.5 nm, about 7 nm, about 7.5 nm, about 8 nm, about 8.5 nm, about 9 nm, about 9.5 nm, or about 10 nm. In some embodiments, the metal oxide nanoparticles have a mean particle diameter of about 0.5 nm, about 1 nm, about 1.5 nm, about 2 nm, about 2.5 nm, about 3 nm, about 3.5 nm, about 4 nm, about 4.5 nm, or about 5 nm.

According to the present disclosure, the mesoporous silica-containing shell surrounds the layer of metal oxide nanoparticles. The metal oxide nanoparticles can be surrounded by one or more layers of mesoporous silica-containing shell (e.g., one layer, two layers, three layers, etc.). In one embodiment, the metal oxide nanoparticles are surrounded by one layer of mesoporous silica-containing shell. In another embodiment, the metal oxide nanoparticles are surrounded by two layers of mesoporous silica-containing shell. In another embodiment, the metal oxide nanoparticles are surrounded by three layers of mesoporous silica-containing shell.

According to the present disclosure, the layer of the mesoporous silica-containing shell has total thickness of about 10 nm to about 2000 nm. The thickness of the mesoporous silica-containing shell is a distance between the outer surfaces of the mesoporous silica-containing shell.

When the metal oxide nanoparticles are surrounded by one layer of mesoporous silica-containing shell, the mesoporous silica-containing shell can have a total thickness of about 10 nm to about 500 nm, about 20 nm to about 400 nm, about 30 nm to about 300 nm, about 40 nm to about 200 nm, about 50 nm to about 100 nm, about 60 nm to about 90 nm, about 40 nm to about 60 nm, or about 20 to about 40 nm. In some embodiments, the mesoporous silica-containing shell has total thickness of about 10 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, or about 150 nm. In one embodiment, the mesoporous silica-containing shell has total thickness of about 70 nm.

When the metal oxide nanoparticles are surrounded by two layers of mesoporous silica-containing shell, the total thickness of the mesoporous silica-containing shell can be about 20 nm to about 1000 nm, about 40 nm to about 800 nm, about 60 nm to about 600 nm, about 80 nm to about 400 nm, about 100 nm to about 200 nm, about 120 nm to about 180 nm, about 40 nm to 60 nm, or 20 to 40 nm. In some embodiments, the mesoporous silica-containing shell has total thickness of about 20 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, about 200 nm, about 220 nm, about 240 nm, about 260 nm, about 280 nm, or about 300 nm.

When the metal oxide nanoparticles are surrounded by three layers of mesoporous silica-containing shell, the total thickness of the mesoporous silica-containing shell can be about 30 nm to about 1500 nm, about 60 nm to about 1200 nm, about 90 nm to about 900 nm, about 120 nm to about 600 nm, about 150 nm to about 300 nm, or about 180 nm to about 270 nm. In some embodiments, the mesoporous silica-containing shell has total thickness of about 40 nm, about 60 nm, about 80 nm, about 100 nm, about 120 nm, about 140 nm, about 160 nm, about 180 nm, about 200 nm, about 220 nm, about 240 nm, about 260 nm, about 280 nm, about 300 nm, about 400 nm, or about 500 nm.

When the metal oxide nanoparticles are surrounded by four or more layers of mesoporous silica-containing shell, the total thickness of the mesoporous silica-containing shell can be about 50 nm to about 2000 nm, about 75 nm to about 1750 nm, about 100 nm to about 1500 nm, about 125 nm to about 1250 nm, about 150 nm to about 1000 nm, about 175 nm to about 750 nm, or about 200 nm to about 500 nm. In some embodiments, the mesoporous silica-containing shell has total thickness of about 50 nm, about 75 nm, about 100 nm, about 125 nm, about 150 nm, about 175 nm, about 200 nm, about 225 nm, about 250 nm, about 275 nm, about 300 nm, about 350 nm, about 400 nm, about 500 nm, about 600 nm, about 700 nm, about 800 nm, about 900 nm, about 1000 nm, or about 1500 nm.

According to the present disclosure, the mesoporous silica-containing shell has pores that extend through the shell (from the openings in the outer surface to the inner surface). According to the present disclosure, these pores can have a diameter from about 1 nm to about 10 nm, about 1.5 nm to about 9 nm, about 2 nm to about 8 nm, about 2.5 nm to about 7 nm, about 3 nm to about 6 nm, about 3 nm to about 5 nm, about 3 nm to about 4 nm, or about 2 nm to about 3 nm. In some embodiments, the mesoporous silica-containing shell has a pore diameter of about 2 nm, about 2.5 nm, about 3 nm, about 3.5 nm, about 4 nm, about 4.5 nm, or about 5 nm. In one embodiment, the mesoporous silica-containing shell has a pore diameter of about 3.5 nm.

The pores present in the mesoporous silica-containing shell have a length. The length of the pores is a distance between the inner surface and the outer surface of the mesoporous silica-containing shell. According to the present disclosure, the length of the pores in the mesoporous silica-containing shell depends on the number of layers of mesoporous silica-containing shell surrounding the metal oxide nanoparticles (e.g., one layer, two layers, three layers, etc.).

When the metal oxide nanoparticles are surrounded by one layer of mesoporous silica-containing shell, the length of the pores can be of about 5 nm to about 250 nm, about 10 nm to about 200 nm, about 15 nm to about 150 nm, about 20 nm to about 100 nm, about 25 nm to about 50 nm, or about 30 nm to about 45 nm. In some embodiments, the length of the pores in the mesoporous silica-containing shell is about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, or about 75 nm. In one embodiment, the length of the pores in the mesoporous silica-containing shell is about 35 nm.

In some embodiments, the metal oxide nanoparticles can comprise about 0.0001 wt % to about 20.0 wt % of the catalyst. For example, the metal oxide nanoparticles can comprise about 0.0001 wt % to about 15.0 wt %, about 0.0001 wt % to about 10.0 wt %, about 0.0001 wt % to about 5.0 wt %, about 0.0001 wt % to about 1.0 wt %, about 0.001 wt % to about 20.0 wt %, about 0.001 wt % to about 15.0 wt %, about 0.005 wt % to about 15.0 wt %, about 0.005 wt % to about 10.0 wt %, about 0.01 wt % to about 10.0 wt %, about 0.05 wt % to about 10.0 wt %, about 0.1 wt % to about 10.0 wt %, about 0.1 wt % to about 5.0 wt %, about 1 wt % to about 10.0 wt %, about 1 wt % to about 7.5 wt %, about 2.5 wt % to about 7.5 wt %, about 4 wt % to about 5.5 wt %, or about 4.5 wt % to about 5.5 wt % of the catalyst. In some embodiments, the metal oxide nanoparticles comprise about 3 wt %, about 3.5 wt %, about 4 wt %, about 4.5 wt %, about 5 wt %, about 5.5 wt %, about 6 wt %, about 6.5 wt % of the catalyst. In one embodiment, the metal oxide nanoparticles comprise about 4 wt %, about 4.5 wt %, about 5 wt %, or about 5.5 wt % of the catalyst.

In some embodiments, the metal oxide nanoparticles can comprise less than 0.0001 wt % of the catalyst. For example, the metal oxide nanoparticles can comprise less than 0.0001 wt %, less than 0.00005 wt %, or less than 0.00001 wt % of the catalyst.

In some embodiments, the metal oxide nanoparticles can comprise more than 20 wt % of the catalyst. For example, the metal oxide nanoparticles can comprise more than 25 wt %, more than 30 wt %, more than 35 wt %, more than 40 wt %, more than 45 wt %, more than 50 wt %, more than 55 wt %, more than 60 wt %, or more than 65 wt % of the catalyst.

Another aspect of the present disclosure relates to a process for catalytically hydrogenolyzing a polymer. This process includes providing a polymer and hydrogen and subjecting the polymer to a hydrogenolysis reaction in the presence of a catalyst to cleave the polymer into hydrocarbon segments. The catalyst comprises metal oxide, where the metal oxide is selected from a group consisting of zirconium oxide, titanium oxide, hafnium oxide, lanthanum oxide, cerium oxide, niobium oxide, molybdenum oxide, tungsten oxide, tantalum oxide, scandium oxide, and yttrium oxide.

In some embodiments, the metal oxide is selected from a group consisting of zirconium oxide, titanium oxide, hafnium oxide, lanthanum oxide, cerium oxide, niobium oxide, and molybdenum oxide. In one embodiment, the metal oxide is zirconium oxide.

In some embodiments, the metal oxide is a plurality of the metal oxide nanoparticles.

In some embodiments, the metal oxide comprises about 0.0001 wt % to about 20.0 wt % of the catalyst. For example, the metal oxide comprises about 0.0001 wt % to about 15.0 wt %, about 0.0001 wt % to about 10.0 wt %, about 0.0001 wt % to about 5.0 wt %, about 0.0001 wt % to about 1.0 wt %, about 0.001 wt % to about 20.0 wt %, about 0.001 wt % to about 15.0 wt %, about 0.005 wt % to about 15.0 wt %, about 0.005 wt % to about 10.0 wt %, about 0.01 wt % to about 10.0 wt %, about 0.05 wt % to about 10.0 wt %, about 0.1 wt % to about 10.0 wt %, about 0.1 wt % to about 5.0 wt %, about 1 wt % to about 10.0 wt %, about 1 wt % to about 7.5 wt %, about 2.5 wt % to about 7.5 wt %, about 4 wt % to about 5.5 wt %, or about 4.5 wt % to about 5.5 wt % of the catalyst. In some embodiments, metal oxide comprises about 3 wt %, about 3.5 wt %, about 4 wt %, about 4.5 wt %, about 5 wt %, about 5.5 wt %, about 6 wt %, about 6.5 wt % of the catalyst. In one embodiment, metal oxide comprises about 4 wt %, about 4.5 wt %, about 5 wt %, or about 5.5 wt % of the catalyst.

In some embodiments, the catalyst contains less than 0.0001 wt % of the metal oxide. For example, the catalyst can contain less than 0.0001 wt %, less than 0.00005 wt %, or less than 0.00001 wt % of the metal oxide.

In some embodiments, the catalyst contains more than 20 wt % of the metal oxide. For example, the catalyst can contain more than 25 wt %, more than 30 wt %, more than 35 wt %, more than 40 wt %, more than 45 wt %, more than 50 wt %, more than 55 wt %, more than 60 wt %, or more than 65 wt % of the metal oxide.

Suitable polymers that can be used according to the present disclosure include polyethylene, atactic polypropylene, isotactic polypropylene, highly isotactic polypropylene, syndiotactic polypropylene, polybutene, high density polyethylene, low density polyethylene, linear low density polyethylene, polymethylmethacrylate, or any other polymers polymerizable by a high-pressure free radical process; polyvinylchloride, polybutene-1, isotactic polybutene, ABS resins, polybutadiene (PBD), vulcanized PBD, polystyrene, polyisoprene, ethylene-propylene rubber (EPR), vulcanized EPR, EPDM, and mixtures thereof.

Suitable polymers that can be used according to the present disclosure also include random copolymer of propylene and ethylene, and/or butene, and/or hexene, and/or octene, and/or ethylene vinyl acetate, and/or ethylene methyl acrylate; and/or acrylic acid, and mixtures thereof.

Suitable polymers that can be used according to the present disclosure also include block copolymer, styrenic block copolymers, cross linked polyethylene, copolymers of ethylene and vinyl alcohol (EVOH); polymers of aromatic monomers such as polystyrene, poly-1 esters, polyacetal, polyethylene glycols, and/or polyisobutylene, and mixtures thereof.

In some embodiments, the polymer is selected from the group consisting of physical mixtures of polymers, polymeric blends, copolymers, block copolymers, graft copolymers, and combinations thereof.

In some embodiments, the polymer is a polyolefinic polymer, such as high density polyethylene, isotactic polypropylene, medium density polyethylene, low density polyethylene, linear low density polyethylene, ultra high molecular weight polyethylene, polypropylene, ethylene propylene diene monomer rubber, and combinations thereof.

In some embodiments, the polymer is in a form of a trash bags, fuel tanks, bottle caps, plastic bottles, liquid containers (e.g., bottles for milk, juice, water, and laundry products), tubing, plastic wrap, piping, carpet, roofing, hinges, auto parts, seals, or electrical insulation.

High density polyethylene (HDPE) generally has a density of greater or equal to 0.941 g/cm³, or for example, from 0.941 to 0.97 g/cm³. HDPE has a low degree of branching. High density polyethylene is used to make bottles for milk, juice, water, and laundry products.

Low density polyethylene (LDPE) is a polyethylene with a high degree of branching with long chains. Often, the density of a LDPE will range from 0.910-0.940 g/cm³.

Linear low density polyethylene (LLDPE) is a polyethylene with significant numbers of short branches resulting from copolymerization of ethylene with at least one C₃₋₁₂ α-olefin comonomer, e.g., butene, hexene or octene. Typically, LLDPE has a density in the range of 0.915-0.925 g/cm³. In some embodiments, the LLDPE is an ethylene hexene copolymer, or an ethylene octene copolymer, or an ethylene butene copolymer. The amount of comonomer incorporated can be from 0.5 to 12 mole %, or in some embodiments from 1.5 to 10 mole %, and in other embodiments from 2 to 8 mole % relative to ethylene.

Medium density polyethylene (MDPE) is a polyethylene with some branching and a density in the range of 0.926-0.940 g/cm³.

Ultra high molecular weight polyethylene (UHMWPE) is a thermoplastic. It has extremely long chains, with molecular weight numbering in the millions, usually between 2 and 6 million. The longer chain serves to transfer load more effectively to the polymer backbone by strengthening intermolecular interactions. This results in a very tough material, with the highest impact strength of any thermoplastic presently made.

An isotactic polypropylene is one in which all of the pendant groups are located on the same side of the hydrocarbon backbone chain. Suitable polypropylene that can be used according to the present disclosure includes isotactic and highly isotactic polypropylene. As used herein, “isotactic” is defined as having at least 10% isotactic pentads, preferably having at least 40% isotactic pentads of methyl groups derived from propylene according to analysis by 13C-NMR. As used herein, “highly isotactic” is defined as having at least 60% isotactic pentads according to analysis by 13C-NMR.

Polymers that can be used according to the present disclosure also include blended films and multi-layer laminates.

In some embodiments, the polymer is high density polyethylene having a number average molecular weight (Mₙ) of 5000-100000 Da.

According to the present disclosure, the step of subjecting the polymer to a hydrogenolysis reaction in the presence of a catalyst can be carried out at a hydrogen partial pressure of about 15 psia to about 1000 psia, about 20 psia to about 800 psia, about 50 psia to about 500 psia, about 75 psia to about 250 psia, or about 100 psia to about 200 psia.

According to the present disclosure, the step of subjecting the polymer to a hydrogenolysis reaction in the presence of a catalyst can be carried out at a temperature of about 150° C. to about 400° C., about 200° C. to about 350° C., or about 550° C. to about 300° C.

In some embodiments, the catalyst comprises a plurality of metal oxide nanoparticles; and a mesoporous silica-containing shell surrounding the plurality of metal oxide nanoparticles. The mesoporous silica-containing shell has an outer surface and an inner surface inside the outer surface, the outer surface having openings leading to pores extending through the mesoporous silica-containing shell to the inner surface. The metal oxide is selected from a group consisting of zirconium oxide, hafnium oxide, titanium oxide, niobium oxide, cerium oxide, molybdenum oxide, scandium oxide, yttrium oxide, and lanthanum oxide.

In some embodiments, the metal oxide is selected from a group consisting of zirconium oxide, hafnium oxide, titanium oxide, niobium oxide, cerium oxide, and molybdenum oxide. In one embodiment, the metal oxide is zirconium oxide.

In some embodiments, the plurality of metal oxide nanoparticles is present in the form of a layer.

In one embodiment, the metal oxide nanoparticles are zirconia oxide nanoparticles.

In some embodiments, the metal oxide is an amorphous material. In one embodiment, the zirconia oxide nanoparticles are amorphous zirconia oxide nanoparticles.

In some embodiments, the metal oxide is a crystalline material. In one embodiment, the zirconia oxide nanoparticles are crystalline zirconia oxide nanoparticles.

In some embodiments, the metal oxide is a nanocrystalline material.

According to the present disclosure, the metal oxide can have a mean particle diameter of about 0.5 to about 100 nm, about 1 to about 100 nm, about 10 to about 100 nm, about 20 to about 100 nm, about 40 to about 100 nm, about 50 to about 100 nm, about 10 to about 90 nm, about 10 to about 80 nm, about 10 to about 70 nm, about 10 to about 60 nm, about 10 to about 50 nm, about 10 to about 40 nm, about 10 to about 30 nm, about 10 to about 20 nm, about 1 to about 50 nm, about 1 to about 40 nm, about 1 to about 20 nm, about 5 to about 20 nm, about 5 to about 15 nm, about 5 to about 10 nm, about 6 to about 9 nm, about 7 to about 8 nm, about 0.5 to about 10 nm, about 0.5 to about 9 nm, about 0.5 to about 8 nm, about 0.5 to about 7 nm, about 0.5 to about 6 nm, about 0.5 to about 5 nm, about 0.5 to about 4 nm, about 0.5 to about 3 nm, or about 0.5 to about 2 nm.

According to the present disclosure, the metal oxide nanoparticles have a mean particle diameter of about 0.1 nm to about 1000 nm, about 1 nm to about 1000 nm, about 5 nm to about 1000 nm, about 10 nm to about 1000 nm, about 15 nm to about 1000 nm, about 20 nm to about 1000 nm, about 10 nm to about 900 nm, about 10 nm to about 800 nm, about 10 nm to about 700 nm, about 10 nm to about 600 nm, about 10 nm to about 500 nm, about 10 nm to about 400 nm, about 10 nm to about 300 nm, about 10 nm to about 200 nm, about 10 nm to about 100 nm, about 0.1 nm to about 500 nm, about 0.1 nm to about 250 nm, about 0.1 nm to about 100 nm, about 0.1 nm to about 50 nm, about 1 nm to about 500 nm, about 1 nm to about 50 nm, about 2 nm to about 40 nm, about 3 nm to about 30 nm, about 4 nm to about 20 nm, about 5 nm to about 10 nm, about 0.1 nm to about 10 nm, about 0.2 nm to about 9 nm, about 0.3 nm to about 8 nm, about 0.4 nm to about 7 nm, about 0.4 nm to about 6 nm, about 0.5 nm to about 5 nm, about 0.6 nm to about 5 nm, about 0.7 nm to about 4 nm, or about 0.8 nm to about 3 nm. The metal oxide nanoparticles have a mean particle diameter of about 0.1 nm, about 0.25 nm, about 0.5 nm, about 0.75 nm, about 1 nm, about 1.25 nm, about 1.5 nm, about 1.75 nm, about 2 nm, about 2.25 nm, about 2.5 nm, about 2.75 nm, about 3 nm, about 3.25 nm, about 3.5 nm, about 3.75 nm, about 4 nm, about 4.5 nm, about 5 nm, about 5.5 nm, about 6 nm, about 6.5 nm, about 7 nm, about 7.5 nm, about 8 nm, about 8.5 nm, about 9 nm, about 9.5 nm, or about 10 nm. In some embodiments, the metal oxide nanoparticles have a mean particle diameter of about 0.5 nm, about 1 nm, about 1.5 nm, about 2 nm, about 2.5 nm, about 3 nm, about 3.5 nm, about 4 nm, about 4.5 nm, or about 5 nm.

According to the present disclosure, the catalyst comprises the mesoporous silica-containing shell surrounds the layer of metal oxide nanoparticles. The metal oxide nanoparticles can be surrounded by one or more layers of mesoporous silica-containing shell (e.g., one layer, two layers, three layers, etc.). In one embodiment, the metal oxide nanoparticles are surrounded by one layer of mesoporous silica-containing shell. In another embodiment, the metal oxide nanoparticles are surrounded by two layers of mesoporous silica-containing shell. In another embodiment, the metal oxide nanoparticles are surrounded by three layers of mesoporous silica-containing shell.

According to the present disclosure, the layer of the mesoporous silica-containing shell has total thickness of about 10 nm to about 2000 nm. The thickness of the mesoporous silica-containing shell is a distance between the outer surfaces of the mesoporous silica-containing shell.

When the metal oxide nanoparticles are surrounded by one layer of mesoporous silica-containing shell, the mesoporous silica-containing shell can have a total thickness of about 10 nm to about 500 nm, about 20 nm to about 400 nm, about 30 nm to about 300 nm, about 40 nm to about 200 nm, about 50 nm to about 100 nm, or about 60 nm to about 90 nm. In some embodiments, the mesoporous silica-containing shell has total thickness of about 10 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, or about 150 nm. In one embodiment, the mesoporous silica-containing shell has total thickness of about 70 nm.

When the metal oxide nanoparticles are surrounded by two layers of mesoporous silica-containing shell, the total thickness of the mesoporous silica-containing shell can be about 20 nm to about 1000 nm, about 40 nm to about 800 nm, about 60 nm to about 600 nm, about 80 nm to about 400 nm, about 100 nm to about 200 nm, or about 120 nm to about 180 nm. In some embodiments, the mesoporous silica-containing shell has total thickness of about 20 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, about 200 nm, about 220 nm, about 240 nm, about 260 nm, about 280 nm, or about 300 nm.

When the metal oxide nanoparticles are surrounded by three layers of mesoporous silica-containing shell, the total thickness of the mesoporous silica-containing shell can be about 30 nm to about 1500 nm, about 60 nm to about 1200 nm, about 90 nm to about 900 nm, about 120 nm to about 600 nm, about 150 nm to about 300 nm, or about 180 nm to about 270 nm. In some embodiments, the mesoporous silica-containing shell has total thickness of about 40 nm, about 60 nm, about 80 nm, about 100 nm, about 120 nm, about 140 nm, about 160 nm, about 180 nm, about 200 nm, about 220 nm, about 240 nm, about 260 nm, about 280 nm, about 300 nm, about 400 nm, or about 500 nm.

When the metal oxide nanoparticles are surrounded by four or more layers of mesoporous silica-containing shell, the total thickness of the mesoporous silica-containing shell can be about 50 nm to about 2000 nm, about 75 nm to about 1750 nm, about 100 nm to about 1500 nm, about 125 nm to about 1250 nm, about 150 nm to about 1000 nm, about 175 nm to about 750 nm, or about 200 nm to about 500 nm. In some embodiments, the mesoporous silica-containing shell has total thickness of about 50 nm, about 75 nm, about 100 nm, about 125 nm, about 150 nm, about 175 nm, about 200 nm, about 225 nm, about 250 nm, about 275 nm, about 300 nm, about 350 nm, about 400 nm, about 500 nm, about 600 nm, about 700 nm, about 800 nm, about 900 nm, about 1000 nm, or about 1500 nm.

According to the present disclosure, the pores present in the mesoporous silica-containing shell can have a diameter from about 1 nm to about 10 nm, about 1.5 nm to about 9 nm, about 2 nm to about 8 nm, about 2.5 nm to about 7 nm, about 3 nm to about 6 nm, about 3 nm to about 5 nm, or about 3 nm to about 4 nm. In some embodiments, the mesoporous silica-containing shell has a pore diameter of about 2 nm, about 2.5 nm, about 3 nm, about 3.5 nm, about 4 nm, about 4.5 nm, or about 5 nm. In one embodiment, the mesoporous silica-containing shell has a pore diameter of about 3.5 nm.

When the metal oxide nanoparticles are surrounded by one layer of mesoporous silica-containing shell, the length of the pores can be of about 5 nm to about 250 nm, about 10 nm to about 200 nm, about 15 nm to about 150 nm, about 20 nm to about 100 nm, about 25 nm to about 50 nm, or about 30 nm to about 45 nm. In some embodiments, the length of the pores in the mesoporous silica-containing shell is about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, or about 75 nm. In one embodiment, the length of the pores in the mesoporous silica-containing shell is about 35 nm.

In some embodiments, the metal oxide nanoparticles can comprise about 0.0001 wt % to about 20.0 wt % of the catalyst. For example, the metal oxide nanoparticles can comprise about 0.0001 wt % to about 15.0 wt %, about 0.0001 wt % to about 10.0 wt %, about 0.0001 wt % to about 5.0 wt %, about 0.0001 wt % to about 1.0 wt %, about 0.001 wt % to about 20.0 wt %, about 0.001 wt % to about 15.0 wt %, about 0.005 wt % to about 15.0 wt %, about 0.005 wt % to about 10.0 wt %, about 0.01 wt % to about 10.0 wt %, about 0.05 wt % to about 10.0 wt %, about 0.1 wt % to about 10.0 wt %, about 0.1 wt % to about 5.0 wt %, about 1 wt % to about 10.0 wt %, about 1 wt % to about 7.5 wt %, about 2.5 wt % to about 7.5 wt %, about 4 wt % to about 5.5 wt %, or about 4.5 wt % to about 5.5 wt % of the catalyst. In some embodiments, the metal oxide nanoparticles comprise about 3 wt %, about 3.5 wt %, about 4 wt %, about 4.5 wt %, about 5 wt %, about 5.5 wt %, about 6 wt %, about 6.5 wt % of the catalyst. In one embodiment, the metal oxide nanoparticles comprise about 4 wt %, about 4.5 wt %, about 5 wt %, or about 5.5 wt % of the catalyst.

In some embodiments, the metal oxide nanoparticles can comprise less than 0.0001 wt % of the catalyst. For example, the metal oxide nanoparticles can comprise less than 0.0001 wt %, less than 0.00005 wt %, or less than 0.00001 wt % of the catalyst.

In some embodiments, the metal oxide nanoparticles can comprise more than 20 wt % of the catalyst. For example, the metal oxide nanoparticles can comprise more than 25 wt %, more than 30 wt %, more than 35 wt %, more than 40 wt %, more than 45 wt %, more than 50 wt %, more than 55 wt %, more than 60 wt %, or more than 65 wt % of the catalyst.

According to the present disclosure, the pores of the mesoporous silica-containing shell have a diameter selected to permit a length of the polymer to enter the pores which yield a particular segment length as a result of hydrogenolysis.

In some embodiments, the products that are formed during the hydrogenolysis reaction leave the catalyst through pores present in the mesoporous silica-containing shell. These products are different from the reactant which entered the mesoporous silica-containing shell.

In some embodiments, the polymer has a longitudinal extent between opposed ends and the step of subjecting the polymer to a hydrogenolysis reaction comprises extending an end of the polymer through the openings and into the pores of the mesoporous silica shell and cleaving the polymer into hydrocarbon segments in the pores using the metal oxide.

In some embodiments, the products that are formed during the hydrogenolysis reaction include gases, liquids, and/or waxes.

In some embodiments, the product is a liquid containing from C₅ to C₂₀ hydrocarbons, from C₁₂ to C₂₀ hydrocarbons, from C₆ to C₁₈ hydrocarbons, from C to C₁₆ hydrocarbons, from C₆ to C₁₆ hydrocarbons, or from C₅ to C₁₅ hydrocarbons. In some embodiments, the liquid has Gaussian-type centered distribution from C₆ to C₁₈, from C₈ to C₁₆, from C₆ to C₁₆, or from C₅ to C₁₈ of hydrocarbons. In some embodiments, the liquid has Gaussian-type C₁₂-, C₁₃-, C₁₄-, C₁₅-, C₁₆-, C₁₇-, C₁₈-, C₁₉-, C₂₀-, C₂₁-, C₂₂-, C₂₃-, C₂₄-, or C₂₅-centered distribution of hydrocarbons. Typically, the hydrocarbons can be linear or branched, wherein the heavier hydrocarbons tend to be branched to form liquids.

In some embodiments, the product is a wax containing from C₁₆ to C₁₀₀ hydrocarbons, from C₂₀ to C₈₀ hydrocarbons, from C₂₅ to C₆₀ hydrocarbons, or from C₃₀ to C₅₀ hydrocarbons. In some embodiments, the wax has Gaussian-type centered distribution from C₁₆ to C₁₀₀, from C₂₀ to C₈₀, from C₂₅ to C₆₀, or from C₃₀ to C₅₀ of hydrocarbons. In some embodiments, the wax has Gaussian-type C₂₀-, C₂₁-, C₂₂-, C₂₃-, C₂₄-, C₂₅-, C₂₆-, C₂₇-, C₂₈-, C₂₉-, C₃₀-, C₃₁-, C₃₂-, C₃-, C₃₄-, C₃₅-, C₃₆-, C₃₇-, C₃₈-, C₃₉-, or C₄₀-centered distribution of hydrocarbons. Typically, linear C₁₆ to C₁₀₀ hydrocarbons form waxes.

Another aspect of the present disclosure relates to a method of preparing a catalyst. This method includes: providing a graphene oxide; providing a metal containing compound; adding the metal containing compound to the graphene oxide to form a plurality of metal oxide hydrate nanoparticles supported on the graphene oxide. The method further involves contacting the plurality of metal oxide hydrate nanoparticles supported on the graphene oxide with a silicon containing compound and a pore structure-directing agent to produce a mesoporous silica-containing shell surrounding the plurality of metal oxide hydrate nanoparticles supported on the graphene oxide, where the mesoporous silica-containing shell has an outer surface and an inner surface inside the outer surface, the outer surface having openings leading to pores extending through the mesoporous silica-containing shell to the inner surface. This method further involves calcinating the mesoporous silica-containing shell containing the plurality of metal oxide hydrate nanoparticles supported on graphene oxide to produce a mesoporous silica-containing shell surrounding the plurality of metal oxide nanoparticles, where the mesoporous silica-containing shell has an outer surface and an inner surface inside the outer surface, the outer surface having openings leading to pores extending through the mesoporous silica-containing shell to the inner surface; where the metal oxide is selected from a group consisting of zirconium oxide, hafnium oxide, titanium oxide, niobium oxide, cerium oxide, molybdenum oxide, scandium oxide, yttrium oxide, and lanthanum oxide.

In some embodiments, graphene oxide was added to a solution of urea in water (such as DI-water) and the mixture was treated in an ultrasonication bath prior to the step of adding the metal containing compound. Ultrasonication can be carried out for about 10 min, about 20 min, about 30 min, about 40 min, about 50 min, or about 60 min. In some embodiments, after ultrasonication, a suspension of graphene oxide is formed.

In some embodiments, the metal containing compound is dissolved in a suitable solvent prior to adding it to graphene oxide. Suitable solvents that can be used to dissolve metal containing compound include water, such as DI-water, alcohols, amines, acetonitrile, acetone, acetic acid, dimethyl sulfoxide, and tetrahydrofuran.

In some embodiments, the solution of metal containing compound is added to the suspension of graphene oxide to form a plurality of metal oxide hydrate nanoparticles supported on the graphene oxide.

In some embodiments, the plurality of metal oxide hydrate nanoparticles supported on the graphene oxide are formed by stirring the mixture containing metal containing compound and suspension graphene oxide.

In some embodiments, the method of preparing a catalyst includes washing the mesoporous silica-containing shell containing the plurality of metal hydrate oxide nanoparticles supported on graphene oxide prior to calcinating.

In some embodiments, the metal oxide is selected from a group consisting of zirconium oxide, hafnium oxide, titanium oxide, niobium oxide, cerium oxide, and molybdenum oxide. In one embodiment, the metal oxide is zirconium oxide.

In some embodiments, the plurality of metal oxide nanoparticles is present in the form of a layer.

In some embodiments, the plurality of metal oxide nanoparticles is present in the form of a uniform layer. In other embodiments, the plurality of metal oxide nanoparticles is not uniformly distributed.

In one embodiment, the metal oxide nanoparticles are zirconia oxide nanoparticles.

In some embodiments, the metal oxide is an amorphous material. In one embodiment, the zirconia oxide nanoparticles are amorphous zirconia oxide nanoparticles.

In some embodiments, the metal oxide is a crystalline material. In one embodiment, the zirconia oxide nanoparticles are crystalline zirconia oxide nanoparticles.

In some embodiments, the metal oxide is a nanocrystalline material.

According to the present disclosure, the metal oxide nanoparticles have a mean particle diameter of about 0.1 nm to about 1000 nm, about 1 nm to about 1000 nm, about 5 nm to about 1000 nm, about 10 nm to about 1000 nm, about 15 nm to about 1000 nm, about 20 nm to about 1000 nm, about 10 nm to about 900 nm, about 10 nm to about 800 nm, about 10 nm to about 700 nm, about 10 nm to about 600 nm, about 10 nm to about 500 nm, about 10 nm to about 400 nm, about 10 nm to about 300 nm, about 10 nm to about 200 nm, about 10 nm to about 100 nm, about 0.1 nm to about 500 nm, about 0.1 nm to about 250 nm, about 0.1 nm to about 100 nm, about 0.1 nm to about 50 nm, about 1 nm to about 500 nm, about 1 nm to about 50 nm, about 2 nm to about 40 nm, about 3 nm to about 30 nm, about 4 nm to about 20 nm, about 5 nm to about 10 nm, about 0.1 nm to about 10 nm, about 0.2 nm to about 9 nm, about 0.3 nm to about 8 nm, about 0.4 nm to about 7 nm, about 0.4 nm to about 6 nm, about 0.5 nm to about 5 nm, about 0.6 nm to about 5 nm, about 0.7 nm to about 4 nm, or about 0.8 nm to about 3 nm. The metal oxide nanoparticles have a mean particle diameter of about 0.1 nm, about 0.25 nm, about 0.5 nm, about 0.75 nm, about 1 nm, about 1.25 nm, about 1.5 nm, about 1.75 nm, about 2 nm, about 2.25 nm, about 2.5 nm, about 2.75 nm, about 3 nm, about 3.25 nm, about 3.5 nm, about 3.75 nm, about 4 nm, about 4.5 nm, about 5 nm, about 5.5 nm, about 6 nm, about 6.5 nm, about 7 nm, about 7.5 nm, about 8 nm, about 8.5 nm, about 9 nm, about 9.5 nm, or about 10 nm. In some embodiments, the metal oxide nanoparticles have a mean particle diameter of about 0.5 nm, about 1 nm, about 1.5 nm, about 2 nm, about 2.5 nm, about 3 nm, about 3.5 nm, about 4 nm, about 4.5 nm, or about 5 nm.

According to the present disclosure, the catalyst comprises the mesoporous silica-containing shell surrounds the layer of metal oxide nanoparticles. The metal oxide nanoparticles can be surrounded by one or more layers of mesoporous silica-containing shell (e.g., one layer, two layers, three layers, etc.). In one embodiment, the metal oxide nanoparticles are surrounded by one layer of mesoporous silica-containing shell. In another embodiment, the metal oxide nanoparticles are surrounded by two layers of mesoporous silica-containing shell. In another embodiment, the metal oxide nanoparticles are surrounded by three layers of mesoporous silica-containing shell.

According to the present disclosure, the layer of the mesoporous silica-containing shell has total thickness of about 10 nm to about 2000 nm. The thickness of the mesoporous silica-containing shell is a distance between the outer surfaces of the mesoporous silica-containing shell.

When the metal oxide nanoparticles are surrounded by one layer of mesoporous silica-containing shell, the mesoporous silica-containing shell can have a total thickness of about 10 nm to about 500 nm, about 20 nm to about 400 nm, about 30 nm to about 300 nm, about 40 nm to about 200 nm, about 50 nm to about 100 nm, or about 60 nm to about 90 nm. In some embodiments, the mesoporous silica-containing shell has total thickness of about 10 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, or about 150 nm. In one embodiment, the mesoporous silica-containing shell has total thickness of about 70 nm.

When the metal oxide nanoparticles are surrounded by two layers of mesoporous silica-containing shell, the total thickness of the mesoporous silica-containing shell can be about 20 nm to about 1000 nm, about 40 nm to about 800 nm, about 60 nm to about 600 nm, about 80 nm to about 400 nm, about 100 nm to about 200 nm, or about 120 nm to about 180 nm. In some embodiments, the mesoporous silica-containing shell has total thickness of about 20 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, about 200 nm, about 220 nm, about 240 nm, about 260 nm, about 280 nm, or about 300 nm.

When the metal oxide nanoparticles are surrounded by three layers of mesoporous silica-containing shell, the total thickness of the mesoporous silica-containing shell can be about 30 nm to about 1500 nm, about 60 nm to about 1200 nm, about 90 nm to about 900 nm, about 120 nm to about 600 nm, about 150 nm to about 300 nm, or about 180 nm to about 270 nm. In some embodiments, the mesoporous silica-containing shell has total thickness of about 40 nm, about 60 nm, about 80 nm, about 100 nm, about 120 nm, about 140 nm, about 160 nm, about 180 nm, about 200 nm, about 220 nm, about 240 nm, about 260 nm, about 280 nm, about 300 nm, about 400 nm, or about 500 nm.

When the metal oxide nanoparticles are surrounded by four or more layers of mesoporous silica-containing shell, the total thickness of the mesoporous silica-containing shell can be about 50 nm to about 2000 nm, about 75 nm to about 1750 nm, about 100 nm to about 1500 nm, about 125 nm to about 1250 nm, about 150 nm to about 1000 nm, about 175 nm to about 750 nm, or about 200 nm to about 500 nm. In some embodiments, the mesoporous silica-containing shell has total thickness of about 50 nm, about 75 nm, about 100 nm, about 125 nm, about 150 nm, about 175 nm, about 200 nm, about 225 nm, about 250 nm, about 275 nm, about 300 nm, about 350 nm, about 400 nm, about 500 nm, about 600 nm, about 700 nm, about 800 nm, about 900 nm, about 1000 nm, or about 1500 nm.

According to the present disclosure, the pores present in the mesoporous silica-containing shell can have a diameter from about 1 nm to about 10 nm, about 1.5 nm to about 9 nm, about 2 nm to about 8 nm, about 2.5 nm to about 7 nm, about 3 nm to about 6 nm, about 3 nm to about 5 nm, or about 3 nm to about 4 nm. In some embodiments, the mesoporous silica-containing shell has a pore diameter of about 2 nm, about 2.5 nm, about 3 nm, about 3.5 nm, about 4 nm, about 4.5 nm, or about 5 nm. In one embodiment, the mesoporous silica-containing shell has a pore diameter of about 3.5 nm.

When the metal oxide nanoparticles are surrounded by one layer of mesoporous silica-containing shell, the length of the pores can be of about 5 nm to about 250 nm, about 10 nm to about 200 nm, about 15 nm to about 150 nm, about 20 nm to about 100 nm, about 25 nm to about 50 nm, or about 30 nm to about 45 nm. In some embodiments, the length of the pores in the mesoporous silica-containing shell is about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, or about 75 nm. In one embodiment, the length of the pores in the mesoporous silica-containing shell is about 35 nm.

In some embodiments, the metal oxide nanoparticles can comprise about 0.0001 wt % to about 20.0 wt % of the catalyst. For example, the metal oxide nanoparticles can comprise about 0.0001 wt % to about 15.0 wt %, about 0.0001 wt % to about 10.0 wt %, about 0.0001 wt % to about 5.0 wt %, about 0.0001 wt % to about 1.0 wt %, about 0.001 wt % to about 20.0 wt %, about 0.001 wt % to about 15.0 wt %, about 0.005 wt % to about 15.0 wt %, about 0.005 wt % to about 10.0 wt 9%, about 0.01 wt % to about 10.0 wt %, about 0.05 wt % to about 10.0 wt %, about 0.1 wt % to about 10.0 wt %, about 0.1 wt % to about 5.0 wt %, about 1 wt % to about 10.0 wt %, 1 wt % to about 7.5 wt %, about 2.5 wt % to about 7.5 wt %, about 4 wt % to about 5.5 wt %, or about 4.5 wt % to about 5.5 wt % of the catalyst. In some embodiments, the metal oxide nanoparticles comprise about 3 wt %, about 3.5 wt %, about 4 wt %, about 4.5 wt %, about 5 wt %, about 5.5 wt %, about 6 wt %, about 6.5 wt % of the catalyst. In one embodiment, the metal oxide nanoparticles comprise about 4 wt %, about 4.5 wt %, about 5 wt %, or about 5.5 wt % of the catalyst.

In some embodiments, the metal oxide nanoparticles can comprise less than 0.0001 wt % of the catalyst. For example, the metal oxide nanoparticles can comprise less than 0.0001 wt %, less than 0.00005 wt %, or less than 0.00001 wt % of the catalyst.

In some embodiments, the metal oxide nanoparticles can comprise more than 20 wt % of the catalyst. For example, the metal oxide nanoparticles can comprise more than 25 wt %, more than 30 wt %, more than 35 wt %, more than 40 wt %, more than 45 wt %, more than 50 wt %, more than 55 wt %, more than 60 wt %, or more than 65 wt % of the catalyst.

In some embodiments, the metal oxide hydrate nanoparticles are zirconium oxyhydroxide nanoparticles.

In some embodiments, the metal containing compound is a metal salt. In some embodiments, the metal salt is selected from a group consisting of zirconium (IV) chloride, irconium (IV) isopropoxide, hafnium (IV) oxychloride hydrate, hafnium (IV) chloride, titanium (IV) isopropoxide, titanium (IV) chloride, cerium (III) nitrate hexahydrate, niobium (V) oxalate, niobium (V) chloride, bis(acetylacetonato)dioxomolybdenum (VI), and ammonium molybdate.

In some embodiments, the graphene oxide is provided in the form of a single-layer graphene oxide sheet.

In some embodiments, the plurality of metal oxide hydrate nanoparticles covers both top and bottom sides of the graphene oxide sheet. In some embodiments, the plurality of metal oxide hydrate nanoparticles covers all the sides of the graphene oxide sheet.

Before the calcination step, the pores in the mesoporous silica-containing shell are filled with the pore structure-directing agent. During the calcination step, the pore structure-directing agent is removed from the pores.

Also, during the calcination step the metal oxide hydrate nanoparticles supported on the graphene oxide are converted into metal oxide particles and graphene oxide is removed.

According to the present disclosure, the calcination step can be conducted at about 400 to about at 700° C., about 400 to about at 600° C., or about 450 to about at 650° C. In some embodiments, the calcination step is performed at about 400° C., about at 450° C., about at 500° C., about at 550° C., or about at 600° C. In one embodiment, the calcination step is performed at about at 500° C.

In some embodiments, the silicon-containing compound is tetraethyl orthosilicate.

In some embodiments, the pore structure-directing agents are ionic surfactants (e.g., myristyltrimethylammonium bromide, hexadecyltrimethylammonium bromide, tetradecyltrimethylammonium bromide, dodecyltrimethylammonium bromide, etc.) or block copolymers (e.g., P123, Pluronic F127, etc.).

The above disclosure is general. A more specific description is provided below in the following examples. The examples are described solely for the purpose of illustration and are not intended to limit the scope of the present application. Changes in form and substitution of equivalents are contemplated as circumstances suggest or render expedient. Although specific terms have been employed herein, such terms are intended in a descriptive sense and not for purposes of limitation.

### EXAMPLES

The following Examples are presented to illustrate various aspects of the present application, but are not intended to limit the scope of the claimed application.

### Example 1—Chemicals and Materials

All chemicals and starting materials used were commercially obtained and used as received without further purification. Zirconium oxide (30 nm) (ZrO₂-30) was purchased from Aldrich. Single-layer graphene oxide (GO, 99 wt. %) was purchased from Cheap Tubes Inc. Zirconium tetrachloride (ZrCl₄, 99.99%) was purchased from Alfa Aesar. Urea (CH₄N₂O, 99%) and sodium hydroxide (98%) were purchased from Fisher Scientific. Tetraethyl orthosilicate (TEOS, 98%), hexadecyltrimethylammonium bromide (CTAB, >98%), ethylenediamine (>99%), hydrochloric acid (35-38%, TraceMetal grade), hydrofluoric acid (48-51% solution in water, TraceMetal grade), nitric acid (67-71%, TraceMetal grade), and polyethylene (PE, Mₙ=20 kDa, M_{w}=96 kDa, Ð=4.8) were purchased from Alfa Aesar. All three inorganic acids were certified to contain less than <1 ppb of Co, Cu, Fe, Ni, Ru, Pd, Pt, Rh, Al, Sb, As, Ba, Be, Bi, Cd, Ca, Ce, Cs, Cr, Dy, Er, Eu, Gd, Ga, Ge, Au, Hf, Ho, In, La, Pb, Li, Lu, Mg, Mn, Hg, Mo, Na, Nd, Nb, K, Pr, Re, Rb, Sm, Sc, Sc, Ag, Na, Sr, Ta, Te, Tb, Tl, Th, Tm, Sn, Ti, W, U, V, Yb, Y, Zn, and Zr. The deionized water (DI-H₂O) was generated with a Millipore water purification system (Milli-Q plus) operating at a resistivity of 18.2 MΩ·cm @ 25° C.

### Example 2—Synthesis of L-ZrO₂@mSiO₂

L-ZrO₂@mSiO₂ was prepared through a two-step synthesis method. In the first step, precipitated zirconium oxyhydroxide nanoparticles were deposited onto single-layer graphene oxide (GO) in an aqueous solution to give ZrO₂₋ₓ(OH)₂ₓ/GO. That material was prepared as follows: urea (0.150 g) was dissolved in DI-H₂O (100 mL), GO (10 mg) was added, and the mixture was treated in an ultrasonication bath for 30 min. An aqueous solution of ZrCl₄ (0.024 g in 1.25 mL of H₂O) was added dropwise to the GO suspension, and the mixture was stirred for 3 hours at room temperature. The mixture was subsequently stirred and heated at 90° C. for 12 hours. The solid ZrO₂₋ₓ(OH)₂ₓ/GO product was collected by centrifugation, washed with DI-H₂O (3×50 mL), and then dispersed into H₂O (10 mL). In the second step, mesoporous silica (mSiO₂) layers were grown onto ZrO₂₋ₓ(OH)₂ₓ/GO following the procedure described below for the synthesis of mSiO₂ platelets. The final product was characterized and displayed a double-layered platelet structure with ultrasmall ZrO₂ nanoparticles in the narrow core.

### Example 3—Catalytic Hydrogenolysis

The catalytic hydrogenolysis of polyolefins was performed in a glass-lined high-pressure autoclave reactor (250 mL, Parr Instruments) equipped with a mechanical impeller-style stirrer and a thermocouple that extends into the melted polymer (Tennakoon et al., “Catalytic Upcycling of High-Density Polyethylene Via a Processive Mechanism,” Nat. Catal. 3:893-901 (2020), which is hereby incorporated by reference in its entirety). Polyethylene (PE) (3.0 g, Mₙ=20,000, Ð=4.8) and a catalyst (5.5 mg) were placed into the glass-lined reaction vessel. The reactor was assembled, and the system was evacuated under reduced pressure (100 Pa) and then refilled with Ar (3×). H₂ was introduced to the desired pressure (0.482 MPa) at room temperature, and the reactor was sealed. The reactor was heated to 300° C., the gauge pressure increased to 0.896 MPa for experiments running 2-20 hours. All pressure values are reported as the absolute pressure at reaction temperature (0.992 MPa=0.896 MPa on the pressure gauge). At the end of the designated time, the reactor was allowed to cool to room temperature. The volatile products were sampled by connecting the cooled reactor to a GC sampling loop and analyzed by gas chromatography-flame ionized detector (GC-FID) and GC-thermal conductivity detector (TCD). The mass yield of gas-phase products was obtained from direct GC-calibrated quantitative analysis of C₁-C₉ hydrocarbons separated on an Agilent Technologies 5890 GC system using an Agilent J&W GS-GasPro (0.32 mm×15 m) capillary column (GC-FID). H₂ was quantified with respect to a He internal standard using a Supelco Carboxen 1000 (15 ft.×⅛ in.×2.1 mm SS) packed column (GC-TCD). Dichloromethane was added to the reactor, which was rescaled and heated to 100° C. The reactor was cooled, and the mixture was filtered on a Buchner funnel to separate residual insoluble polymer from the dichloromethane-soluble liquid products. The volatile components were evaporated in a rotary evaporator, and the yields of extracted liquid species and solid materials were measured. The soluble materials were analyzed by calibrated gas chromatography-mass spectrometry (GC-MS) using an Agilent Technologies 7890A GC system equipped with an FID or an Agilent Technologies 5975 C inert MSD mass spectrometer on an Agilent J&W DB-5ht ((5%-phenyl)-methylpolysiloxane, 0.25 mm×30 m×0.1 μm) capillary column (see Quantification of Liquid Products for details). The solid portion was dissolved in 1,2,4-trichlorobenzene (TCB) at 150° C. and analyzed by high temperature gel permeation chromatography (HT-GPC).

### Example 4—Analysis

### Analysis of Reaction Products

The solid polymeric residue was analyzed by HT-GPC (Agilent-Polymer Laboratories 220) to determine the molecular weights (Mₙ and M_{w}) and molecular weight distributions (Ð=M_{w}/Mₙ). The HT-GPC was equipped with refractive index (RI) and viscometry detectors. Monodisperse polyethylene standards (PSS Polymer Standards Service, Inc.) were used for calibration ranging from ˜330 Da to ˜ 120 kDa. The column set included 3 Agilent PL-Gel Mixed B columns and 1 PL-Gel Mixed B guard column. 1,2,4-Trichlorobenzene (TCB) containing 0.01 wt % 3,5-di-tert-butyl-4-hydroxytoluene (BHT) was used as the eluent at a flow rate of 1.0 mL/min at 160° C. The lubricant samples were prepared in TCB at a concentration of ˜5.0 mg/mL and heated at 150° C. for 24 hours prior to injection.

### Quantification of Liquid Products

The composition of the dichloromethane-extracted liquid products, in terms of amounts of each chain length in the samples, was estimated using previously reported approach (Tennakoon et al., “Catalytic Upcycling of High-Density Polyethylene Via a Processive Mechanism,” Nat. Catal. 3:893-901 (2020), which is hereby incorporated by reference in its entirety), summarized here briefly for convenience: A GC-MS of the ASTM standard was integrated. A plot of integrated area vs. carbon number allowed the determination of response of all Cn (since ASTM standard does not include C₁₃, C₁₉, C₂₁, etc.) by interpolation. The regions of C₆-C₂₀ and C₂₀-C₄₀ were linear, but with inequivalent slopes. Therefore, these two regions were fit separately and used as calibration curves for liquid products.

### Example 5-Characterization of Catalytic Materials for Comparisons with L-ZrO₂@mSiO₂

Synthesis of mSiO₂ Platelets

Mesoporous silica platelets (mSiO₂) were prepared following a procedure adapted from the literature (Wang et al., “Graphene Oxide-Periodic Mesoporous Silica Sandwich Nanocomposites with Vertically Oriented Channels,” ACS Nano 4:7437-7450 (2010), which is hereby incorporated by reference in its entirety). GO (30 mg), hexadecyltrimethylammonium bromide (CTAB) (1.00 g, 2.74 mmol), and sodium hydroxide (0.2 g, 5.0 mmol) were first added into deionized water (DI-H₂O, 45 mL), and then the mixture was subjected to ultrasonication for 3 hours. The mixture was heated to 40° C. and stirred rapidly for 1 hour, and then tetraethyl orthosilicate (TEOS) (1 mL, 0.94 g, 9.6 mmol) was added in a dropwise fashion to grow mesoporous silica on GO. The reaction mixture was further heated at 40° C. for 24 hours. The solid product was collected by centrifugation, washed with DI-H₂O (5×50 mL), and washed with ethanol (2×50 mL). The solid product was then redispersed into DI-H₂O, and the above mSiO₂ growth process was repeated 2 times. Finally, the solid product was dried in an oven at 80° C. and then calcined at 550° C. for 6 hours in a box furnace. The final product was then characterized and exhibited a double-layered platelet structure with a narrow empty core.

Synthesis of Imp-ZrO₂/mSiO₂

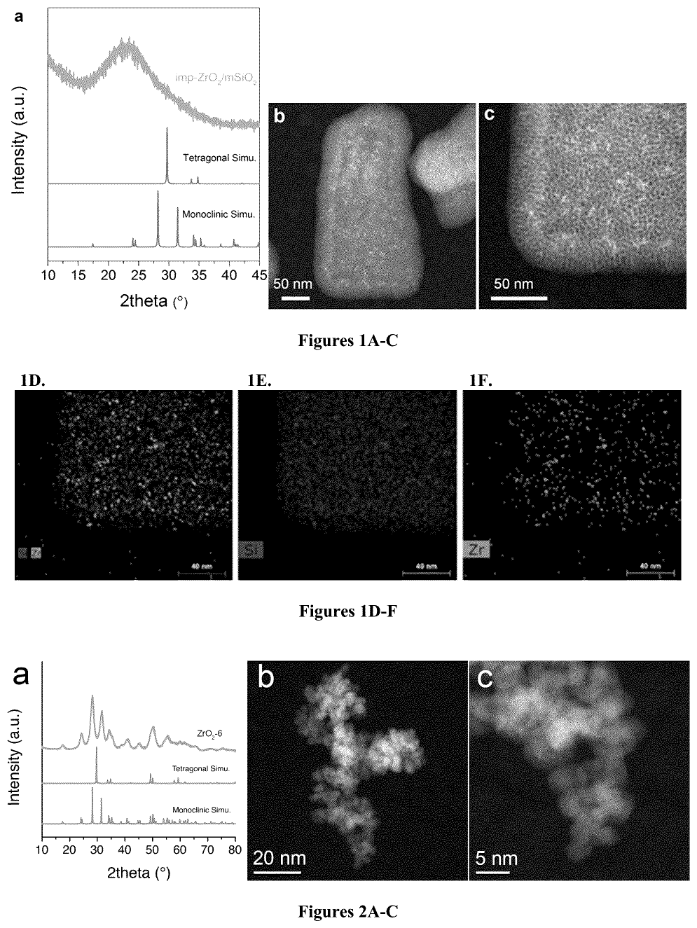

ZrO₂ nanoparticles were deposited throughout the pores and on the external surface of mSiO₂ platelets by the incipient wetness impregnation method. ZrCl₄ (0.044 g) as a methanol solution (0.5 mL) was added in a dropwise manner to the previously prepared mSiO₂ platelets (150 mg) while being mixed by a glass rod. The sample was dried in a laboratory oven at 80° C. and then calcined in a box furnace at 550° C. for 6 hours. The final product was characterized by STEM (FIGS. 1A-F), which showed a well-dispersed ZrO₂ throughout imp-ZrO₂/mSiO₂ particles.

Preparation of ZrO₂-6/mSiO₂

ZrO(NO₃)₂·xH₂O (6.374 g) was dissolved in DI-H₂O (15 mL) to form solution A. Urea (10.811 g, 0.18 mol) was dissolved in DI-H₂O (15 mL) to form solution B. Solution A and B were mixed to obtain a solution with the Zr concentration of 0.6 M. The mixture was transferred into a Teflon-lined stainless-steel autoclave and heated at 180° C. for 21 hours to give a white crystalline precipitate. The white precipitate was collected, washed with DI-H₂O (2×50 mL), and then washed with methanol (2×50 mL). The washed sample was redispersed into methanol (38 mL) to obtain suspension C containing ˜2.2 g of ZrO₂ nanoparticles. To prepare the ZrO₂-6/mSiO₂ with a ZrO₂ loading of ˜5 wt. %, mSiO₂ platelets (50 mg) were mixed with suspension C (35 mg) diluted by methanol (0.25 mL). The mixture was dried in an oven at 60° C. and then calcined at 550° C. for 6 hours. The final ZrO₂-6/mSiO₂ product was characterized by STEM (FIGS. 2A-C), which showed that the ZrO₂ nanoparticles are distributed solely on the external surfaces of layered mSiO₂ or are separate aggregates not on the mSiO₂ support.

### Synthesis of L-Pt@mSiO₂

The preparation of L-Pt@mSiO₂ followed a modified procedure from the synthesis of L-ZrO₂@mSiO₂. In the first step, urea (0.150 g) was dissolved in DI-H₂O (100 mL), GO (10 mg) was added, and the mixture was treated in an ultrasonication bath for 30 min. Subsequently, an aqueous solution of H₂PtCl₆·6H₂O (0.033 g in 1.25 mL) was added dropwise to the GO suspension, and the mixture was stirred for 3 hours at room temperature. The mixture was stirred and heated at 90° C. for 12 hours. The solid PtO₂₋ₓ(OH)₂ₓ/GO product was collected by centrifugation, washed with DI-H₂O (3×50 mL), and then dispersed into water (10 mL). In the second step, mesoporous silica (mSiO₂) was grown onto PtO₂₋ₓ(OH)₂ₓ/GO following a modified procedure of the one described for the synthesis of L-ZrO₂@mSiO₂, in which PtO₂₋ₓ(OH)₂ₓ/GO (rather than ZrO₂₋ₓ(OH)₂ₓ/GO) was used as the starting materials for the synthesis. Finally, the L-Pt@mSiO₂ product was obtained after calcination at 550° C. for 6 hours and characterized by STEM with the particle size of 3.5±0.8 nm (FIG. 12C). Like the ZrO₂ nanoparticles of L-ZrO₂@mSiO₂, Pt nanoparticles were localized in the middle of mSiO₂ shells (FIGS. 3A-B).

### Characterization of Catalytic Materials

### Powder X-Ray Diffraction (PXRD)

The PXRD patterns of ZrO₂-based samples were collected on a Bruker D8 Advance Twin diffractometer (Ni-filtered Cu Kα radiation with a wavelength of 1.5406 Å, operated at 40 kV and. 40 mA, VANTEC-position-sensitive detector) at a scan speed of 2.0 degrees per min and a step size of 0.02 degrees in 2θ.

### Nitrogen Gas (N₂) Physisorption

The sorption experiments on ZrO₂-based and Pt-containing samples were conducted using a Micromeritics 3Flex surface characterization analyzer at 77 K. The Brunauer-Emmett-Teller (BET) surface area was calculated according to the BET equation, using nitrogen sorption isotherms in the relative pressure range from 0.01 to 0.2. The mesopore size distributions were obtained using Barrett-Joyner-Halenda (BJH) method assuming a cylindrical pore model, and the desorption branches of isotherms were used for the calculation.

### Inductively Coupled Plasma Mass Spectrometry (ICP-MS)

The elemental analysis of the ZrO₂ and Pt-based catalysts was carried out on a Thermo Scientific X Series II mass spectrometer. The samples (˜1.5 mg) are first treated with hydrofluoric acid (80 μL) to etch away silica or dissolve the ZrO₂ particles, and then digested with aqua regia (4 mL). The final solutions were diluted with 2.0 v/v % nitric acid to target concentrations for the ICP-MS measurement. The control samples and blanks were treated following the same procedure described above.

### Scanning Transmission Electron Microscopy

High-angle annular dark-field scanning transmission electron microscopy (HAADF-STEM) images and energy dispersive X-ray spectroscopy (EDX) maps of L-ZrO₂@mSiO₂ were acquired on a FEI Titan Themis 300 probe-corrected scanning transmission electron microscope under 200 kV accelerating voltage. Prior to the imaging, about 1 mg of the ZrO₂-based samples was embedded in 1 mL of Epon epoxy resin and sectioned at 50 nm thickness on a Leica UC6 ultramicrotome with a DiATOME diamond knife.

### Example 6—Results and Discussion of Examples 1-5

### Synthesis and Catalyst Structure

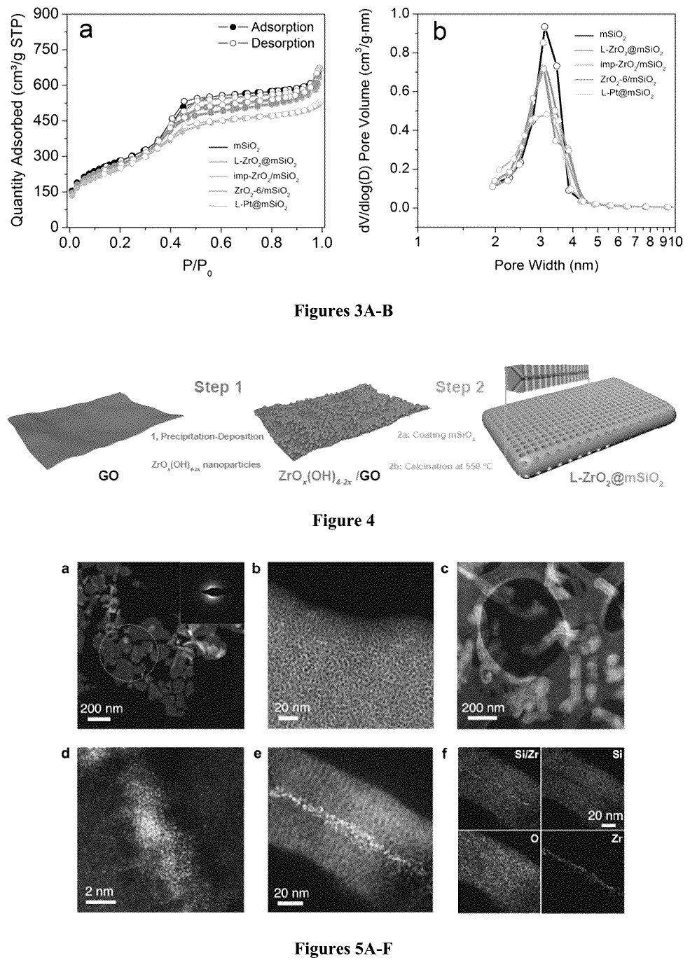

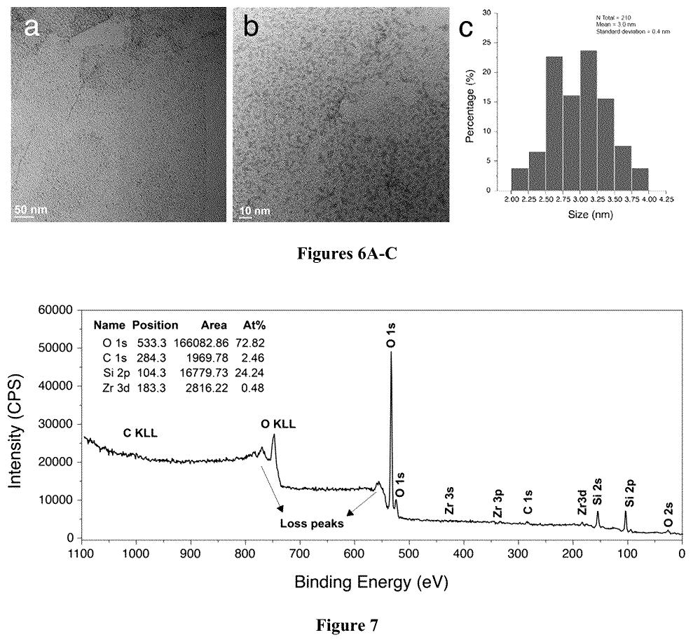

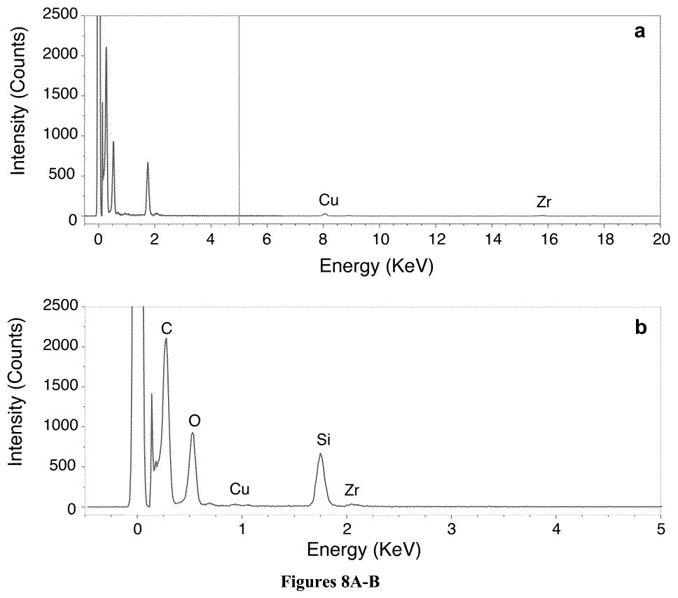

L-ZrO₂@mSiO₂ was designed for zirconium-catalyzed polyolefin deconstruction (FIGS. 4 and 5A-F). Ultrasmall ZrOₓ(OH)₄₋₂ₓ nanoparticles were dispersed on graphene oxide (GO) sheets (FIGS. 6A-C), mSiO₂ layers were grown on the ZrOₓ(OH)₄₋₂ₓ/GO, and the resulting material was washed and calcined to remove structure-directing agents. Inductively coupled plasma mass spectrometry (ICP-MS) analysis of L-ZrO₂@mSiO₂ revealed a ZrO₂ loading of 4.7 wt. % (Table 1). ICP-MS analyses of three batches of as-synthesized L-ZrO₂@mSiO₂ catalysts (Table 2) ruled out the presence of any other transition metals in the catalyst, including Ru, Rh, Pt, Pd, Au, Rc, Os, Ir, Ni, Fc, Co, Cu, Zn, Mo, W, Cd, Ce, Hf, Ti, and V. The elemental purity of L-ZrO₂@mSiO₂ was further supported by X-ray photoelectron spectroscopy (XPS) (FIG. 7) and energy dispersive X-ray spectroscopy (EDX; FIG. 8A-B).

TABLE 1
Source and Characteristics of Catalysts

| | | | Catalyst | | |
|---|---|---|---|---|---|
| | | | Loading | SSA_{BET} | Dₚₒᵣₑ |
| Entry | Catalyst | Source | [wt. %] | [m²/g] | [nm]^{d} |
| 1 | mSiO₂ | Syn.^{a} | 0.0 | 1022 | 3.6 |
| 2 | L-ZrO₂@mSiO₂ | Syn.^{a} | 4.7 | 973 | 3.7 |
| 3 | imp-ZrO₂/mSiO₂ | Syn.^{a} | 4.1 | 959 | 3.6 |
| 4 | ZrO₂-6/mSiO₂ | Syn.^{a} | 6.0 | 966 | 3.8 |
| 5 | ZrO₂-30 | Aldrich^{b} | 100 | 37 | n.a.^{e} |
| 6 | L-Pt@mSiO₂ | Syn.^{a} | 3.6 | 909 | 3.4 |
| 7 | Pt/C | Alfa Aesar^{c} | 7.1 | n.a. | n.a. |

^{a}Synthesized in this work.
^{b}Purchased from Aldrich.
^{c}Purchased from Alfa Aesar.
^{d}Pore size calculated from the desorption branch of nitrogen gas sorption isotherm using BJH method.
^{e}Not applicable.

TABLE 2
Weight Percentage of Metal in Zro₂-Based Catalytic
Materials, Potentially Present as Trace Impurities^{a}

| | | | | Spent | | |
|---|---|---|---|---|---|---|
| | L-ZrO₂ | L-ZrO₂ | L-ZrO₂ | L-ZrO₂ | ZrO₂-6/ | imp-ZrO₂/ |
| Metal | @mSiO₂_1 | @mSiO₂_2 | @mSiO₂_3 | @mSiO₂_3 | mSiO₂ | mSiO₂ |
| Ru | 0.000% | 0.000% | 0.000% | 0.000% | 0.000% | 0.000% |
| Rh | 0.000% | 0.000% | 0.000% | 0.000% | 0.000% | 0.000% |
| Pd | 0.000% | 0.000% | 0.000% | 0.000% | 0.000% | 0.000% |
| Pt | 0.000% | 0.000% | 0.000% | 0.000% | 0.000% | 0.000% |
| Au | 0.000% | 0.000% | 0.001% | 0.000% | 0.000% | 0.000% |
| Re | 0.000% | 0.000% | 0.000% | 0.000% | 0.000% | 0.000% |
| Ir | 0.000% | 0.000% | 0.000% | 0.000% | 0.000% | 0.000% |
| Os | 0.000% | 0.000% | 0.004% | 0.000% | 0.000% | 0.000% |
| Fe | <0.000% | <0.000% | <0.000% | 0.001% | <0.000% | <0.000% |
| Co | 0.000% | 0.000% | 0.000% | 0.001% | 0.000% | 0.000% |
| Ni | 0.000% | 0.000% | 0.000% | <0.000% | 0.000% | 0.000% |
| Cu | 0.000% | 0.000% | 0.000% | 0.004% | 0.003% | 0.000% |
| Zn | 0.002% | 0.003% | <0.000% | <0.000% | <0.000% | <0.000% |
| Mo | 0.000% | 0.000% | <0.000% | 0.010% | <0.000% | <0.000% |
| W | 0.000% | 0.000% | 0.000% | 0.000% | 0.000% | 0.000% |
| Cd | 0.000% | 0.000% | 0.000% | 0.000% | 0.000% | 0.000% |
| Ce | 0.001% | 0.000% | <0.000% | <0.000% | <0.000% | <0.000% |
| Hf | 0.000% | 0.000% | <0.000% | <0.000% | <0.000% | <0.000% |
| Ti | 0.000% | 0.011% | <0.000% | <0.000% | <0.000% | <0.000% |
| V | 0.000% | 0.000% | <0.000% | <0.000% | <0.000% | <0.000% |

^{a}Weight percentage was calculated based on the inductively coupled plasma mass spectrometry (ICP-MS) Analyses^{b}
^{b}L-ZrO₂@mSiO₂ was measured from three separately digested samples and labeled as L-ZrO₂@mSiO₂_1, L-ZrO₂ @mSiO₂_2, and L-ZrO₂ @mSiO₂_3.

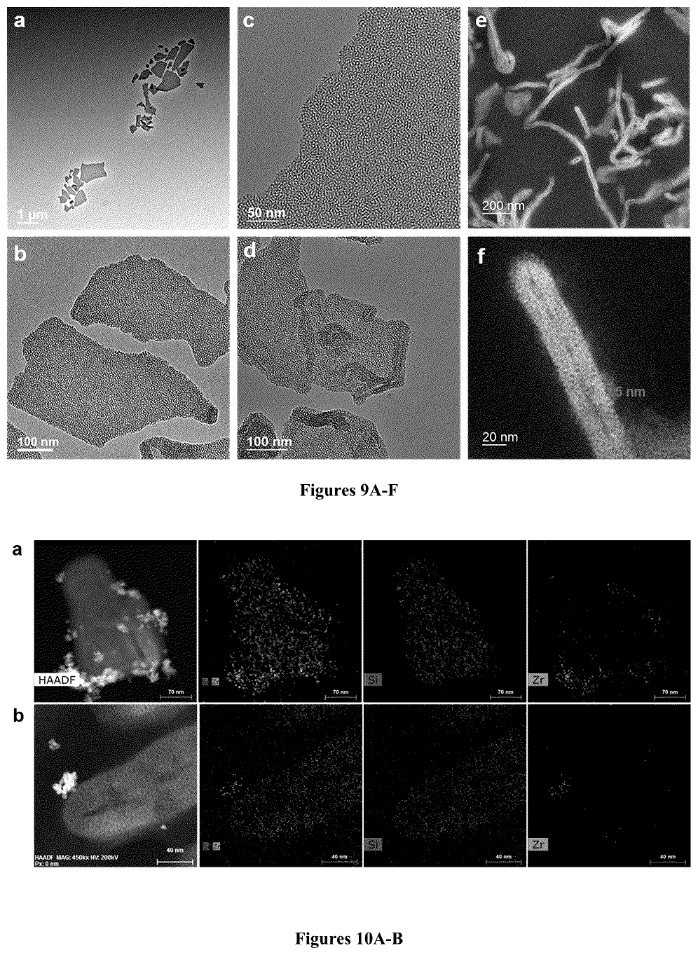

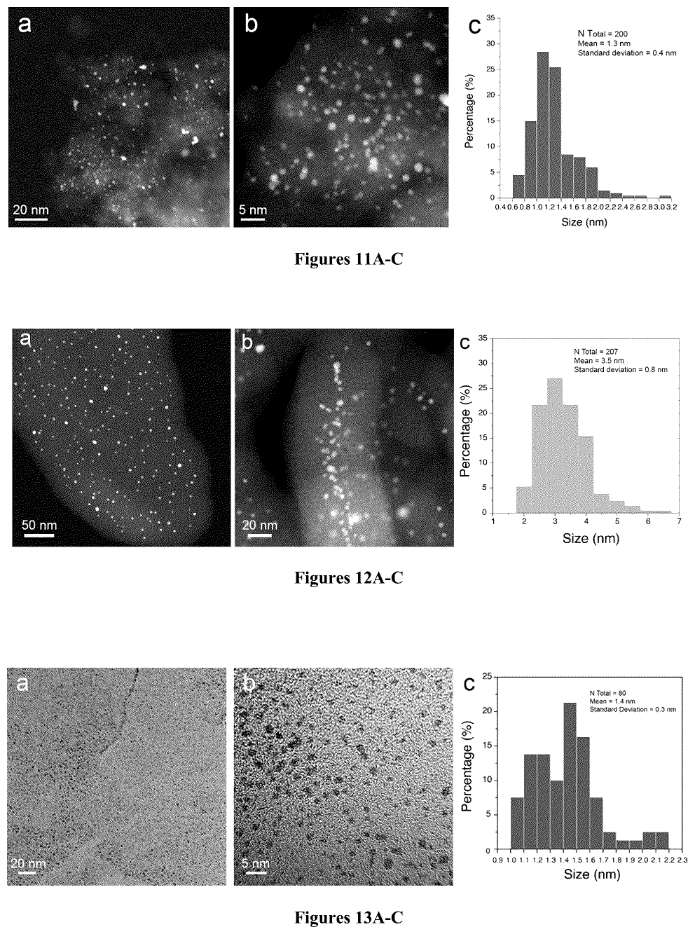

The performance of L-ZrO₂@SiO₂ is best understood through comparisons to the behavior of several reference catalysts (Table 1). mSiO₂ was synthesized by templated silica growth on GO (Yang et al., “Graphene-Based Nanosheets with a Sandwich Structure,” Angew. Chem. Int. Ed. 49:4795-4799 (2010); Wang et al., “Graphene Oxide-Periodic Mesoporous Silica Sandwich Nanocomposites with Vertically Oriented Channels,” ACS Nano 4:7437-7450 (2010), which are hereby incorporated by reference in their entirety) and has the same layered platelet morphology and porous structure (FIGS. 9A-F) as L-ZrO₂@mSiO₂, imp-ZrO₂/mSiO₂, produced by incipient wetness impregnation of zirconium precursors into mSiO₂, contains randomly dispersed amorphous ZrO₂ nanoparticles (FIGS. 1A-F). ZrO₂-6/mSiO₂ was prepared by immobilizing pre-synthesized 6 nm monoclinic ZrO₂ nanoparticles (FIGS. 2A-C) on the external surface of mSiO₂ (FIGS. 10A-B). ZrO₂-30 and Pt/C are commercial monoclinic ˜30 nm-sized zirconia and 1.3±0.4 nm-sized platinum nanoparticles supported on carbon (FIGS. 11A-C), respectively. L-Pt@mSiO₂ (FIGS. 12A-C), synthesized by deposition of PtOₓ(OH)₄₋₂ₓ nanoparticles on GO (FIGS. 13A-C) followed by growth of the mSiO₂ shell, creates a comparable architecture to L-ZrO₂@mSiO₂ with 3.5±0.8 nm platinum nanoparticles instead of zirconia. The total surface area and BJH pore size for mSiO₂-based samples are ˜900-1000 m²/g and 3.4-3.8 nm, respectively (Table 1).

The low magnification scanning transmission electron microscopy (STEM) image (FIG. 5A) of L-ZrO₂@mSiO₂ showed its separated nanoplatelet particle morphology, with lateral dimensions ranging from hundreds of nanometers to a few microns. Pore diameters of 3.4±0.4 nm in the mesoporous silica nanoplatelets, revealed by the higher magnification image (FIG. 5B), matched the values obtained with N₂ sorption isotherm measurements (Table 1, FIGS. 3A-C). Notably, the STEM images of cross-sectioned L-ZrO₂@mSiO₂ particles prepared by ultramicrotome (FIGS. 5C-E) clearly showed a thin (˜3 nm) bright band, identified by elemental mapping as a region of concentrated zirconium (FIG. 5F), between the two 35 nm-thick sheets of mSiO₂. The mesopores in mSiO₂ are aligned perpendicular to the nanoplate (FIG. 5E) (Wang et al., “Graphene Oxide-Periodic Mesoporous Silica Sandwich Nanocomposites with Vertically Oriented Channels,” ACS Nano 4:7437-7450 (2010); Wang et al., “Sandwich-Type Nanocomposite of Reduced Graphene Oxide and Periodic Mesoporous Silica with Vertically Aligned Mesochannels of Tunable Pore Depth and Size,” Adv. Func. Mater. 27:1704066 (2017), which are hereby incorporated by reference in their entirety), and the diameter of the ZrO₂ particles is 3.0±0.5 nm (FIGS. 14A-B).

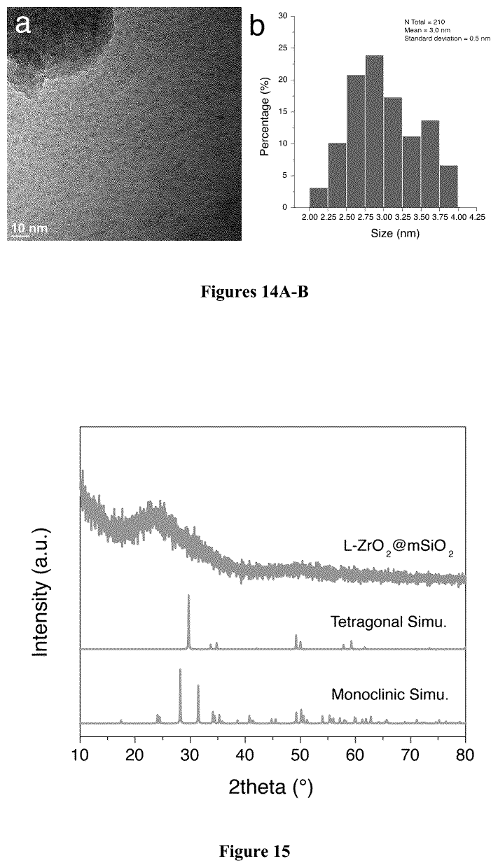

The amorphous nature and chemical structure of the ultrasmall ZrO₂ nanoparticles in L-ZrO₂@mSiO₂ were established by electron diffraction and powder X-ray diffraction (pXRD). A diffuse ring in the selected-area-electron diffraction (SAED) pattern (inset in FIG. 5A) indicated amorphous characteristics of the material, in contrast to sharp diffraction spots or rings typical of crystalline substances. The high-resolution image (FIG. 5D) further revealed that both ZrO₂ and mSiO₂ lack long-range order. Diffraction peaks from ZrO₂ were not detected in the pXRD pattern of L-ZrO₂@mSiO₂ (FIG. 15).

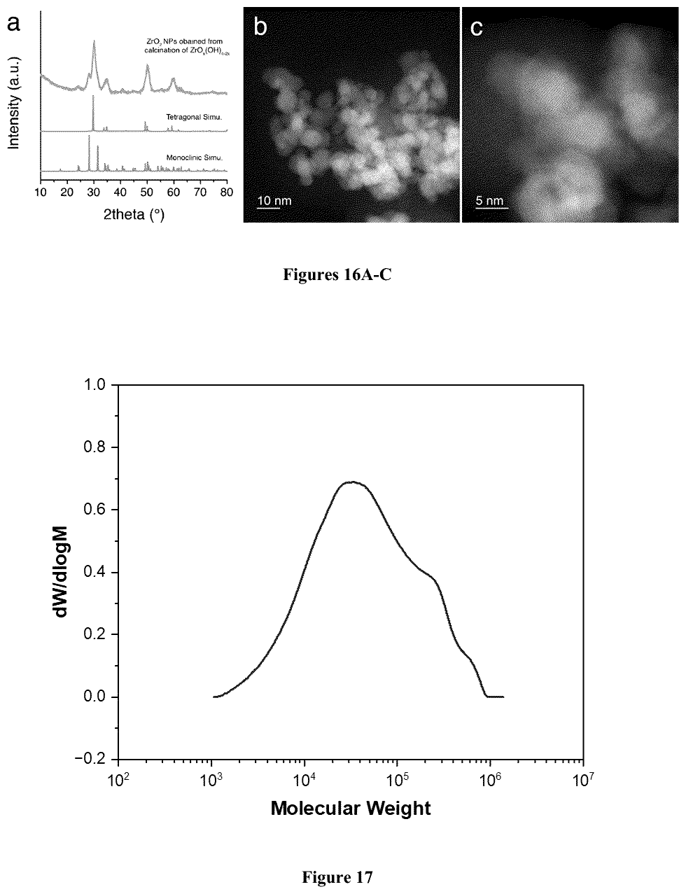

The thermochemical stability of ZrO₂ is affected by the mSiO₂ shell. Calcination of ZrOₓ(OH)₄₋₂ₓ/GO at 550° C. formed a mixture of tetragonal and monoclinic ZrO₂ nanocrystals (Scherrer size 5.5 and 9.3 nm, respectively; FIGS. 16A-C). Similar calcination of L-ZrO₂@mSiO₂ did not provide detectable signals of crystalline domains (FIG. 15). Likely, the confinement of ultrasmall ZrO₂ nanoparticles within the mesopores, along with the covalent Si—O—Zr bonding, limits their growth and crystallization.

### Polymer Deconstruction Catalysis

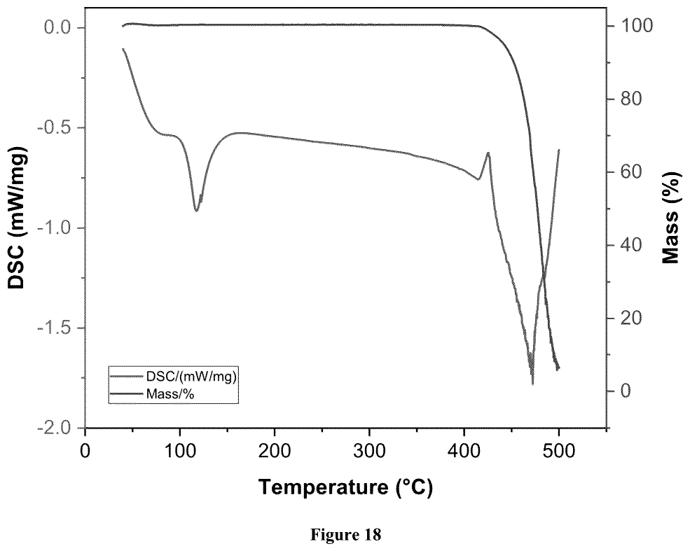

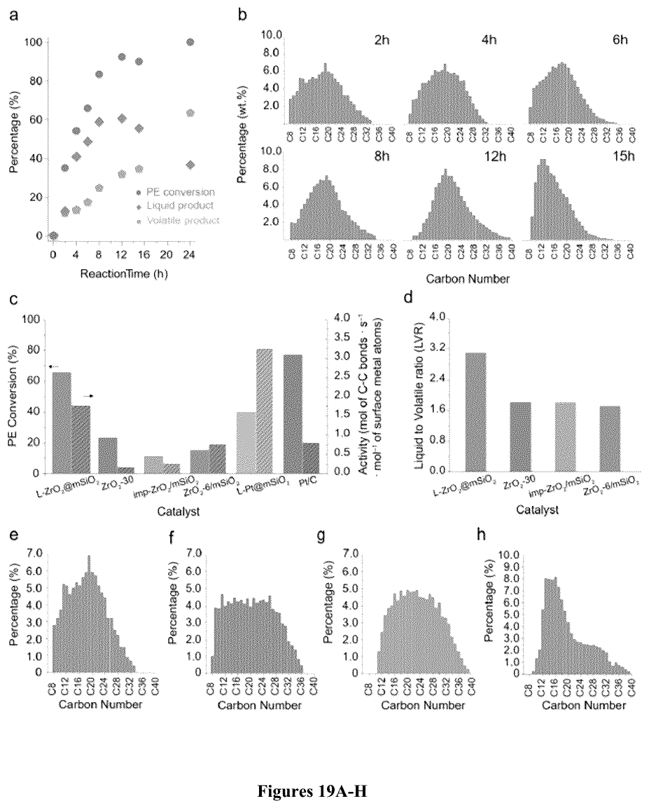

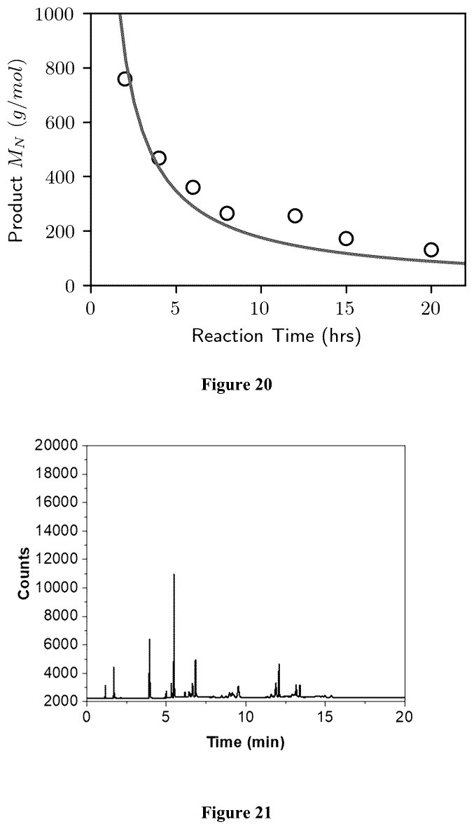

Polyethylene (PE) hydrogenolysis was performed with ˜3 g of melted PE (Mₙ=20 kDa, M_{w}=91 kDa, FIGS. 17 and 18) and 5.5 mg of catalyst under 0.992 MPa of H₂ at 300° C. as the standard conditions. The high mass specific catalytic activity of L-ZrO₂@mSiO₂ was established by the rate of C—C bonds cleaved per metal mass (2.3±0.4 mol H₂·Zr g⁻¹·h⁻¹). The number of C—C bonds that were broken in each experiment was determined by measuring the consumption of H₂ (each H₂ molecule consumed corresponds to one hydrogenolyzed C—C bond). The products include C₁-C₉ species, the C₈-C₅₀ liquid and wax fraction, and the >C₅₀ polymeric solid residue (FIGS. 19A-B, Tables 3 and 4). The Mₙ vs time curve follows the generally expected decay (FIG. 20).

TABLE 3
Product Compositions Plotted in FIG. 19A from
the Hydrogenolysis of PE over 2-20 hours, Catalyzed by
L-ZrO₂@mSiO₂ under H₂ (0.992 MPa) at 300° C.

| | | | | Solid | H₂ Con- |
|---|---|---|---|---|---|
| Time | PE | Volatiles | Liquids | residue | sumption |
| (h) | (g) | g (%) | g (%) | g (%) | (mmol) |
| 2 | 3.009 | 0.067 (2.2%) | 0.467 (15.5%) | 2.475 (82.3%) | 1.8 ± 0.2 |
| 4 | 3.003 | 0.089 (3.0%) | 0.835 (27.8%) | 2.078 (69.2%) | 3.1 ± 0.6 |
| 6 | 3.003 | 0.082 (2.7%) | 1.257 (42.3%) | 1.664 (55.4%) | 3.6 ± 0.6 |
| 8 | 3.016 | 0.195 (6.47%) | 1.659 (55.0%) | 1.162 (38.5%) | 5.2 ± 0.7 |
| 12 | 3.004 | 0.230 (7.7%) | 1.951 (64.9%) | 0.823 (27.4%) | 8.1 ± 1.1 |
| 15 | 3.007 | 0.295 (9.8%) | 2.400 (79.8%) | 0.312 (10.4%) | 10.3 ± 0.8 |
| 20 | 3.000 | 0.426 (14.2%) | 2.574 (85.8%) | — | 16.1 ± 1.4 |

TABLE 4
Total Cuts Calculated by Lumping all Molecular Weights
of Gas-Liquid and Solid Phases

| | | Total | H₂ Con- | Mass Activity |
|---|---|---|---|---|
| | Reaction | Cuts ^{a} | sumption ^{b} | mol H₂ · |
| Catalyst | Time (h) | (mmol) | (mmol) | g_{Metal}⁻¹ · h⁻¹ |
| L-ZrO₂@mSiO₂ | 2 | 3.82 | 1.8 ± 0.2 | 3.4 ± 0.3 |
| L-ZrO₂@mSiO₂ | 4 | 6.27 | 3.1 ± 0.6 | 3.0 ± 0.1 |
| L-ZrO₂@mSiO₂ | 6 | 8.14 | 3.6 ± 0.6 | 2.3 ± 0.1 |
| L-ZrO₂@mSiO₂ | 8 | 11.2 | 5.2 ± 0.7 | 2.6 ± 0.3 |
| L-ZrO₂@mSiO₂ | 12 | 11.4 | 8.1 ± 1.1 | 2.6 ± 0.3 |
| L-ZrO₂@mSiO₂ | 15 | 17.4 | 10.3 ± 0.8 | 2.7 ± 0.3 |
| L-ZrO₂@mSiO₂ | 20 | 21.2 | 16.1 ± 1.4 | 3.1 ± 0.3 |
| ZrO₂-30 | 6 | 2.96 | 2.0 ± 0.2 | 0.1 ± 0.01 |
| ZrO₂-30 | 12 | n.a. | 3.2 ± 0.5 | 0.1 ± 0.02 |
| imp-ZrO₂/mSiO₂ | 6 | 3.87 | 3.1 ± 0.4 | 2.5 ± 0.5 |
| ZrO₂-6/mSiO₂ | 6 | 2.24 | 1.9 ± 0.2 | 1.0 ± 0.1 |
| ZrO₂-6/mSiO₂ | 15 | 12.6 | 3.6 ± 0.5 | 1.0 ± 0.2 |
| Pt/C | 6 | 6.49 | 5.9 ± 1.1 | 2.2 ± 0.1 |
| L-Pt/mSiO₂ | 6 | 7.13 | 6.7 ± 0.3 | 5.6 ± 1 |

^{a} Total Cuts are calculated from the Mₙ of the entire population of hydrocarbon species, according to eq 3 in the Methods section of the main text.
^{b} H₂ consumption correlates directly with C—C bonds cleaved. This data and Total Cuts are given for comparison of the analytical methods.

A few zirconia materials showed catalytic activity in PE hydrogenolysis, with L-ZrO₂@mSiO₂ providing the highest conversion of PE and high mass-specific activity for C—C bond breakage (FIG. 19C). Catalysts were compared by normalizing per ethylene hydrogenation (Table 5). L-ZrO₂@mSiO₂ activity for C—C bond cleavage is ca. 23±2× and 2.4±0.3× higher than the activities of ZrO₂-30 and ZrO₂-6/mSiO₂, and comparable activity to imp-ZrO₂/mSiO₂ (Table 4). Remarkably, the activity of L-ZrO₂@mSiO₂ for C—C cleavage was even competitive with that of Pt-based catalysts following the trend L-ZrO₂@mSiO₂˜Pt/C<L-Pt@mSiO₂. The similar activity of Pt and confined Zr, along with the <0.001 wt % concentration of other transition metals measured by ICP-MS of as-synthesized and post-reaction zirconia catalysts, as well as catalyst-free control experiments, also ruled out trace contaminants as being catalytically important species.

TABLE 5
Ethylene Hydrogenation Conversion Catalyzed by
L-ZrO₂@mSiO₂ and Pure mSiO₂ Platelets

| Temperature | Conversion (%) | |
|---|---|---|
| (° C.) | L-ZrO₂@mSiO₂ | Pure mSiO₂ platelets |
| 200 | 12.6 | 0.1 |
| 250 | 9.9 | 0.1 |
| 300 | 3.4 | 0.1 |

Gas Flow Rates: He: 13.2 mL/min; H₂: 12.0 mL/min; C₂H₄: 1.20 mL/min at the ambient pressure and 200, 250, and 300° C.

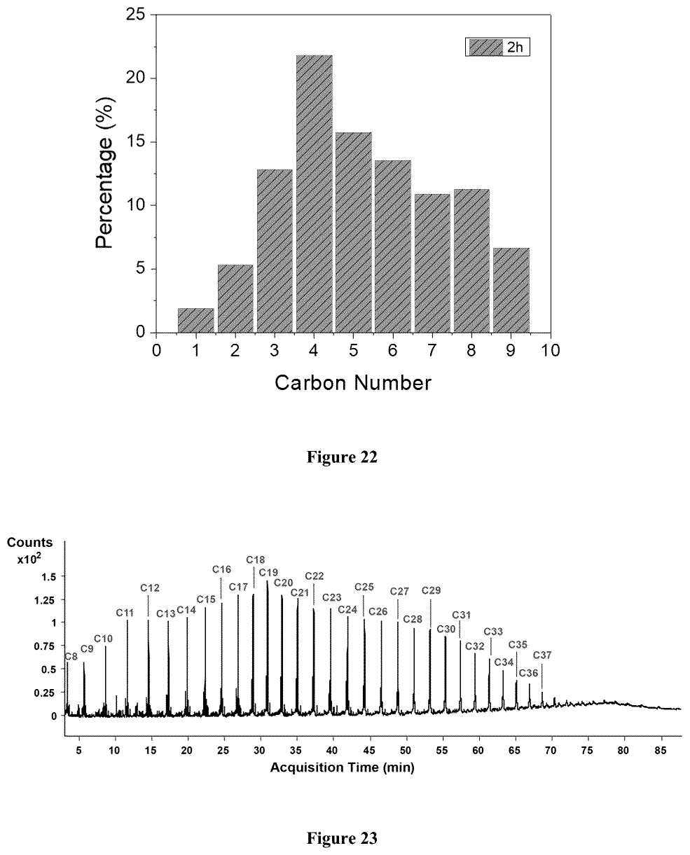

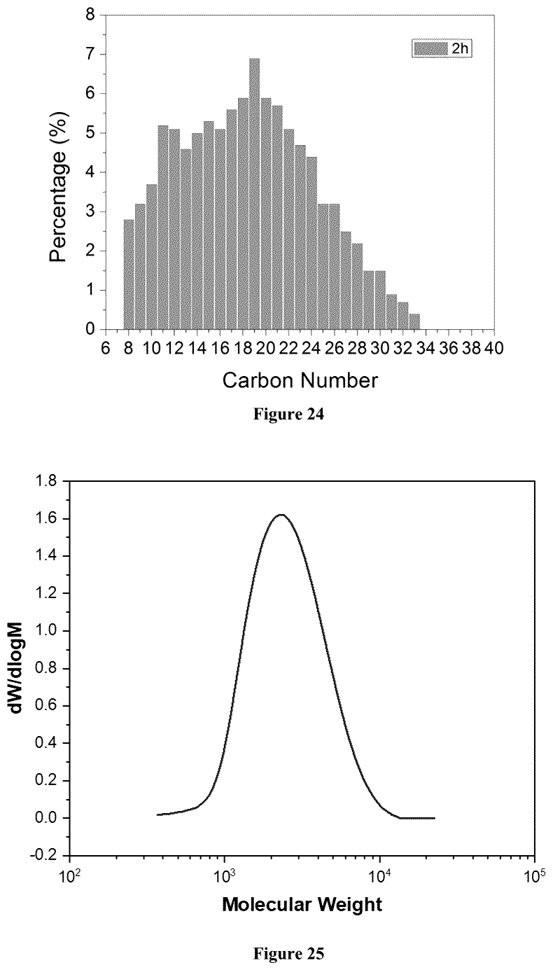

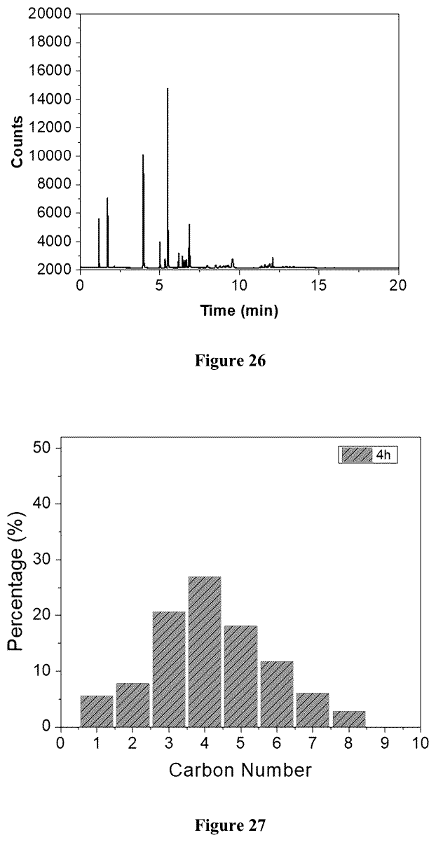

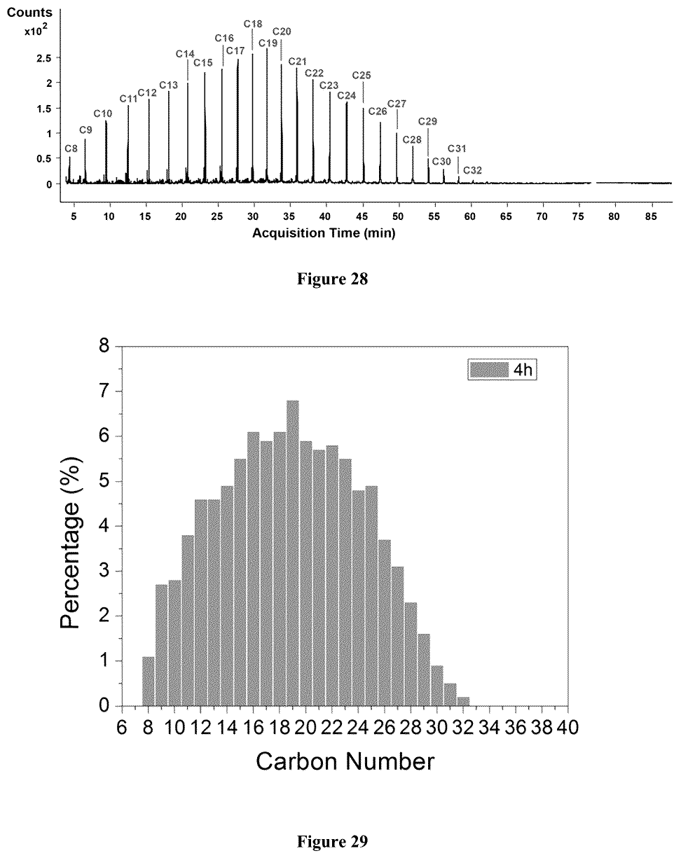

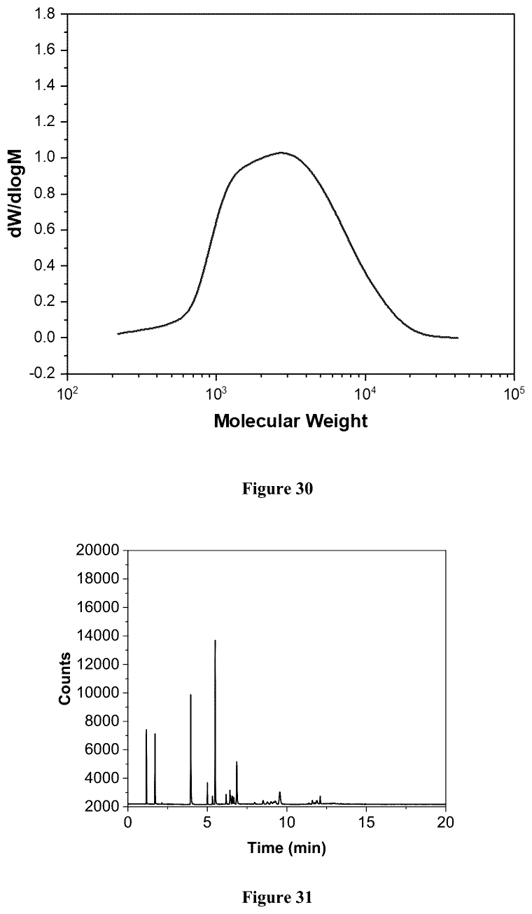

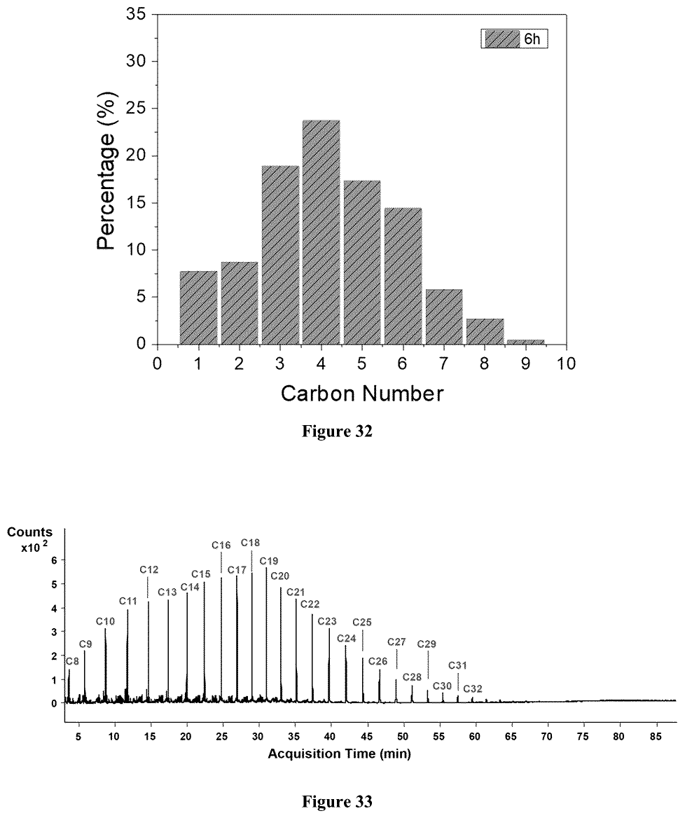

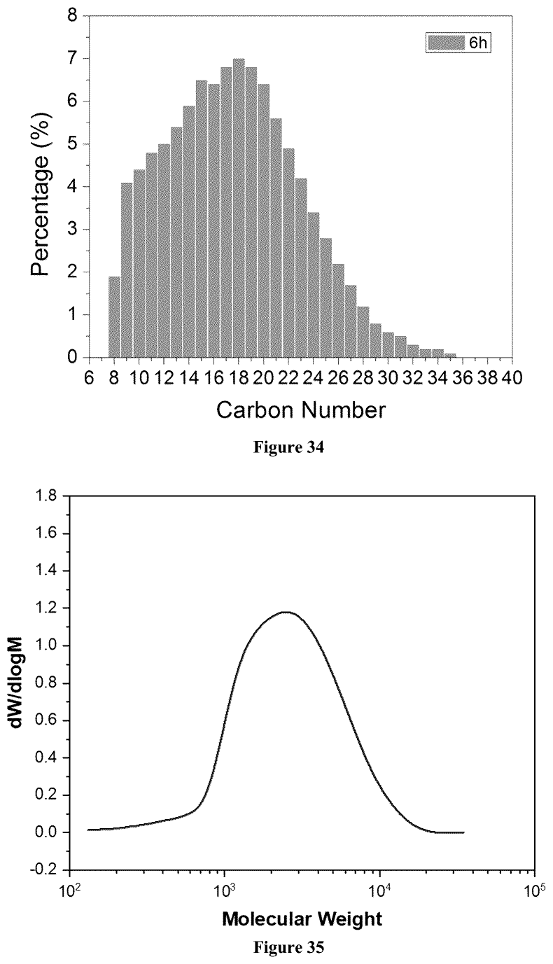

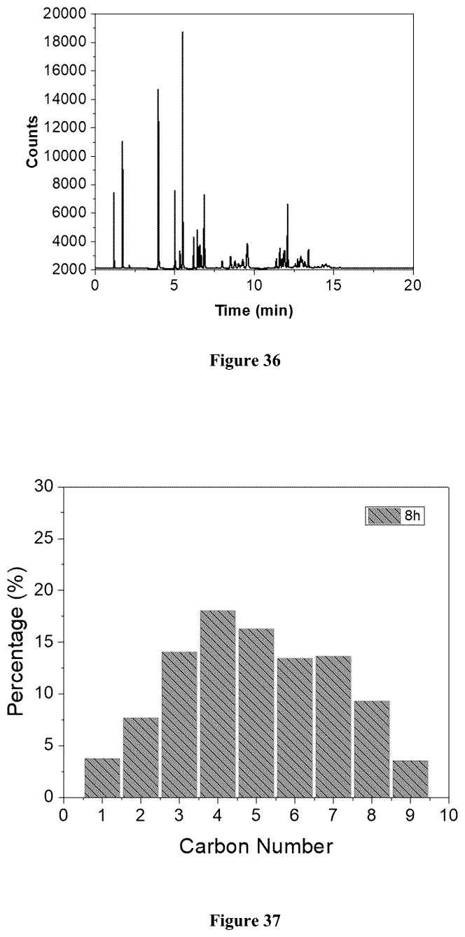

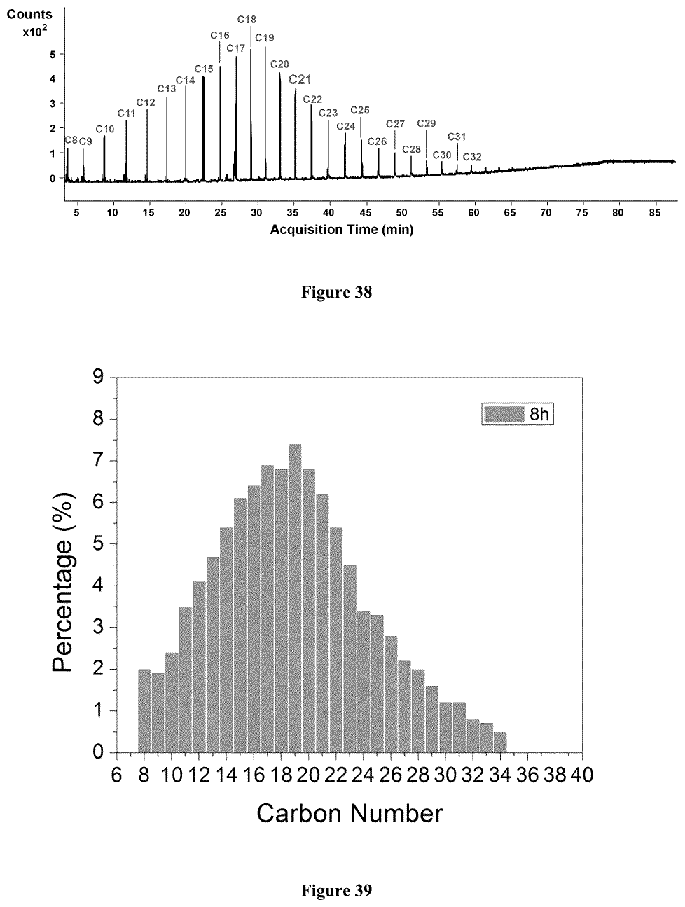

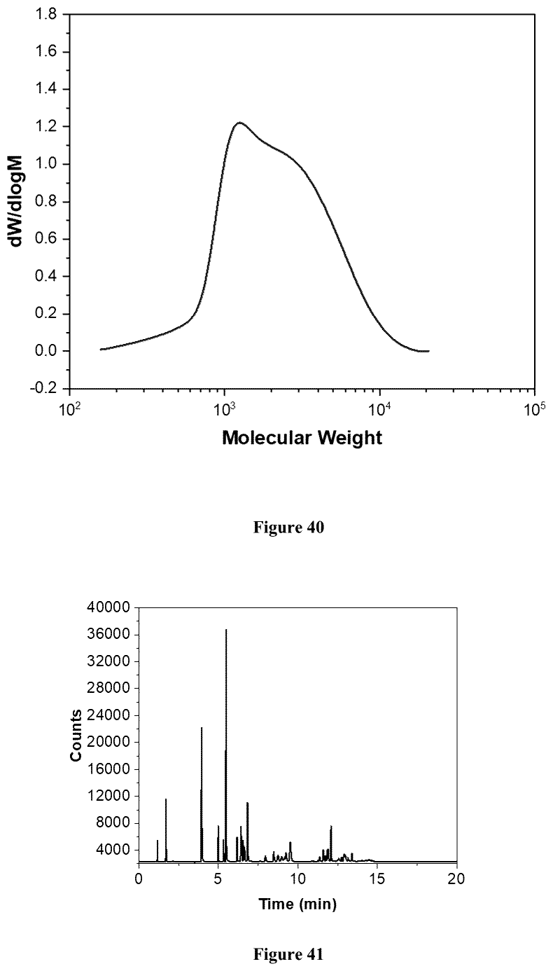

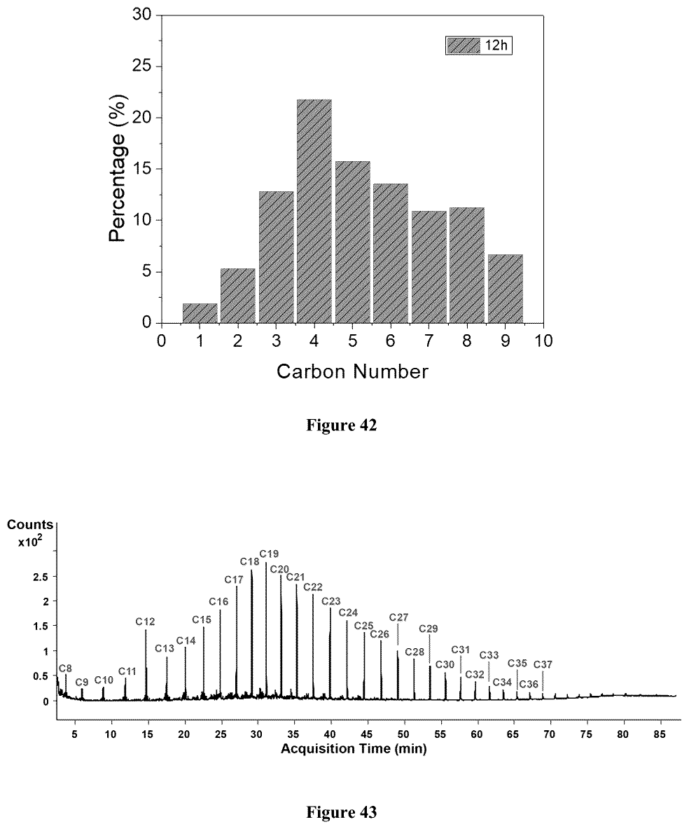

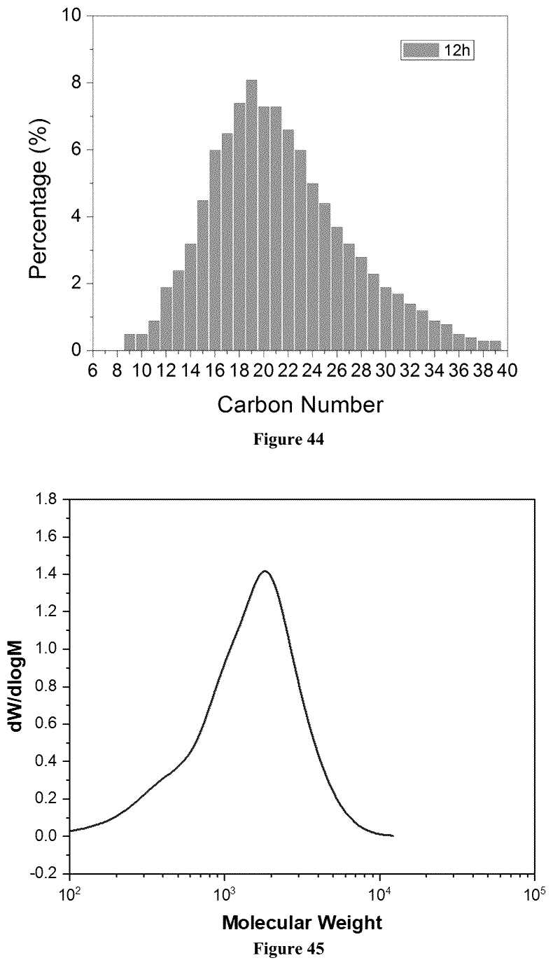

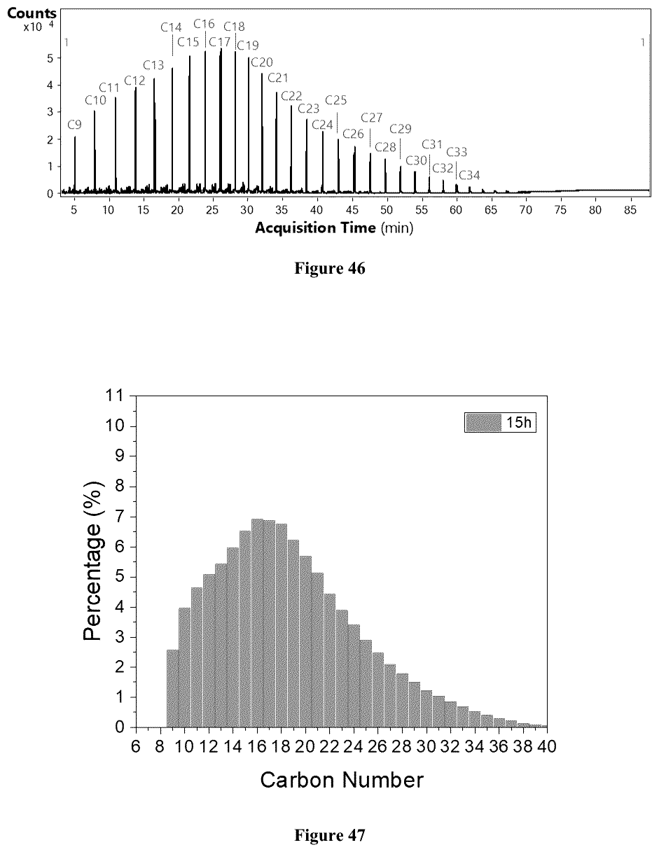

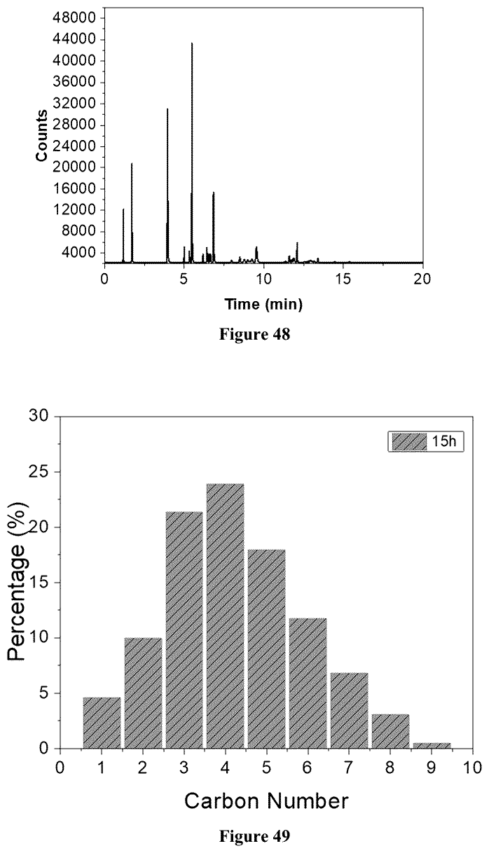

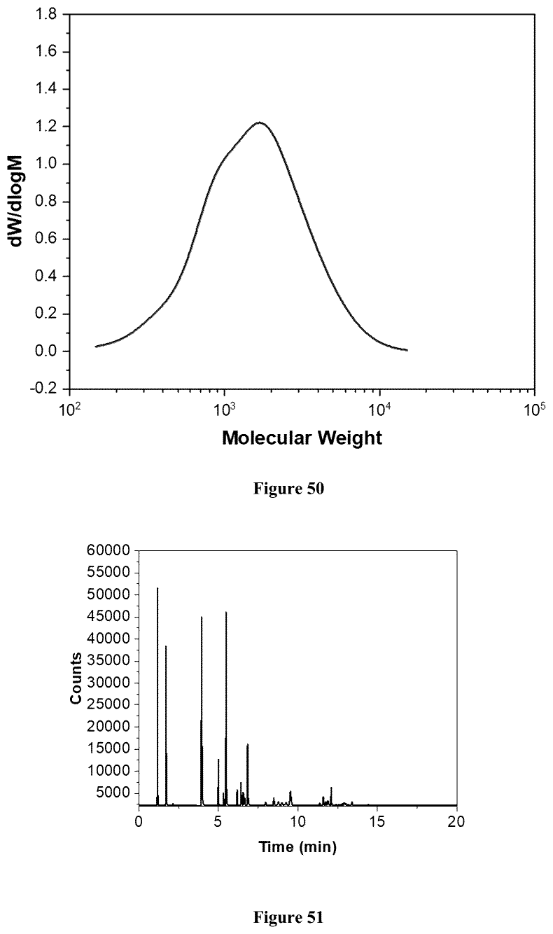

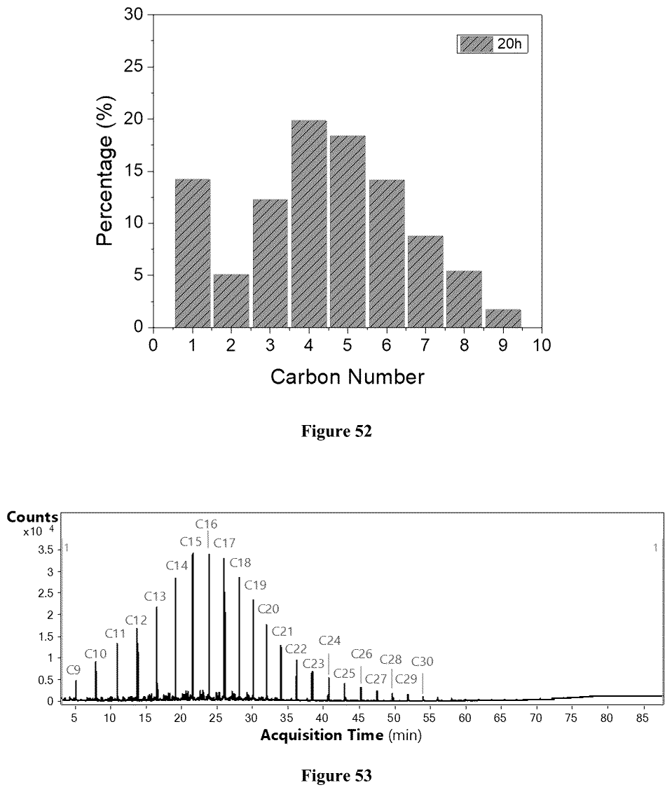

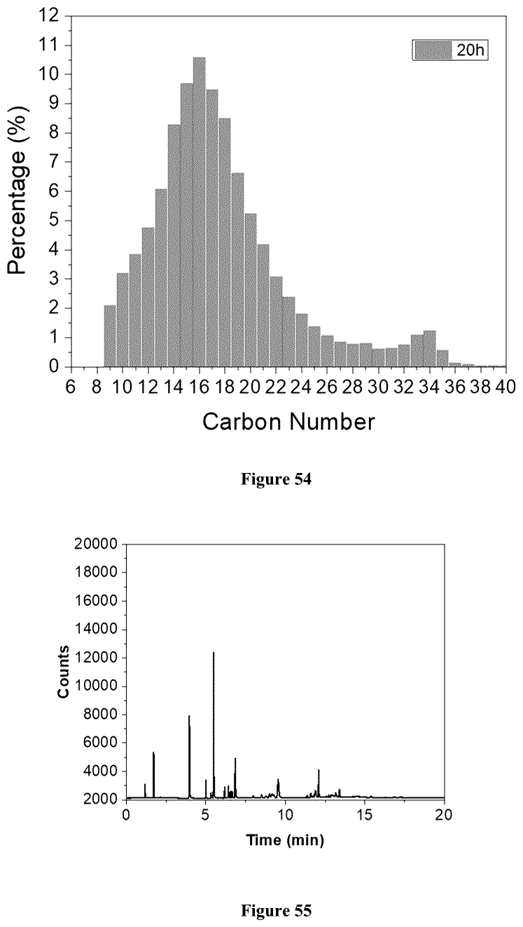

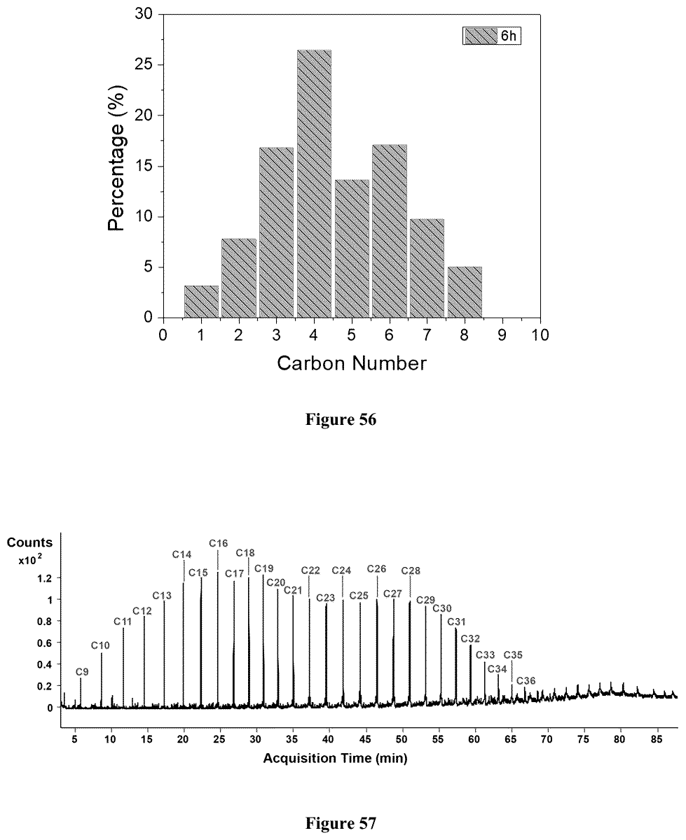

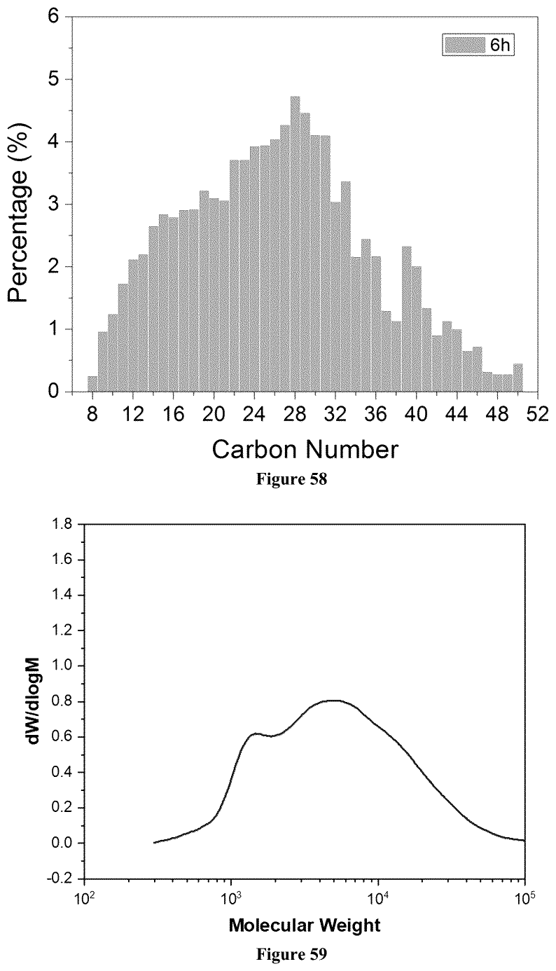

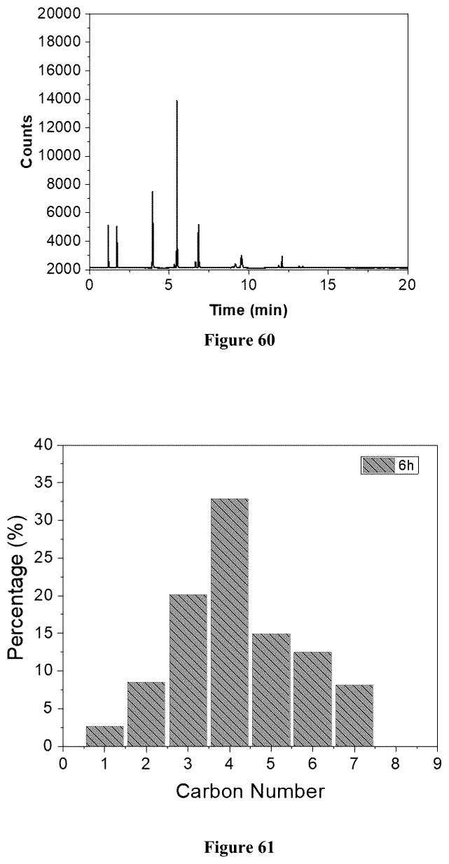

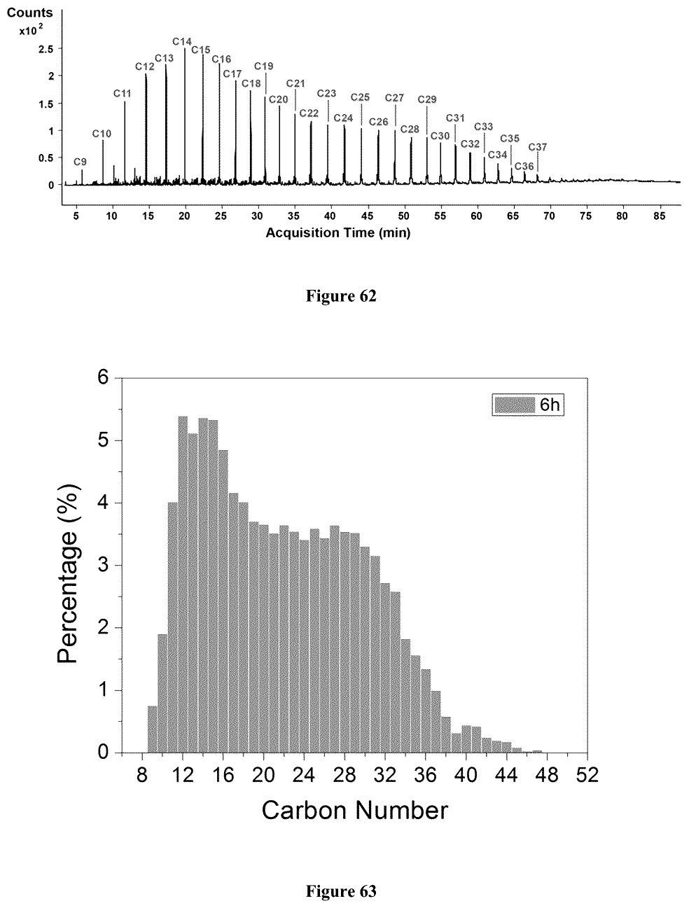

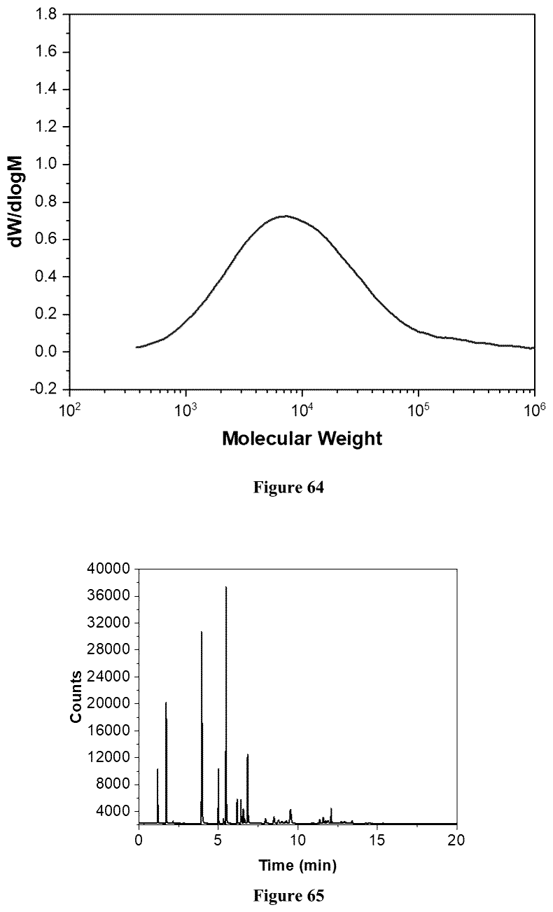

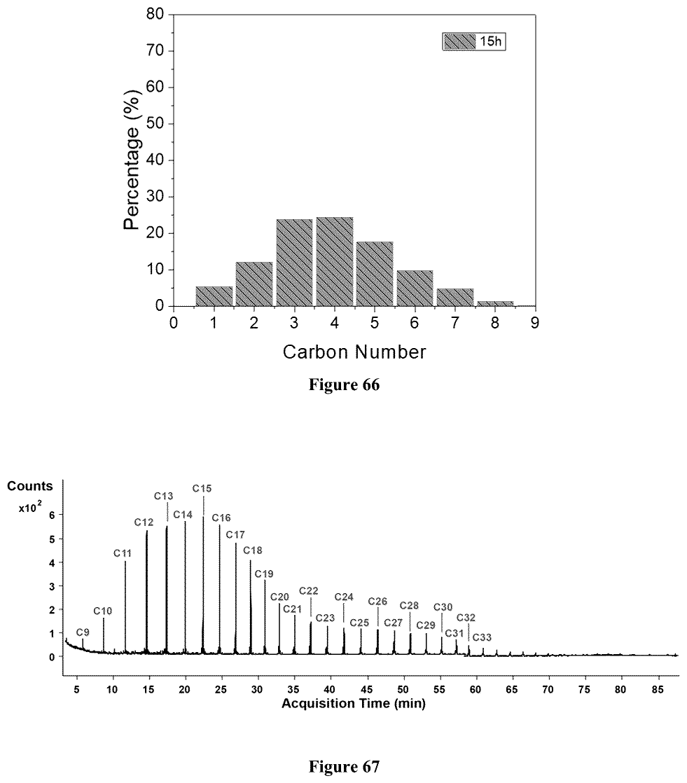

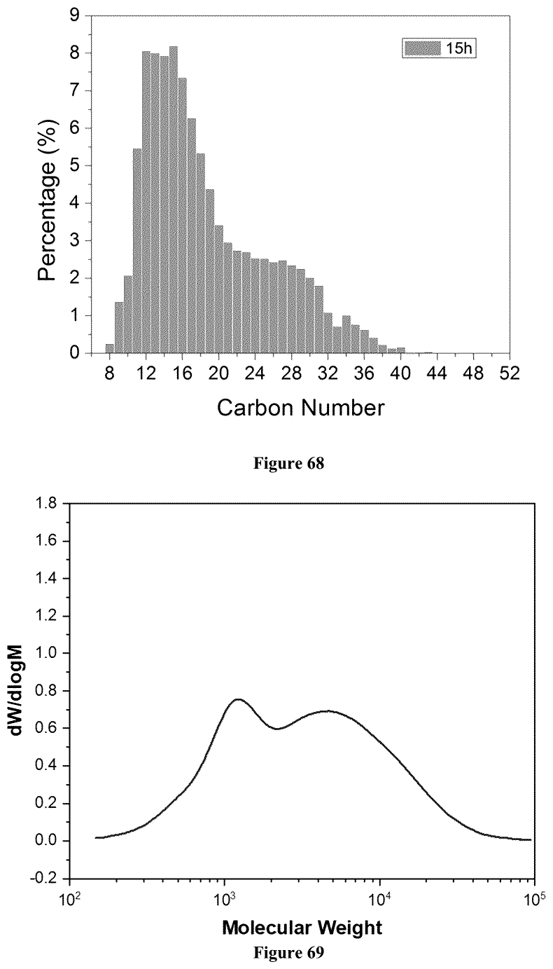

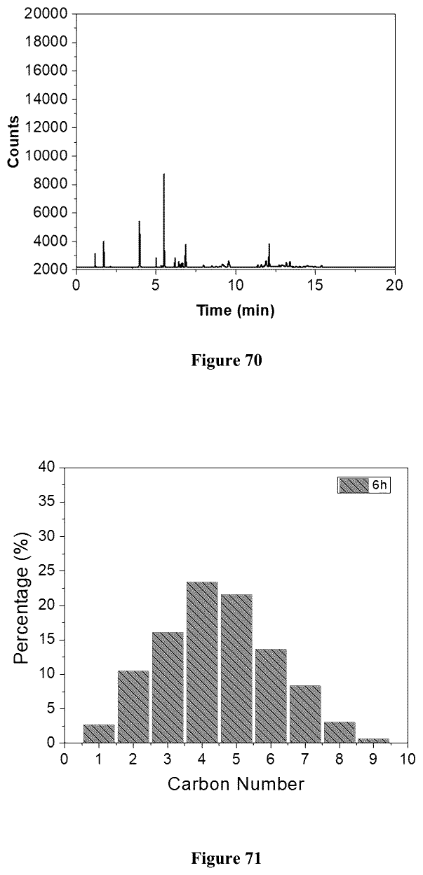

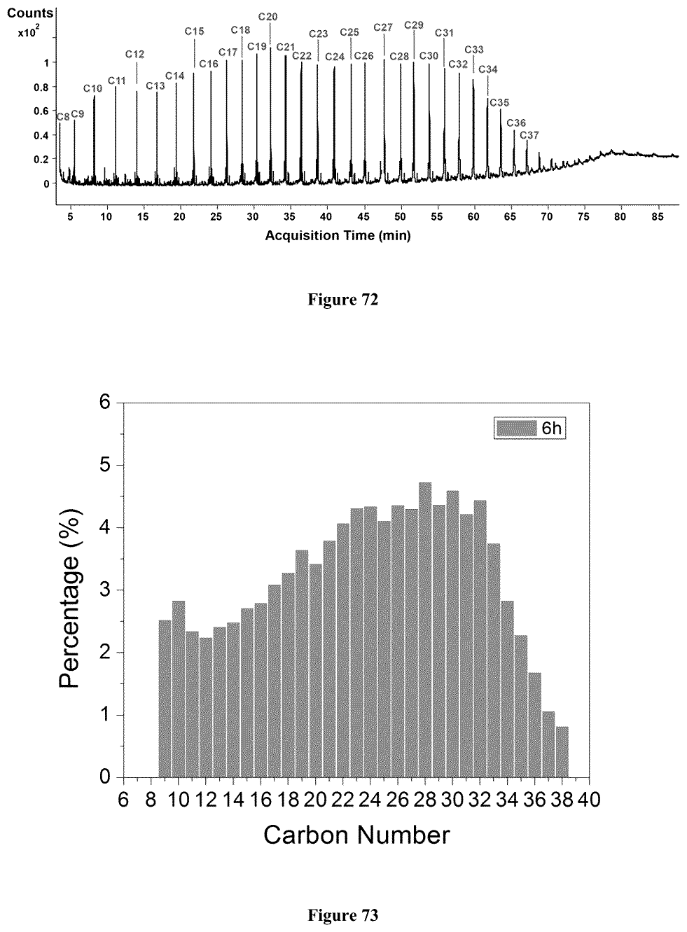

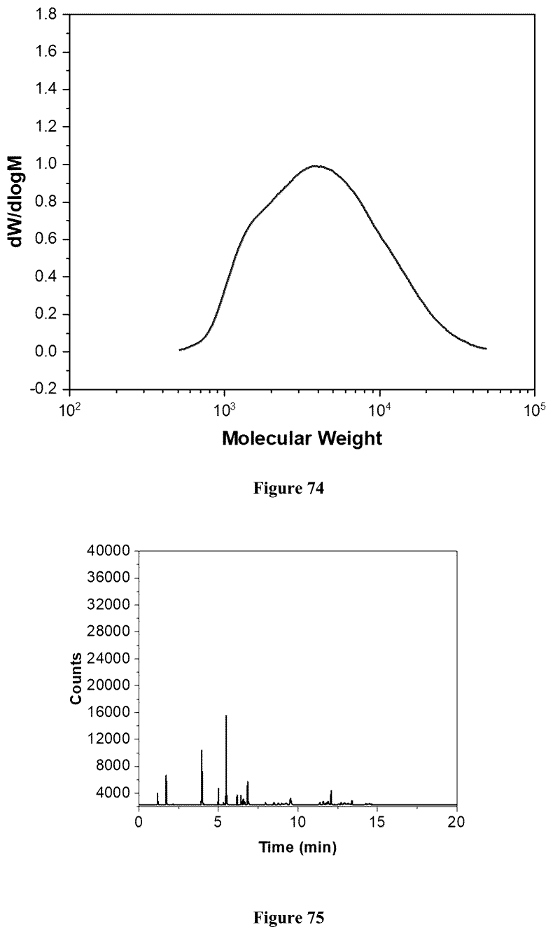

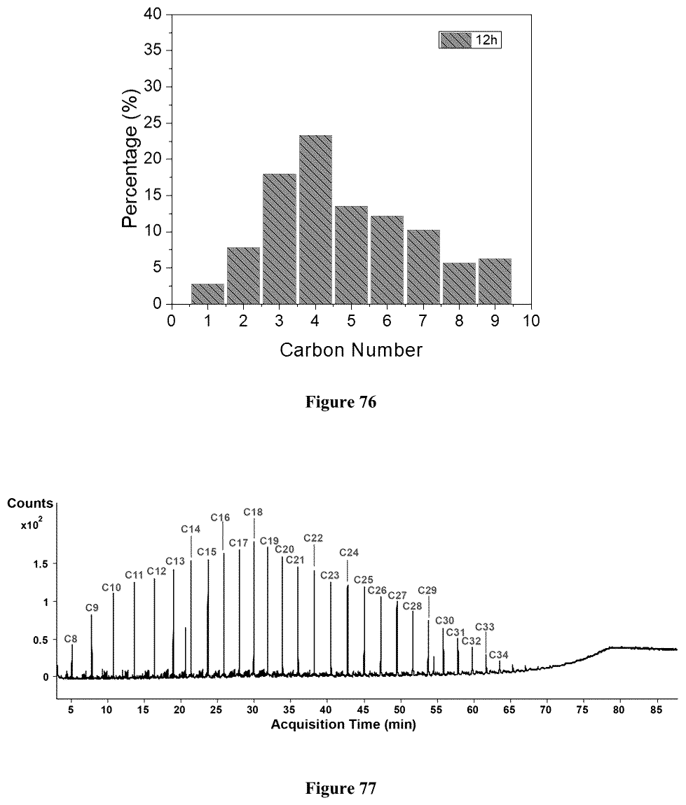

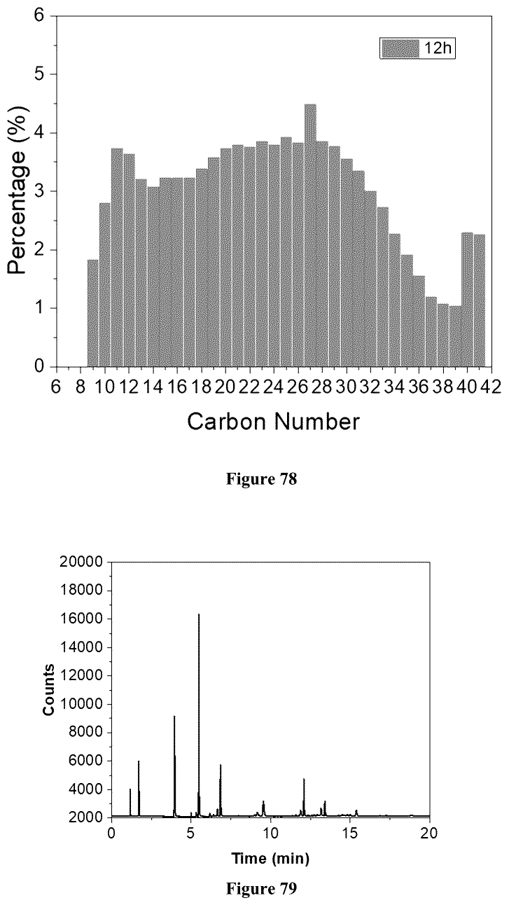

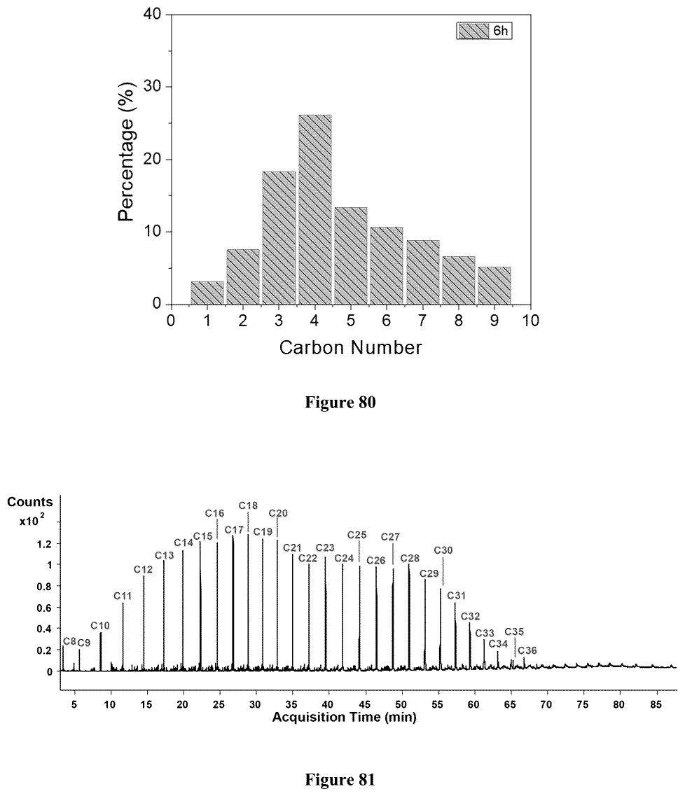

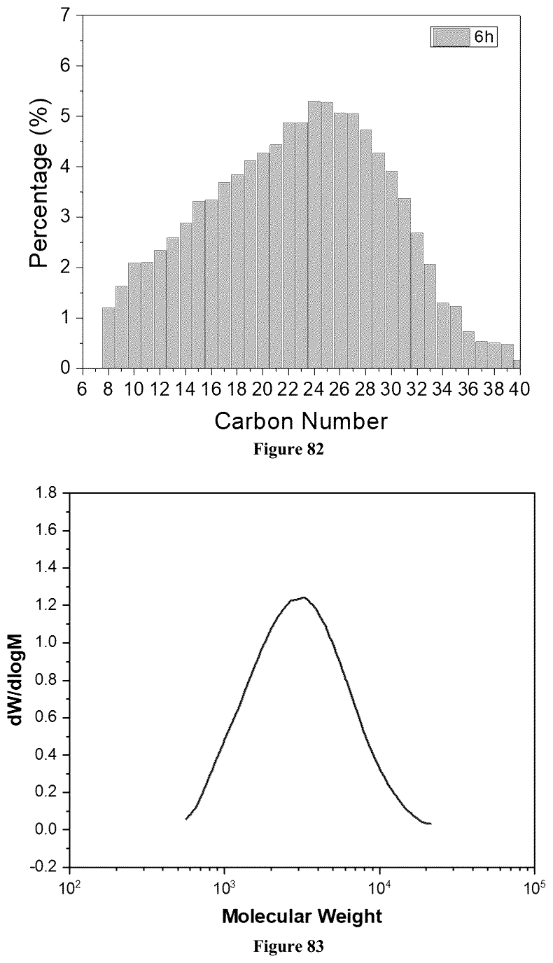

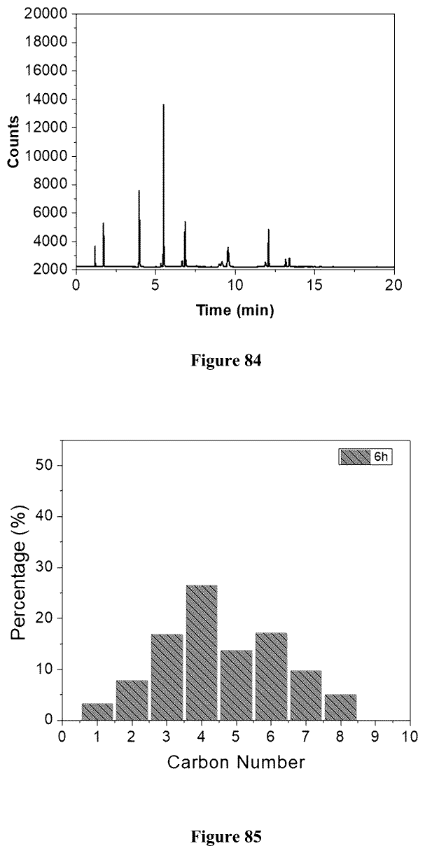

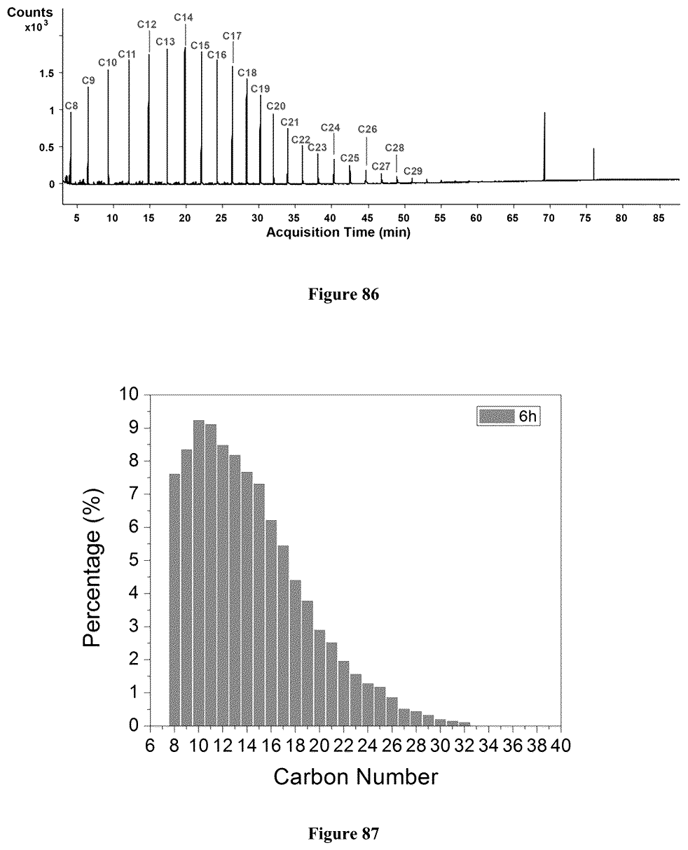

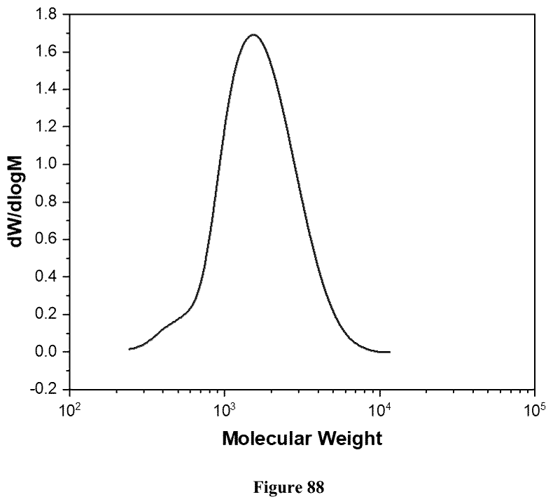

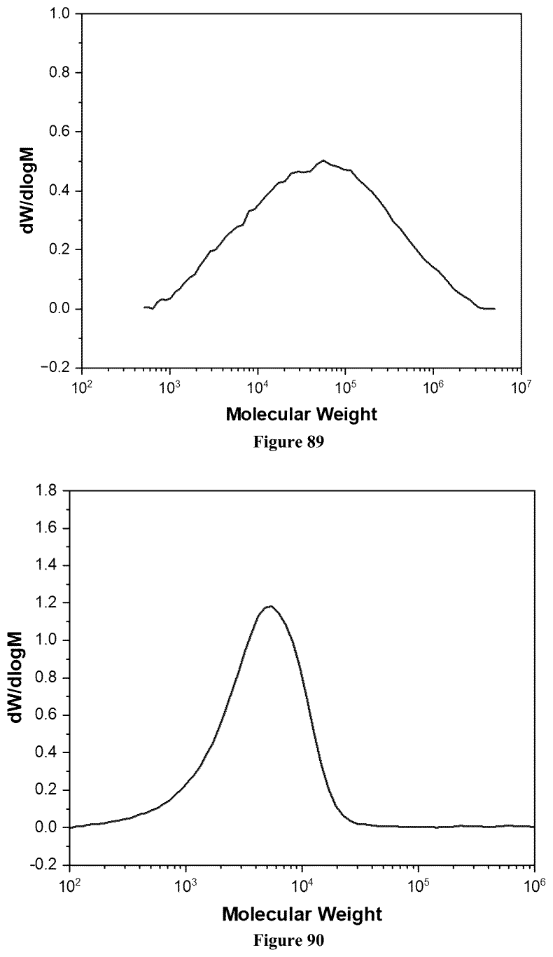

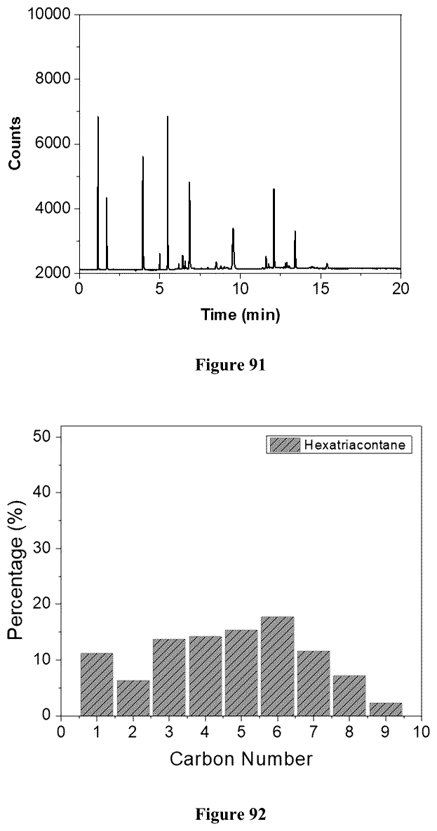

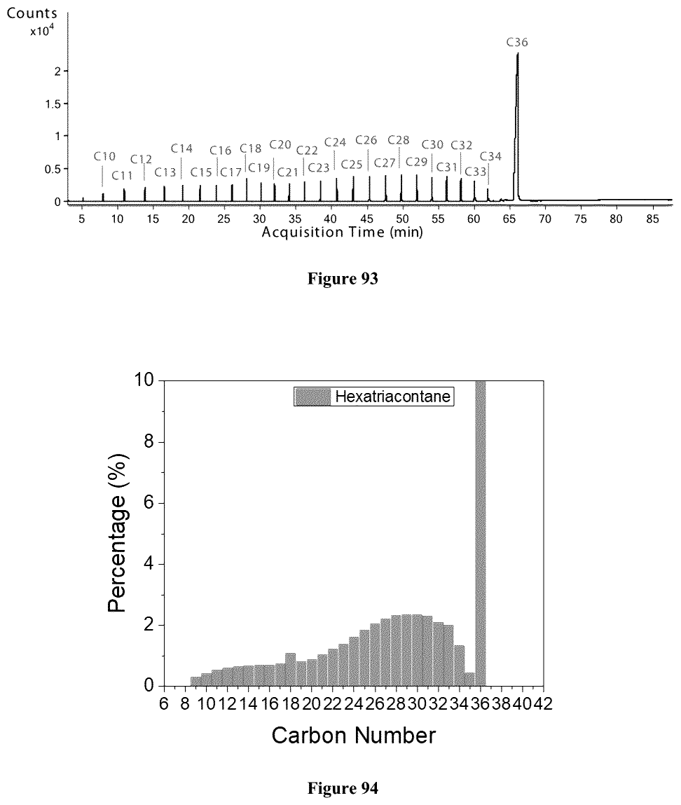

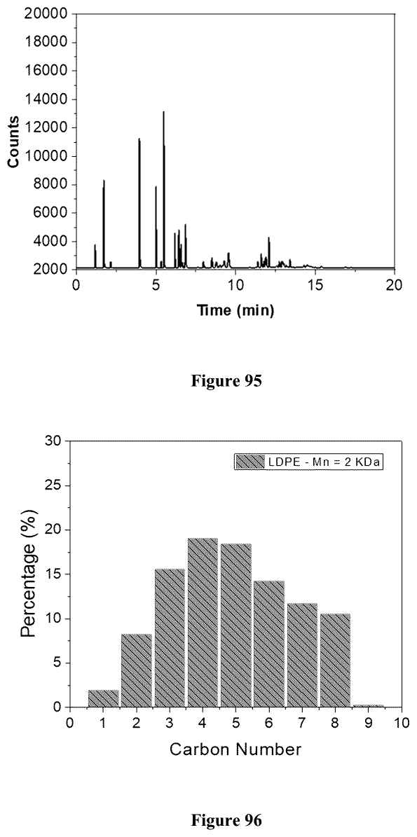

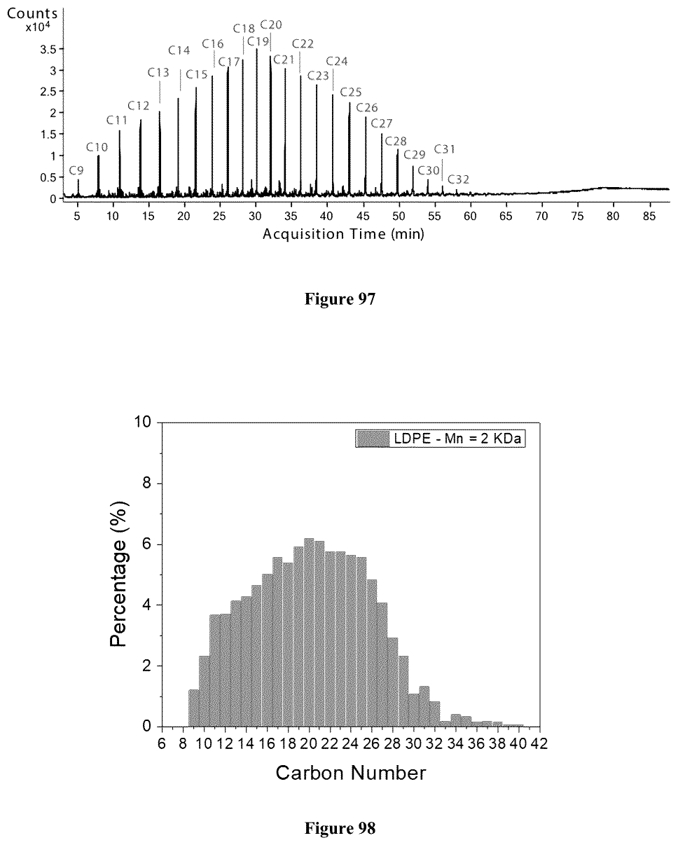

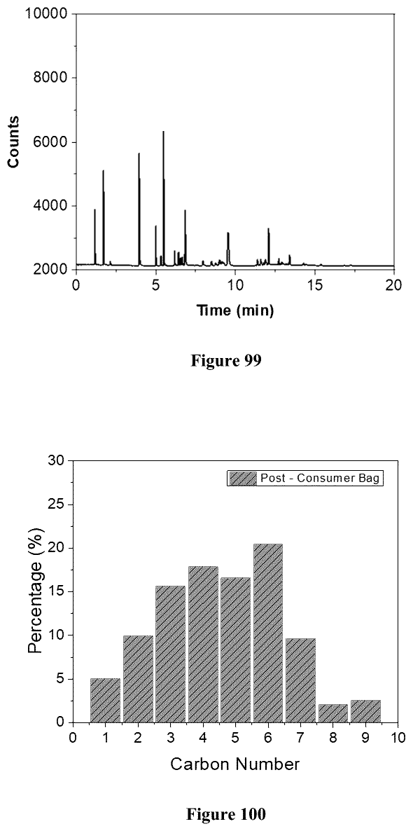

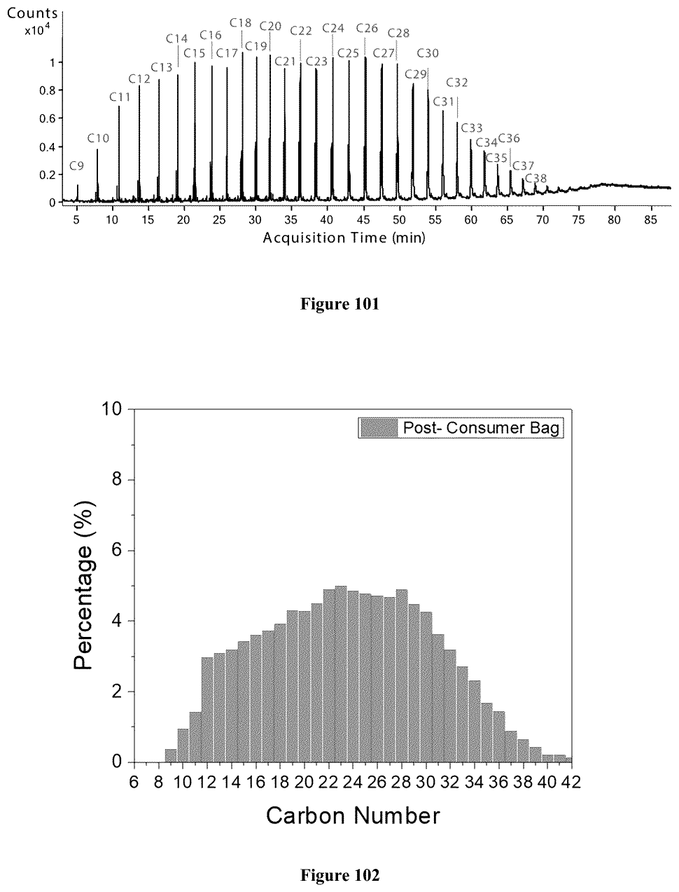

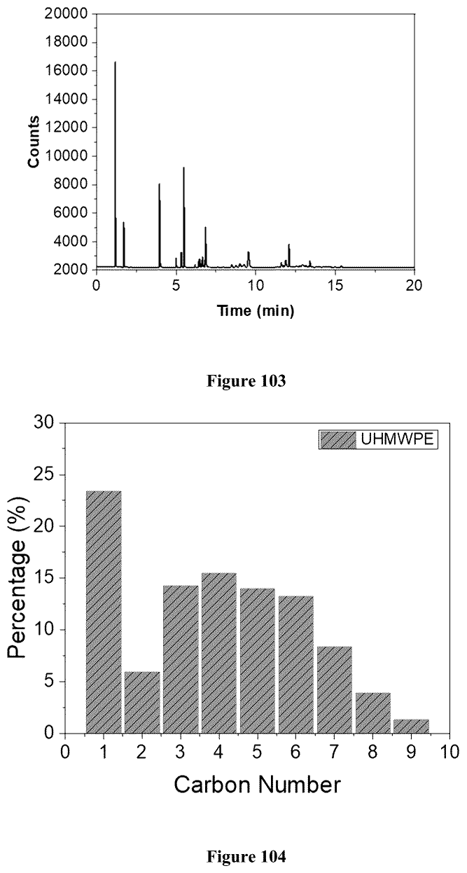

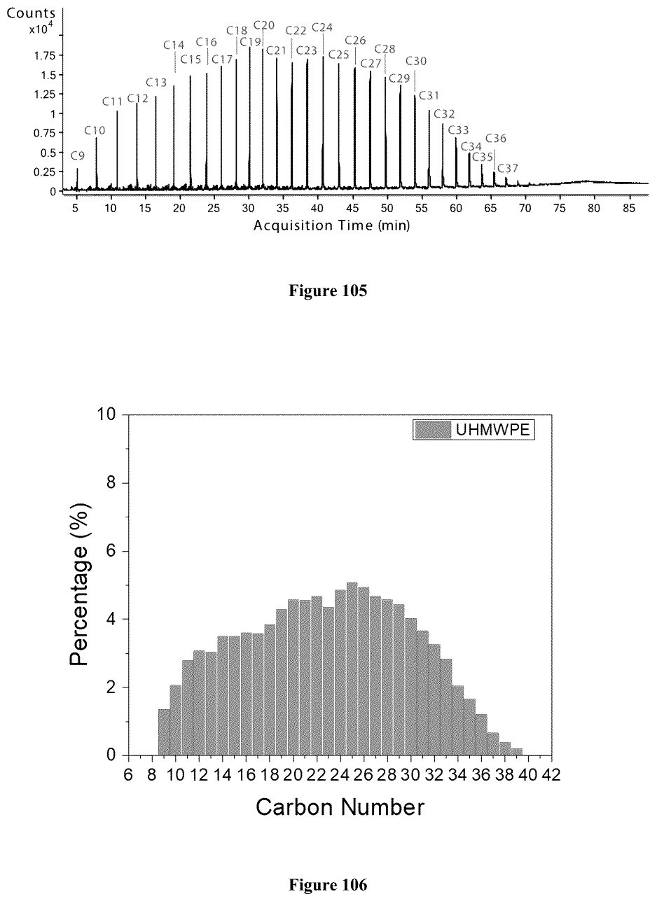

The L-ZrO₂@mSiO₂-catalyzed PE hydrogenolysis produced a narrow, Gaussian-type C₁₈-centered distribution of liquid hydrocarbons, with C₉-C₂₇ representing >90% of the chains. This characteristic distribution was formed at the initial stage of the reaction and increased in yield in a roughly linear fashion until ca. ˜ 75% PE conversion (FIGS. 19A-B and Table 3). The volatile species, which represented the low-end tail of the product distribution, similarly increased in yield as the reaction progressed (FIGS. 21-45). After >80% conversion of the PE, the average chain length in the liquid products decreases to C₁₆ after 15 hours (FIGS. 46-47) and sharpens after 20 hours (FIG. 19B), and the weight fraction of volatile products, mostly composed of methane and ethane, further increased (FIGS. 46-54). These observations were attributed to the secondary hydrogenolysis of the C₁₈-centered distribution that occurred primarily at the ends of the chains. These results further indicate that L-ZrO₂@mSiO₂-catalyzed hydrogenolysis is selective for the long hydrocarbon chains of PE rather than the shorter chains of the primary products. This remarkable behavior resembles mSiO₂/Pt/SiO₂-catalyzed hydrogenolysis of PE (Tennakoon et al., “Catalytic Upcycling of High-Density Polyethylene Via a Processive Mechanism,” Nat. Catal. 3:893-901 (2020); Wu et al., “Size-Controlled Nanoparticles Embedded in a Mesoporous Architecture Leading to Efficient and Selective Hydrogenolysis of Polyolefins,” J. Am. Chem. Soc. 144:5323-5334 (2022), which are hereby incorporated by reference in their entirety), and contrasts the performance of the other ZrO₂ catalysts, which give broader, non-Gaussian or multimodal distributions (FIG. 19E), which also vary throughout the PE conversion (Tables 4, 6, and 7, FIGS. 55-88).

TABLE 6
Product Compositions and H₂ Consumption Data Used in FIG. 19A-H to Compare
Catalysts in Hydrogenolysis of PE at 300° C. under H₂ (0.992 MPa)

| | | | | | Solid | H₂ |
|---|---|---|---|---|---|---|
| | Time | PE | Volatiles | Liquids | residue | consumption |
| Catalyst | (h) | (g) | g (%) | g (%) | g (%) | (mmol) |
| mSiO₂ | 24 | 3.006 | 0.078 (2.6%) | 0.028 (0.9%) | 2.900 (96.5%) | n.a.^{a} |
| ZrO₂-30 | 6 | 3.001 | 0.020 (0.7%) | 0.378 (12.6%) | 2.603 (86.7%) | 2.0 ± 0.2 |
| ZrO₂-30 | 12 | 3.003 | 0.098 (3.3%) | 0.832 (27.7%) | 2.073 (69.0%) | 3.2 ± 0.5 |
| imp-ZrO₂/mSiO₂ | 6 | 3.003 | 0.077 (2.6%) | 0.603 (20.1%) | 2.323 (77.4%) | 3.1 ± 0.4 |
| ZrO₂-6/mSiO₂ | 6 | 3.001 | 0.020 (0.7%) | 0.378 (12.6%) | 2.603 (86.7%) | 1.9 ± 0.2 |
| ZrO₂-6/mSiO₂ | 15 | 3.003 | 0.412 (13.7%) | 0.754 (25.1%) | 1.832 (61.0%) | 3.6 ± 0.5 |
| Pt/C | 6 | 3.014 | 0.067 (2.2%) | 0.668 (22.2%) | 2.279 (75.6%) | 5.9 ± 1.1 |
| L-Pt/mSiO₂ | 6 | 3.003 | 0.079 (2.6%) | 1.546 (51.5%) | 1.378 (45.9%) | 6.7 ± 0.3 |

^{a}Not applicable

TABLE 7
GPC Analysis of Polymeric Solid Residue Obtained
After Catalytic Hydrogenolysis and Extraction of Small
Molecules With Methylene Chloride At 100° C.

| Catalyst | Reaction time (h) | Mₙ (Da) | M_{w} (Da) | Ð |
|---|---|---|---|---|
| No catalyst: PE | 0 | 20000 | 96000 | 4.8 |
| starting material | | | | |
| L-ZrO₂@mSiO₂ | 2 | 3050 | 6900 | 2.3 |
| L-ZrO₂@mSiO₂ | 4 | 1990 | 3800 | 1.9 |
| L-ZrO₂@mSiO₂ | 6 | 1880 | 3300 | 1.8 |
| L-ZrO₂@mSiO₂ | 8 | 1600 | 2700 | 1.7 |
| L-ZrO₂@mSiO₂ | 12 | 930 | 1800 | 1.9 |
| L-ZrO₂@mSiO₂ | 15 | 1100 | 1990 | 1.8 |
| imp-ZrO₂/mSiO₂ | 6 | 3000 | 8700 | 2.9 |
| ZrO₂-6/mSiO₂ | 6 | 4500 | 29600 | 6.6 |
| ZrO₂-6/mSiO₂ | 15 | 1700 | 5800 | 3.4 |
| ZrO₂-30/mSiO₂ | 6 | 3000 | 6000 | 2.0 |
| Pt/C | 6 | 1400 | 1900 | 1.4 |
| L-Pt@mSiO₂ | 6 | 2400 | 3800 | 1.6 |

This highly disperse PE (Mₙ=20 kDa) represents the typical range used for flexible packaging applications. Accordingly, L-ZrO₂@mSiO₂-catalyzed hydrogenolysis of a post-consumer LDPE grocery bag (Mₙ=10.6 kDa, M_{w}=150 kDa; dried under vacuum; FIG. 89) resulted in equivalent reactivity (FIG. 19D; 2.3±0.4 mol H₂·Zr g⁻¹·h⁻¹). The catalytic activity was also similar for hexatriacontane (n-C₃₆H₇₄), LDPE (Mₙ=2.8 kDa, M_{w}=5.3 kDa; FIG. 90), and ultra-high molecular weight high density polyethylene (UHMW HDPE, M_{w}˜ 3,000-5,000 kDa). These results suggest that rates of threading of chains into pores and translocation to the active sites at the ends of the pores are not limiting the rates of C—C bond cleavage for short and long chains as well as branched and linear polymers, and the distribution is independent of C—C bond cleavage rate; however, the conformations of long and short chains likely vary to influence the distributions. Specifically, hydrogenolysis of hexatriacontane provided a distribution of chain end-cleaved hydrocarbons, similar to the process observed for secondary hydrogenolysis of C₁₈ primary products noted above. On the other hand, UHMW HDPE or post-consumer LDPE gave broad distributions, respectively (FIGS. 91-106, Table 8). In addition, L-ZrO₂@mSiO₂ produced a narrower distribution of chain lengths of extractable species compared to the other ZrO₂-based catalysts at a similar PE conversion (39-54%, FIG. 19E).

TABLE 8
Composition of Products Obtained From the Hydrogenolysis of Hydrocarbons
Catalyzed by L-Zro₂@Msio₂ Under H₂ (0.992 Mpa) at 300° C. For 6 Hours

| | | | | | H₂ | Mass Activity |
|---|---|---|---|---|---|---|
| | Reactant | Volatiles | Liquids | Residue | consumption | mol |
| Polymer | g | g (%) | g (%) | g (%) | mmol | H₂ · g_{Zr}⁻¹ · h⁻¹ |
| n-C₃₆H₇₄ | 2.994 | 0.050 | 2.944 | n.a.^{a} | 3.5 ± 0.7 | 2.3 ± 0.5 |
| | | (1.7%) | | | | |
| LDPE | 3.003 | 0.134 | 1.422 | 1.447 | 4.2 ± 0.6 | 2.7 ± 0.4 |
| Mₙ = 2.8 kDa | | (4.5%) | (47.4%) | (48.3%) | | |
| M_{w} = 5.3 kDa | | | | | | |
| LDPE | 3.003 | 0.082 | 1.257 | 1.664 | 3.6 ± 0.5 | 2.3 ± 0.3 |
| Mₙ = 20 kDa | | (2.7%) | (42.3%) | (55.4%) | | |
| M_{w} = 91 kDa | | | | | | |
| Grocery Bag | 2.934 | 0.049 | 1.205 | 1.68 | 3.6 ± 0.6 | 2.3 ± 0.4 |
| Mₙ = 10.6 kDa | | (1.7%) | (41.1%) | (57.3%) | | |
| M_{w} = 150 kDa | | | | | | |
| UHMW PE | 3.006 | 0.086 | 1.402 | 1.518 | 4.1 ± 0.3 | 2.7 ± 0.1 |
| | | (2.9%) | (46.6%) | (50.5%) | | |

^{a}not applicable.

### CONCLUSION

Investigations of L-ZrO₂@mSiO₂ revealed the combined architectural and chemical features which enable an earth abundant, non-reducible metal oxide (Zr, Si, O) to catalyze the selective hydrogenolysis of hydrocarbon polymers. The synthesis of L-ZrO₂@mSiO₂ demonstrates, remarkably, that ZrOₓ(OH)₄₋ₓ nanoparticles are stable under the hydrolytic conditions necessary for growth of mesoporous silica and creation of the catalytic architecture with core-localized nanoparticles. Moreover, the coordinatively unsaturated surface sites needed for catalysis are stabilized by covalently embedding the amorphous zirconium nanoparticles in the walls of mesoporous silica. These sites mediate C—C bond hydrogenolysis with comparable activity to Pt/C. The quantitative comparison of activity across a series of catalysts is based on H₂ consumption or the relationship between the number of C—C bonds that are cleaved and the change in Mₙ of the entire hydrocarbon population, determined from the detailed characterization of gas, liquid, and solid compositions. This quantitative comparison reveals that the catalytic enhancement observed with L-ZrO₂@mSiO₂ is more than simply the combination of small crystalline ZrO₂ with mSiO₂, as shown by the poorer activity of ZrO₂-6/mSiO₂.

In addition, L-ZrO₂@mSiO₂ provides advantageous selectivity over the other zirconia-based catalysts investigated in this study. Alignment of long chains in the pores (Tennakoon et al., “Catalytic Upcycling of High-Density Polyethylene Via a Processive Mechanism,” Nat. Catal. 3:893-901 (2020), which is hereby incorporated by reference in its entirety), non-dissociative adsorption of polymer onto the walls of silica, and escape of smaller products through the void space between the two mesoporous silica plates may all contribute to higher selectivity. In fact, both L-ZrO₂@mSiO₂ and L-Pt@mSiO₂ have sites localized at the ends of mesopores and are both more selective than their non-pore-confined analogues. The mechanisms of zirconia and platinum catalyzed reactions, however, are distinct. Access to such species directly from ZrO₂, rather than by grafting neopentylzirconium onto silica, allows the catalytic architecture to be constructed under aqueous conditions, as well as enabling the catalytic chemistry to be accessed with air-stable precursors. In this sense, hydrogenolysis with L-ZrO₂@mSiO₂ is a previously unrecognized heterogeneous analogue of the SOMC-catalyzed C—C cleavage processes.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A catalyst comprising:
a layer of metal oxide nanoparticles; and
a mesoporous silica-containing shell surrounding the layer of metal oxide nanoparticles, wherein the mesoporous silica-containing shell has an outer surface and an inner surface inside the outer surface, the outer surface having openings leading to pores extending through said mesoporous silica-containing shell to the inner surface,
wherein the metal oxide is selected from a group consisting of zirconium oxide, hafnium oxide, titanium oxide, niobium oxide, cerium oxide, molybdenum oxide, scandium oxide, yttrium oxide, and lanthanum oxide.

2. The catalyst of claim 1, wherein the metal oxide is selected from a group consisting of zirconium oxide, hafnium oxide, titanium oxide, niobium oxide, cerium oxide, and molybdenum oxide.

3. The catalyst of claim 1, wherein the metal oxide nanoparticles are zirconia oxide nanoparticles.

4. The catalyst of claim 3, wherein the zirconia oxide nanoparticles are amorphous zirconia oxide nanoparticles.

5. The catalyst of claim 3, wherein the zirconia oxide nanoparticles are crystalline zirconia oxide nanoparticles.

6. The catalyst of claim 1, wherein the metal oxide nanoparticles have a mean particle diameter of about 0.5 nm to about 5 nm.

7. The catalyst of claim 1, wherein the metal oxide nanoparticles have a mean particle diameter of about 5 nm to about 10 nm.

8. The catalyst of claim 1, wherein the metal oxide nanoparticles have a mean particle diameter of about 10 nm to about 500 nm.

9. The catalyst of claim 1, wherein the metal oxide nanoparticles have a mean particle diameter of about 10 nm to about 1000 nm.

10. The catalyst of claim 1, wherein the mesoporous silica-containing shell has total thickness of about 10 nm to about 500 nm.

11. The catalyst of claim 1, wherein the mesoporous silica-containing shell has a pore diameter of about 1 nm to about 10 nm.

12. The catalyst of claim 1, wherein the pores have a length of about the thickness of the mesoporous silica shell measured between its inner and outer surfaces.

13. The catalyst of claim 1, wherein said metal oxide nanoparticles comprise about 0.0001 wt % to about 20.0 wt % of said catalyst.

14. The catalyst of claim 1, wherein said metal oxide nanoparticles comprise about 1 wt % to about 20.0 wt % of said catalyst.

15. A process for catalytically hydrogenolyzing a polymer, said process comprising:
providing a polymer; and
subjecting said polymer to a hydrogenolysis reaction in the presence of a catalyst to cleave the polymer into hydrocarbon segments, wherein the catalyst comprises metal oxide, wherein the metal oxide is selected from a group consisting of zirconium oxide, titanium oxide, hafnium oxide, lanthanum oxide, cerium oxide, niobium oxide, molybdenum oxide, tungsten oxide, tantalum oxide, scandium oxide, and yttrium oxide.

16.-24. (canceled)

25. The process of claim 15, wherein the catalyst comprises:
a plurality of metal oxide nanoparticles; and
a mesoporous silica-containing shell surrounding the plurality of metal oxide nanoparticles, wherein the mesoporous silica-containing shell has an outer surface and an inner surface inside the outer surface, the outer surface having openings leading to pores extending through said mesoporous silica-containing shell to the inner surface,
wherein the metal oxide is selected from a group consisting of zirconium oxide, hafnium oxide, titanium oxide, niobium oxide, cerium oxide, molybdenum oxide, scandium oxide, yttrium oxide, and lanthanum oxide.

26.-46. (canceled)

47. A method of preparing a catalyst comprising:
providing a graphene oxide;
providing a metal containing compound;
adding the metal containing compound to the graphene oxide to form a plurality of metal oxide hydrate nanoparticles supported on the graphene oxide;
contacting the plurality of metal oxide hydrate nanoparticles supported on the graphene oxide with a silicon containing compound and a pore structure-directing agent to produce a mesoporous silica-containing shell surrounding the plurality of metal oxide hydrate nanoparticles supported on the graphene oxide, wherein the mesoporous silica-containing shell has an outer surface and an inner surface inside the outer surface, the outer surface having openings leading to pores extending through said mesoporous silica-containing shell to the inner surface; and
calcinating the mesoporous silica-containing shell containing the plurality of metal oxide hydrate nanoparticles supported on graphene oxide to produce a mesoporous silica-containing shell surrounding the plurality of metal oxide nanoparticles, wherein the mesoporous silica-containing shell has an outer surface and an inner surface inside the outer surface, the outer surface having openings leading to pores extending through said mesoporous silica-containing shell to the inner surface;
wherein the metal oxide is selected from a group consisting of zirconium oxide, hafnium oxide, titanium oxide, niobium oxide, cerium oxide, molybdenum oxide, scandium oxide, yttrium oxide, and lanthanum oxide.

48.-66. (canceled)
